(19) United States
(12) Patent Application Publication
(10) Pub. No.: US 2025/0151080 A1
(43) Pub. Date: May 8, 2025

(54) METHOD AND APPARATUS FOR TRANSMISSION AND RECEPTION OF REFERENCE SIGNAL IN WIRELESS COMMUNICATION SYSTEM

(71) Applicant: SAMSUNG ELECTRONICS CO., LTD., Suwon-si (KR)

(72) Inventors: Youngrok JANG, Suwon-si (KR); Ameha Tsegaye ABEBE, Suwon-si (KR); Seongmok LIM, Suwon-si (KR); Hyoungju JI, Suwon-si (KR)

(21) Appl. No.: 18/934,047

(22) Filed: Oct. 31, 2024

(30) Foreign Application Priority Data
Nov. 2, 2023 (KR) 10-2023-0150158
May 9, 2024 (KR) 10-2024-0061450

(51) Int. Cl. H04W 72/231; H04B 7/06; H04L 5/00; H04W 72/1268

(52) U.S. Cl. CPC H04W 72/231; H04B 7/0626; H04L 5/0051; H04W 72/1268

(57) ABSTRACT

The disclosure relates to a 5G or 6G communication system for supporting a higher data transmission rate. An embodiment of the disclosure may include: receiving, from a base station, configuration information on a channel state information (CSI)-reference signal (RS) resource set with more than 32 antenna ports, wherein the CSI-RS resource set includes an aggregation of a plurality of CSI-RS resources as an associated CSI-RS; receiving, from the base station, downlink control channel (DCI) requesting a sounding reference signal (SRS); receiving, from the base station, the associated CSI-RS; transmitting, to the base station, the SRS based on the DCI; and transmitting, to the base station, a non-codebook based physical uplink shared channel (PUSCH) according to the SRS, wherein a number of the plurality of CSI-RS resources is one of 2, 3, or 4.

### CROSS-REFERENCE TO RELATED APPLICATIONS

This application is based on and claims priority under 35 U.S.C. § 119 to Korean Patent Application No. 10-2023-0150158 filed on Nov. 2, 2023, and Korean Patent Application No. 10-2024-0061450 filed on May 9, 2024, in the Korean Intellectual Property Office, the disclosure of which are herein incorporated by reference in their entirety.

### BACKGROUND

### 1. Field

The disclosure relates to the operation of a user equipment (UE) and a base station in a wireless communication system. More particularly, the disclosure relates to a method for transmitting and receiving a reference signal in a wireless communication system and an apparatus capable of performing the same.

### 2. Description of Related Art

5G mobile communication technologies define broad frequency bands such that high transmission rates and new services are possible, and can be implemented not only in “Sub 6 GHZ” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The disclosed embodiment is to provide an apparatus and a method for effectively providing services in a mobile communication system.

To solve the above problems, the disclosure provides a method for processing a control signal in a wireless communication system, the method including receiving a first control signal transmitted from a base station, processing the received first control signal, and transmitting a second control signal generated based on the processing to the base station.

The disclosed embodiment provides an apparatus and a method for effectively providing services in a mobile communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the present disclosure;

FIG. 2 illustrates a structure of a frame, a subframe, and a slot in a wireless communication system according to an embodiment of the present disclosure;

FIG. 3 illustrates an example of a bandwidth part configuration in a wireless communication system according to an embodiment of the present disclosure;

FIG. 4 illustrates radio protocol structures of a base station and a UE in single cell, carrier aggregation, and dual connectivity situations in a wireless communication system according to an embodiment of the present disclosure;

FIG. 5 illustrates an example of an aperiodic CSI reporting method according to an embodiment of the present disclosure;

FIG. 6 illustrates an example of a control resource set configuration of a downlink control channel in a wireless communication system according to an embodiment of the present disclosure;

FIG. 7 illustrates a structure of a downlink control channel in a wireless communication system according to an embodiment of the present disclosure;

FIG. 8 illustrates a non-codebook-based PUSCH transmission process according to an embodiment of the present disclosure;

FIG. 9 illustrates a possible location in which an aperiodic associated CSI-RS may exist according to an embodiment of the present disclosure;

FIG. 10 illustrates the operation of a UE according to an embodiment of the present disclosure;

FIG. 11 illustrates the operation of a base station according to an embodiment of the present disclosure;

FIG. 12 illustrates a structure of a UE in a wireless communication system according to an embodiment of the present disclosure; and

FIG. 13 illustrates a structure of a base station in a wireless communication system according to an embodiment of the present disclosure.

### DETAILED DESCRIPTION

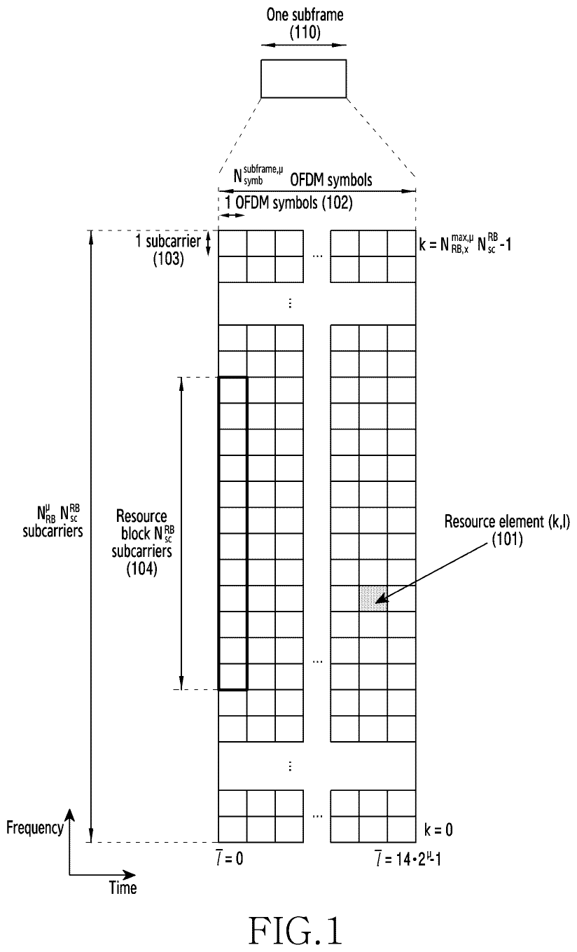

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. The contents of the disclosure may be applied to FDD and TDD systems.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms and may also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, the term “a/b” may be understood as at least one of a and b.

### [NR Time-Frequency Resources]

Hereinafter, a frame structure of a 5G system will be described in more detail with reference to the accompanying drawings.

FIG. 1 illustrates a basic structure of a time-frequency domain, which is a radio resource domain used to transmit data or control channels, in a 5G system.

The horizontal axis in FIG. 1 represents a time domain, and the vertical axis in FIG. 1 represents a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, NR (for example, 12) consecutive REs may constitute one resource block (RB) 104. In the time domain, one subframe 110 may include multiple OFDM symbols 102. For example, the length of one subframe may be 1 ms.

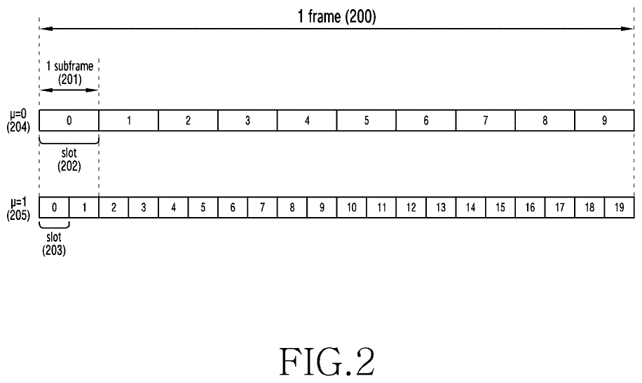

FIG. 2 illustrates a structure of a frame, a subframe, and a slot in a wireless communication system according to an embodiment of the present disclosure.

Referring to FIG. 2, FIG. 2 illustrates an example of a structure of a frame 200, a subframe 201, and a slot 202. One frame 200 may be defined as 10 ms. One subframe 201 may be defined as 1 ms, and thus one frame 200 may include a total of ten subframes 201. One slot 202 or 203 may be defined as 14 OFDM symbols (i.e., the number of symbols per one slot is N slot symb=14). One subframe 201 may include one or multiple slots 202 and 203, and the number of slots 202 and 203 per one subframe 201 may vary depending on configuration values μ 204 or 205 for the subcarrier spacing. The example of FIG. 2 shows the case of μ=0 (204) and the case of μ=1 (205) as a configuration value for a subcarrier spacing. In the case of μ=0 (204), one subframe 201 may include one slot 202, and in the case of μ=1 (205), one subframe 201 may include two slots 203. That is, the number of slots per one subframe Nₛₗₒₜ^{sunframe,μ} may differ depending on the subcarrier spacing configuration value u, and the number of slots per one frame Nₛₗₒₜ^{frame,μ} may differ accordingly. Nₛₗₒₜ^{sunframe,μ} and Nₛₗₒₜ^{frame,μ} may be defined according to each subcarrier spacing configuration μ as in Table 1 below.

TABLE 1

| μ | N_{symb}^{slot} | Nₛₗₒₜ^{frame,μ} | Nₛₗₒₜ^{sunframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, a bandwidth part (BWP) configuration in a 5G communication system will be described in detail with reference to the accompanying drawings.

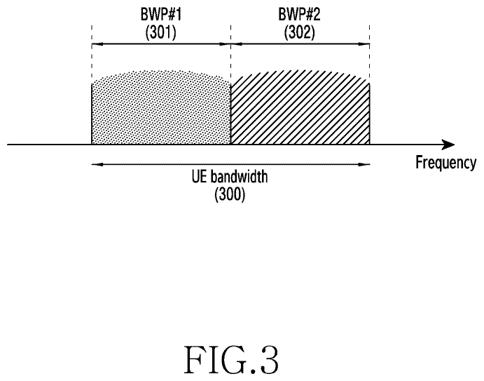

FIG. 3 illustrates an example of a bandwidth part configuration in a wireless communication system according to an embodiment of the present disclosure.

FIG. 3 illustrates an example in which a UE bandwidth 300 is configured to include two bandwidth parts, that is, bandwidth part #1(BWP #1) 301 and bandwidth part #2 (BWP #2) 302. A base station may configure one or multiple bandwidth parts for a UE and may configure the following pieces of information with regard to each bandwidth part as given in Table 2 below.

TABLE 2

| | |
|---|---|
| BWP ::= | SEQUENCE { |
| bwp-Id | BWP-Id, |
| (bandwidth part identifier) | |
| location AndBandwidth | INTEGER (1..65536), |
| (bandwidth part location) | |
| subcarrierSpacing | ENUMERATED {n0, n1, n2, n3, n4, |
| n5}, | |
| (subcarrier spacing) | |
| cyclicPrefix | ENUMERATED { extended } |
| (cyclic prefix) | |
| } | |

Of course, the bandwidth part configuration is not limited to the above example in Table 2, and in addition to the configuration information in Table 2, various parameters related to the bandwidth part may be configured for the UE. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

According to various embodiments of the disclosure, the bandwidth part-related configuration supported by 5G may be used for various purposes.

According to an embodiment, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control resource set (i.e., CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. For example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside the received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (TBWP) required during a bandwidth part change are specified in standards and may be defined as given in Table 3 below, for example. Obviously, the example given below is not limiting.

TABLE 3

| | | BWP switch delay T_{BWP} (slots) | |
|---|---|---|---|
| μ | NR Slot length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+TBWP, and may transmit/receive a data channel scheduled by the corresponding DCI in the newly changed bandwidth part. If the base station wants to schedule a data channel by using the new bandwidth part, the base station may determine time domain resource allocation regarding the data channel, based on the UE's bandwidth part change delay time (TBWP). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI indicating a bandwidth part change may indicate a slot offset (K0 or K2) value smaller than the bandwidth part change delay time (TBWP).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [Regarding CA/DC]

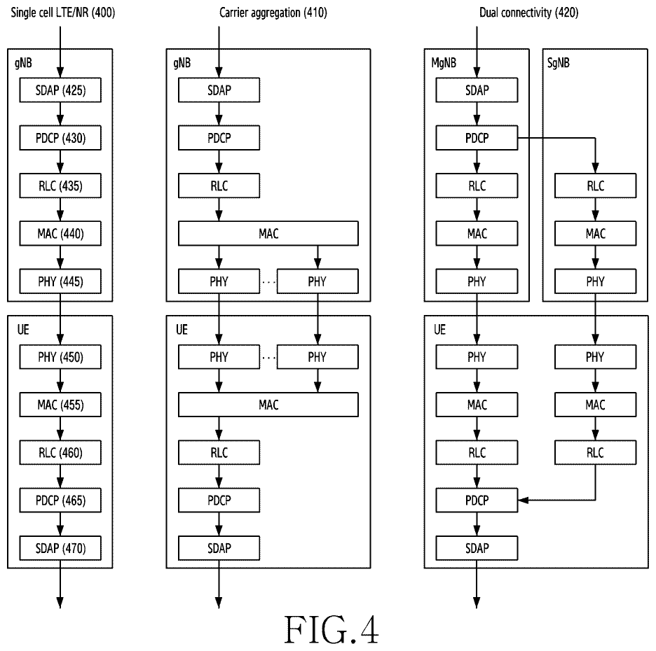

FIG. 4 illustrates radio protocol structures of a base station and a UE in single cell, carrier aggregation, and dual connectivity situations in a wireless communication system according to an embodiment of the present disclosure.

Referring to FIG. 4, a radio protocol of a next-generation mobile communication system includes an NR service data adaptation protocol (SDAP) 425 or 470, an NR packet data convergence protocol (PDCP) 430 or 465, an NR radio link control (RLC) 435 or 460, and an NR medium access controls (MAC) 440 or 455, on each of UE and NR base station sides. Obviously, the above example is not limiting, and the radio protocol may include a larger or smaller number of layers.

The main functions of the NR SDAP 425 or 470 may include some of functions below. Obviously, the example given below is not limiting:
Transfer of user plane data;
Mapping between a QOS flow and a DRB for both DL and UL;
Marking QoS flow ID in both DL and UL packets; and/or
Reflective QOS flow to DRB mapping for the UL SDAP PDUs.

With regard to the SDAP layer device 425 or 470, whether to use the header of the SDAP layer device or whether to use functions of the SDAP layer device may be configured for the UE through an RRC message according to PDCP layer devices or according to bearers or according to logical channels. If an SDAP header is configured, the NAS QOS reflection configuration 1-bit indicator (NAS reflective QoS) of the SDAP header and the AS QOS reflection configuration 1-bit indicator (AS reflective QoS) thereof may be indicated by the base station, so that the UE can update or reconfigure mapping information regarding the QoS flow and data bearer of the uplink and downlink. The SDAP header may include QOS flow ID information indicating the QoS. The QoS information may be used as data processing priority, scheduling information, etc. for smoothly supporting services.

The main functions of the NR PDCP 430 or 465 may include some of functions below. Obviously, the example given below is not limiting:
Header compression and decompression: robust header compression (ROHC) only;
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and/or
Timer-based SDU discard in uplink.

The reordering of the NR PDCP device 430 or 465 refers to a function of reordering PDCP PDUs received from a lower layer in an order based on the PDCP sequence number (SN) and may include a function of transferring data to an upper layer in the reordered sequence. Alternatively, the reordering of the NR PDCP device 430 or 465 may include at least one of a function of instantly transferring data without considering the order, a function of recording PDCP PDUs lost as a result of reordering, a function of reporting the state of the lost PDCP PDUs to the transmitting side, and a function of requesting retransmission of the lost PDCP PDUs.

The main functions of the NR RLC 435 or 460 may include some of functions below. Obviously, the example given below is not limiting:
Transfer of upper layer PDUs;
In-sequence delivery of upper layer PDUs;
Out-of-sequence delivery of upper layer PDUs;
Error Correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard; and/or
RLC re-establishment.

The in-sequence delivery of the NR RLC device 435 or 460 may refer to a function of successively delivering RLC SDUs, received from the lower layer, to the upper layer. The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs. The in-sequence delivery function of the NR RLC device 435 or 460 may include at least one of a function of, if there is a lost RLC SDU, successively delivering only RLC SDUs before the lost RLC SDU to the upper layer, and a function of, if a predetermined timer has expired although there is a lost RLC SDU, successively delivering all RLC SDUs received before the timer was started to the upper layer.

Alternatively, the in-sequence delivery of the NR RLC device may include a function of, if a predetermined timer has expired although there is a lost RLC SDU, successively delivering all currently received RLC SDUs to the upper layer. In addition, the in-sequence delivery of the NR RLC device 435 or 460 may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device 435 or 460 may refer to a function of directly delivering RLC SDUs, received from the lower layer, to the upper layer regardless of the sequence. The out-of-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, and a function of storing the RLC SN or PDCP SN of received RLC PDUs, and recording RLC PDUs lost as a result of reordering.

The NR MAC 440 or 455 may be connected to multiple NR RLC layer devices configured in one UE, and the main functions of the NR MAC may include some of functions below. Obviously, the example given below is not limiting:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and/or
Padding.

An NR PHY layer 445 or 450 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. Obviously, the example given above is not limiting.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 400. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 410. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as 420.

### [CSI Resource Configuration]

In NR, there may be a CSI framework indicating channel state information (CSI) measurement and report of a UE by a base station. The CSI framework of NR may include a minimum of two elements such as resource setting and report setting, and the report setting may be associated with each other by referencing to at least one of IDs of the resource setting.

According to an embodiment of the disclosure, the resource setting may include information relating to a reference signal (RS) for measuring channel state information by the UE. The base station may configure one or more resource settings in the UE. For example, the base station and the UE may exchange signaling information described as shown Table 4 in order to transfer information relating to the resource setting. Of course, this is not limited to the examples below.

```
TABLE 4
-- ASN1START
-- TAG-CSI-RESOURCECONFIG-START
CSI-ResourceConfig ::= SEQUENCE {
  csi-ResourceConfigId CSI-ResourceConfigId,
  csi-RS-ResourceSetList CHOICE {
  nzp-CSI-RS-SSB SEQUENCE {
  nzp-CSI-RS-ResourceSetList SEQUENCE (SIZE (1..maxNrofNZP-CSI-RS-
ResourceSetsPerConfig)) OF NZP-CSI-RS-ResourceSetId
    OPTIONAL, -- Need R
  csi-SSB-ResourceSetList SEQUENCE (SIZE (1..maxNrofCSI-SSB-ResourceSetsPerConfig))
OF CSI-SSB-ResourceSetId
    OPTIONAL -- Need R
  },
  csi-IM-ResourceSetList SEQUENCE (SIZE (1..maxNrofCSI-IM-ResourceSetsPerConfig)) OF
CSI-IM-ResourceSetId
  },
  bwp-Id BWP-Id,
  resourceType ENUMERATED { aperiodic, semiPersistent, periodic },
  ...
}
-- TAG-CSI-RESOURCECONFIG-STOP
-- ASN1STOP
```

In Table 4, signaling information CSI-ResourceConfig may include information on each resource setting. According to the signaling information of Table 4, each resource setting may include a resource setting index (csi-ResourceConfigId), a BWP index (bwp-ID), a configuration of transmission in a time axis of resources, or a resource set list (csi-RS-ResourceSetList) including at least one resource set. Time-domain transmission configuration of resources may be configured as aperiodic transmission, semi-persistent transmission, or periodic transmission. A resource set list may be a set including resource sets for channel measurement, or a set including resource sets for interference measurement. In case that a resource set list is a set including resource sets for channel measurement, each resource set may include at least one resource, and the at least one resource may correspond to an index of a CSI reference signal (CSI-RS) resource or a synchronization/broadcast channel block (SS/PBCH block, SSB). In case that a resource set list is a set including resource sets for interference measurement, each resource set may include at least one interference measurement resource (CSI interference measurement, CSI-IM).

For example, when a resource set includes a CSI-RS, a base station and a UE may exchange signaling information described as shown in Table 5 below in order to transfer information relating to the resource set. Of course, this is not limited to the examples below.

```
TABLE 5
-- ASN1START
-- TAG-NZP-CSI-RS-RESOURCESET-START
NZP-CSI-RS-ResourceSet ::= SEQUENCE {
  nzp-CSI-ResourceSetId NZP-CSI-RS-ResourceSetId,
  nzp-CSI-RS-Resources SEQUENCE (SIZE (1..maxNrofNZP-CSI-RS-ResourcesPerSet)) OF
NZP-CSI-RS-ResourceId,
  repetition ENUMERATED { on, off } OPTIONAL, -- Need S
  aperiodicTriggeringOffset INTEGER(0..6) OPTIONAL, -- Need S
trs-Info ENUMERATED {true} OPTIONAL, -- Need R
  ...
}
-- TAG-NZP-CSI-RS-RESOURCESET-STOP
-- ASN1STOP
```

The signaling information NZP-CSI-RS-ResourceSet in Table 5 may include information relating to each resource set. According to the signaling information, each resource set may include information relating to at least a resource set index (nzp-CSI-ResourceSetId) or a CSI-RS index set (nzp-CSI-RS-Resources). In addition, each resource set may include a part of information (repetition) relating to a spatial domain transmission filter of a CSI-RS resource or information (trs-Info) relating to whether the CSI-RS resource is used for tracking.

A CSI-RS may be the most representative reference signal included in a resource set. A base station and a UE may exchange signaling information described as shown in Table 6 below to transfer information relating to a CSI-RS resource. Of course, this is not limited to the examples below.

```
TABLE 6
-- ASN1START
-- TAG-NZP-CSI-RS-RESOURCE-START
NZP-CSI-RS-Resource ::= SEQUENCE {
  nzp-CSI-RS-ResourceId NZP-CSI-RS-ResourceId,
  resourceMapping CSI-RS-ResourceMapping,
  powerControlOffset INTEGER (−8..15),
  powerControlOffsetSS ENUMERATED{db−3, db0, db3, db6} OPTIONAL, -- Need R
  scramblingID ScramblingId,
  periodicity AndOffset CSI-ResourcePeriodicityAndOffset OPTIONAL, -- Cond
PeriodicOrSemiPersistent
  qcl-InfoPeriodicCSI-RS TCI-StateId OPTIONAL, -- Cond Periodic
  ...
}
-- TAG-NZP-CSI-RS-RESOURCE-STOP
-- ASN1STOP
```

The signaling information NZP-CSI-RS-Resource in Table 6 may include information relating to each CSI-RS. The information included in the signaling information NZP-CSI-RS-Resource may have meanings as below, but is not limited thereto:
nzp-CSI-RS-ResourceId: CSI-RS resource index;
resourceMapping: resource mapping information of CSI-RS resource;
powerControlOffset: ratio between PDSCH Energy Per RE (EPRE) and CSI-RS EPRE;
powerControlOffsetSS: ratio between SS/PBCH block EPRE and CSI-RS EPRE;
scramblingID: scrambling index of CSI-RS sequence;
periodicity AndOffset: transmission period of CSI-RS resource and slot offset;
and/or
qcl-InfoPeriodicCSI-RS: TCI-state information if corresponding CSI-RS is periodic CSI-RS.

The resourceMapping included in the signaling information NZP-CSI-RS-Resource indicates resource mapping information of the CSI-RS resource and may include at least one of mapping of resource elements (REs) of frequency resources, the number of ports, symbol mapping, CDM type, frequency resource density, and frequency band mapping information. The number of ports, the frequency resource density, the CDM type, and time-frequency axis RE mapping that can be configured through resourceMapping may have a determined value in one of rows of Table 7 below. Of course, this is not limited to the examples below.

TABLE 7

| | | | | | CDM | | |
|---|---|---|---|---|---|---|---|
| | Ports | Density | cdm- | | group | | |
| Row | χ | ρ | Type | (k̅, l̅) | index j | k′ | l′ |
| 1 | 1 | 3 | No CDM | (k₀, l₀), (k₀ + 4, l₀), (k₀ + 8, l₀) | 0, 0, 0 | 0 | 0 |
| 2 | 1 | 1, 0.5 | No CDM | (k₀, l₀) | 0 | 0 | 0 |
| 3 | 2 | 1, 0.5 | FD-CDM2 | (k₀, l₀) | 0 | 0, 1 | 0 |
| 4 | 4 | 1 | FD-CDM2 | (k₀, l₀), (k₀ + 2, l₀) | 0, 1 | 0, 1 | 0 |
| 5 | 4 | 1 | FD-CDM2 | (k₀, l₀), (k₀, l₀ + 1) | 0, 1 | 0, 1 | 0 |
| 6 | 8 | 1 | FD-CDM2 | (k₀, l₀), (k₁, l₀), (k₂, l₀) (k₃, l₀) | 0, 1, 2, 3 | 0, 1 | 0 |
| 7 | 8 | 1 | FD-CDM2 | (k₀, l₀), (k₁, l₀), (k₀, l₀ + 1), (k₁, l₀ + 1) | 0, 1, 2, 3 | 0, 1 | 0 |
| 8 | 8 | 1 | CDM4 | (k₀, l₀), (k₁, l₀) | 0, 1 | 0, 1 | 0, 1 |
| | | | (FD2, TD2) | | | | |
| 9 | 12 | 1 | FD-CDM2 | (k₀, l₀), (k₁, l₀), (k₂, l₀), (k₃, l₀), (k₄, l₀), (k₅, l₀) | 0, 1, 2, 3, 4, 5 | 0, 1 | 0 |
| 10 | 12 | 1 | CDM4 | (k₀, l₀), (k₁, l₀), (k₂, l₀) | 0, 1, 2 | 0, 1 | 0, 1 |
| | | | (FD2, TD2) | | | | |
| 11 | 16 | 1, 0.5 | FD-CDM2 | (k₀, l₀), (k₁, l₀), (k₂, l₀), (k₃, l₀), | 0, 1, 2, 3, | 0, 1 | 0 |
| | | | | (k₀, l₀ + 1), (k₁, l₀ + 1), (k₂, l₀ + 1), (k₃, l₀ + 1) | 4, 5, 6, 7 | | |
| 12 | 16 | 1, 0.5 | CDM4 | (k₀, l₀), (k₁, l₀), (k₂, l₀), (k₃, l₀) | 0, 1, 2, 3 | 0, 1 | 0, 1 |
| | | | (FD2, TD2) | | | | |
| 13 | 24 | 1, 0.5 | FD-CDM2 | (k₀, l₀), (k₁, l₀), (k₂, l₀), (k₀, l₀ + 1), (k₁, l₀ + 1), (k₂, l₀ + | 0, 1, 2, 3, 4, 5, | 0, 1 | 0 |
| | | | | (k₀, l₁), (k₁, l₁), (k₂, l₁), (k₀, l₁ + 1), (k₁, l₁ + 1), (k₂, l₁ + 1) | 6, 7, 8, 9, 10, 11 | | |
| 14 | 24 | 1, 0.5 | CDM4 | (k₀, l₀), (k₁, l₀), (k₂, l₀), (k₀, l₁), (k₁, l₁), (k₂, l₁) | 0, 1, 2, 3, 4, 5 | 0, 1 | 0, 1 |
| | | | (FD2, TD2) | | | | |
| 15 | 24 | 1, 0.5 | CDM8 | (k₀, l₀), (k₁, l₀), (k₂, l₀) | 0, 1, 2 | 0, 1 | 0, 1, 2, 3 |
| | | | (FD2, TD4) | | | | |
| 16 | 32 | 1, 0.5 | FD-CDM2 | (k₀, l₀), (k₁, l₀), (k₂, l₀), (k₃, l₀), | 0, 1, 2, 3, | 0, 1 | 0 |
| | | | | (k₀, l₀ + 1), (k₁, l₀ + 1), (k₂, l₀ + 1), (k₃, l₀ + 1), | 4, 5, 6, 7, | | |
| | | | | (k₀, l₁), (k₁, l₁), (k₂, l₁), (k₃, l₁) | 8, 9, 10, 11, | | |
| | | | | (k₀, l₁ + 1), (k₁, l₁ + 1), (k₂, l₁ + 1), (k₃, l₁ + 1) | 12, 13, 14, 15 | | |
| 17 | 32 | 1, 0.5 | CDM4 | (k₀, l₀), (k₁, l₀), (k₂, l₀), (k₃, l₀), (k₀, l₁), (k₁, l₁), (k₂, l₁), | 0, 1, 2, 3, 4, 5, | 0, 1 | 0, 1 |
| | | | (FD2, TD2) | | 6, 7 | | |
| 18 | 32 | 1, 0.5 | CDM8 | (k₀, l₀), (k₁, l₀), (k₂, l₀), (k₃, l₀) | 0, 1, 2, 3 | 0, 1 | 0, 1, 2, 3 |
| | | | (FD2, TD4) | | | | |

Table 7 shows a frequency resource density configurable according to the number (X) of CSI-RS ports, a CDM type, frequency and time domain starting positions (k, l) of a CSI-RS component RE pattern, and the number (k′) of frequency domain REs and the number (l′) of time domain REs of a CSI-RS component RE pattern. A CSI-RS component RE pattern described above may be a basic unit for configuring a CSI-RS resource. A CSI-RS component RE pattern may be configured by YZ number of REs through Y=1+max (k′) number of REs in the frequency domain and Z=1+max (l′) number of REs in the time domain. When the number of CSI-RS ports is 1, the position of a CSI-RS RE may be designated in a physical resource block (PRB) without restriction on subcarriers, and may be designated by a bitmap having 12 bits. When the number of CSI-RS ports is {2, 4, 8, 12, 16, 24, 32}, and Y is equal to 2 (Y=2), the position of a CSI-RS RE may be designated at every two subcarriers in a PRB, and may be designated by a bitmap having 6 bits. When the number of CSI-RS ports is 4, and Y is equal to 4 (Y=4), the position of a CSI-RS RE may be designated at every four subcarriers in a PRB, and may be designated by a bitmap having 3 bits. Similarly, the position of a time domain RE may be designated by a bitmap having a total of 14 bits.

### [CSI Report Configuration]

According to an embodiment of the disclosure, the report setting may be associated with each other by referencing to at least one of IDs of the resource setting. The resource setting(s) associated with the report setting may provide configuration information including information on a reference signal for measuring channel information. When the resource setting(s) associated with the report setting are used for measuring channel information, the measured channel information may be used for channel information reporting according to a reporting method configured in the associated report setting.

According to an embodiment of the disclosure, the resource setting may include configuration information relating to the CSI reporting method. For example, the base station and the UE may exchange signaling information described as shown Table 8 in order to transfer information relating to the resource setting. Of course, this is not limited to the examples below.

```
TABLE 8
-- ASN1START
-- TAG-CSI-REPORTCONFIG-START
CSI-ReportConfig ::= SEQUENCE {
  reportConfigId CSI-ReportConfigId,
  carrier ServCellIndex OPTIONAL, -- Need S
  resourcesForChannelMeasurement CSI-ResourceConfigId,
  csi-IM-ResourcesForInterference CSI-ResourceConfigId OPTIONAL, -- Need R
  nzp-CSI-RS-ResourcesForInterference CSI-ResourceConfigId OPTIONAL, -- Need R
  reportConfigType CHOICE {
    periodic SEQUENCE {
      reportSlotConfig CSI-ReportPeriodicityAndOffset,
      pucch-CSI-ResourceList SEQUENCE (SIZE (1..maxNrofBWPs)) OF PUCCH-CSI-Resource
    },
    semiPersistentOnPUCCH SEQUENCE {
      reportSlotConfig CSI-ReportPeriodicityAndOffset,
    pucch-CSI-ResourceList SEQUENCE (SIZE (1..maxNrofBWPs)) OF PUCCH-CSI-Resource
    },
    semiPersistentOnPUSCH SEQUENCE {
      reportSlotConfig ENUMERATED {sl5, sl10, sl20, sl40, sl80, sl160, sl320},
      reportSlotOffsetList SEQUENCE (SIZE (1..maxNrofUL-Allocations)) OF INTEGER(0..32),
      p0alpha P0-PUSCH-AlphaSetId
    },
    aperiodic SEQUENCE {
      reportSlotOffsetList SEQUENCE (SIZE (1..maxNrofUL-Allocations)) OF INTEGER(0..32)
    }
  },
  reportQuantity CHOICE {
    none NULL,
    cri-RI-PMI-CQI NULL,
    cri-RI-il NULL,
    cri-RI-i1-CQI SEQUENCE {
      pdsch-BundleSizeForCSI ENUMERATED {n2, n4} OPTIONAL -- Need S
    },
    cri-RI-CQI NULL,
    cri-RSRP NULL,
    ssb-Index-RSRP NULL,
    cri-RI-LI-PMI-CQI NULL
  },
  reportFreqConfiguration SEQUENCE {
    cqi-FormatIndicator ENUMERATED { widebandCQI, subbandCQI } OPTIONAL, -- Need
R
    pmi-FormatIndicator ENUMERATED { widebandPMI, subbandPMI } OPTIONAL, -- Need
R
  csi-ReportingBand CHOICE {
    subbands3 BIT STRING(SIZE(3)),
    subbands4 BIT STRING(SIZE(4)),
    subbands5 BIT STRING(SIZE(5)),
    subbands6 BIT STRING(SIZE(6)),
    subbands7 BIT STRING(SIZE(7)),
    subbands8 BIT STRING(SIZE(8)),
    subbands9 BIT STRING(SIZE(9)),
    subbands10 BIT STRING(SIZE(10)),
    subbands11 BIT STRING(SIZE(11)),
    subbands12 BIT STRING(SIZE(12)),
    subbands13 BIT STRING(SIZE(13)),
    subbands14 BIT STRING(SIZE(14)),
    subbands15 BIT STRING(SIZE(15)),
    subbands16 BIT STRING(SIZE(16)),
    subbands17 BIT STRING(SIZE(17)),
    subbands18 BIT STRING(SIZE(18)),
    ...,
    subbands19-v1530 BIT STRING(SIZE(19))
    } OPTIONAL -- Need S
  } OPTIONAL, -- Need R
  timeRestrictionForChannelMeasurements ENUMERATED {configured, notConfigured},
  timeRestrictionForInterferenceMeasurements ENUMERATED {configured, notConfigured},
  codebookConfig CodebookConfig OPTIONAL, -- Need R
  dummy ENUMERATED {n1, n2} OPTIONAL, -- Need R
  groupBasedBeamReporting CHOICE {
    enabled NULL,
    disabled SEQUENCE {
      nrofReportedRS ENUMERATED {n1, n2, n3, n4} OPTIONAL -- Need S
    }
  },
  cqi-Table ENUMERATED {table1, table2, table3, spare1} OPTIONAL, -- Need R
  subbandSize ENUMERATED {value1, value2},
  non-PMI-PortIndication SEQUENCE (SIZE (1..maxNrofNZP-CSI-RS-ResourcesPerConfig)) OF
PortIndexFor8Ranks OPTIONAL, -- Need R
  ...,
  [[
  semiPersistentOnPUSCH-v1530 SEQUENCE {
    reportSlotConfig-v1530 ENUMERATED {sl4, sl8, sl16}
  } OPTIONAL -- Need R
  ]]
}
```

In Table 8, the signaling information CSI-ReportConfig may contain information about each report setting. The information included in the signaling information CSI-ReportConfig may have the following meanings. This is not limited to the following examples:
reportConfigId: report setting index;
carrier: serving cell index;
resourcesForChannelMeasurement: resource setting index for channel measurement that has a relationship with the report setting;
csi-IM-ResourcesForInterference: resource setting index with CSI-IM resources for interference measurement associated with report settings;
nzp-CSI-RS-ResourcesForInterference: index of resource settings with CSI-RS resources for interference measurement that are associated with the report setting;
reportConfigType: this may indicate the time axis transmission configuration and transmission channel for channel reporting, and may have a configuration of aperiodic transmission, semi-persistent physical uplink control channel (PUCCH) transmission, semi-persistent PUSCH transmission, or periodic transmission;
reportQuantity: indicates types of reported channel information, and may have channel information types (“cri-RI-PMI-CQI,” “cri-RI-i1,” “cri-RI-i1-CQI,” “cri-RI-CQI,” “cri-RSRP,” “ssb-Index-RSRP,” and “cri-RI-LI-PMI-CQI”) in case that no channel report is transmitted (“none”) and that channel report is transmitted. Here, elements included in channel information types are channel quality indicator (CQI), precoding matric indicator (PMI), CSI-RS resource indicator (CRI), SS/PBCH block resource indicator (SSBRI), layer indicator (LI), rank indicator (RI), and/or reference signal received power (L1-RSRP);
reportFreqConfiguration: may indicate whether reported channel information includes only information on an entire bandwidth (wideband) or may include information on each subband and has configuration information of a subband including channel information if reported channel information includes information on each subband;
timeRestrictionForChannelMeasurements: time axis restriction of reference signal for channel measurement in reference signals referred to by reported channel information;
timeRestrictionForInferenceMeasurements: time axis restriction of reference signal for interference measurement in reference signals referred to by reported channel information;
codebookConfig: codebook information referred to by reported channel information;
groupBasedBeamReporting: beam grouping of channel report;
cqi-Table: CQI table index referred to by reported channel information;
subbandSize: index indicating subband size of channel information; and/or
non-PMI-PortIndication: port mapping information referred to when non-PMI channel information is reported.

When the base station indicates a channel information report through high-layer signaling or L1 signaling, the UE may perform the channel information report with reference to the configuration information included in the indicated report setting.

The base station may indicate the channel state information (CSI) report to the UE through higher layer signaling including radio resource control (RRC) signaling or medium access control (MAC) control element (CE) signaling or L1 signaling (for example, common DCI, group-common DCI, or UE-specific DCI).

For example, the base station may indicate an aperiodic channel information report to the UE through higher layer signaling or DCI using DCI format 0_1. The base station may configure a plurality of CSI report trigger states including a parameter for the aperiodic CSI report of the UE or a parameter for the CSI report through higher layer signaling. The parameter for the CSI report or the CSI report trigger state may include at least one of a slot interval between a PDCCH including DCI and a PUSCH including the CSI report or a set of available slot intervals, a reference signal ID for channel state measurement, and a type of channel information included in the CSI report. When the base station indicates some of the plurality of CSI report trigger states to the UE through DCI, the UE may report channel information according to the CSI report configuration of report setting configured in the indicated CSI report trigger state. Channel information reporting may be performed via a PUSCH scheduled in DCI format 0_1. The time-axis resource allocation of the PUSCH containing the CSI report of the UE may be accomplished via at least one of the slot interval with the PDCCH indicated via DCI, or the start symbol and symbol length indication within the slot for the time-axis resource allocation of the PUSCH. For example, the location of the slot in which the PUSCH containing the CSI report of the UE is transmitted may be indicated via the slot interval from the PDCCH indicated via the DCI, and the start symbol and symbol length within the slot may be indicated via the time domain resource assignment field of the DCI described above.

For example, the base station may indicate, to the UE, a semi-persistent CSI report transmitted to a PUSCH via DCI using DCI format 0_1. The base station may activate or deactivate the semi-persistent CSI report transmitted to PUSCH via DCI scrambled by SP-CSI-RNTI. When the semi-persistent CSI report is activated, the UE may periodically report channel information according to the configured slot interval. When the semi-persistent CSI report is deactivated, the UE may stop the activated periodic channel information report. The base station may configure a plurality of CSI report trigger states including a parameter for the semi-persistent CSI report of the UE or a parameter for the semi-persistent CSI report through higher layer signaling. The parameter for the CSI report or the CSI report trigger state may include at least one of a slot interval between a PDCCH including DCI indicating the CSI report and a PUSCH including the CSI report or a set including available slot intervals, a slot interval between a slot in which higher layer signaling indicating the CSI report is activated and the PUSCH including the CSI report, a slot interval period of the CSI report, and a type of channel information included in the CSI report.

When the base station activates some of a plurality of CSI report trigger states or some of a plurality of report settings in the UE through higher layer signaling or DCI, the UE may report channel information according to the report setting included in the indicated CSI report trigger state or a CSI report configuration configured in the activated report setting. Channel information reporting may be performed via semi-persistently scheduled PUSCHs in DCI format 0_1 scrambled by SP-CSI-RNTI. Time axis resource allocation of the PUSCH including the CSI report of the UE may be accomplished through at least one of a slot interval period of the CSI report, a slot interval with the slot in which higher layer signaling is activated or a slot interval with the PDCCH indicated through DCI, a start symbol within the slot for time axis resource allocation of the PUSCH, and a symbol length indication. For example, the location of the slot in which the PUSCH including the CSI report of the UE is transmitted may be indicated through a slot interval with the PDCCH indicated through DCI. The start symbol within the slot and the symbol length may be indicated through a time domain resource assignment field of DCI format 0_1.

For example, the base station may indicate, to the UE, a semi-persistent CSI report transmitted to a PUCCH via higher layer signaling, such as MAC-CE. MAC-CE signaling allows the base station to activate or deactivate the semi-persistent CSI reports transmitted to the PUCCH. When semi-persistent CSI reports are activated, the UE may report channel information periodically according to the configured slot interval. When semi-persistent CSI report is deactivated, the UE may stop reporting periodic channel information that has been activated. The base station may configure the parameters for the semi-persistent CSI report of the UE through higher layer signaling. The parameter for the CSI report may include at least one of the following: the PUCCH resource on which the CSI report is transmitted, the slot interval frequency of the CSI report, or the type of channel information included in the CSI report. The UE may transmit the CSI report through a PUCCH. Alternatively, the UE may transmit the CSI report through a PUSCH if the PUCCH for the CSI report overlaps the PUSCH. The location of the PUCCH transmission slot containing the CSI report may be indicated by the slot interval period of the CSI report configured through higher layer signaling, and/or the slot interval between the slot in which higher layer signaling is activated and the PUCCH containing the CSI report. The start symbol within a slot and the symbol length may be indicated through a start symbol to which the PUCCH resources configured through higher layer signaling are allocated and a symbol length.

For example, the base station may indicate a periodic CSI report to the UE through higher layer signaling. The base station may activate or deactivate the periodic CSI report through higher layer signaling including RRC signaling. When the periodic CSI report is activated, the UE may periodically report channel information according to the configured slot interval. When the periodic CSI report is deactivated, the UE may stop the activated periodic channel information report. The base station may configure report setting including the parameter for the periodic CSI report of the UE through higher layer signaling. The parameter for the CSI report may include at least one of a PUCCH resource configuration for the CSI report, a slot interval between a slot in which higher layer signaling indicating the CSI report is activated and a PUCCH including the CSI report, a slot interval period of the CSI report, a reference signal ID for channel state measurement, or a type of channel information included in the CSI report. The UE may transmit the CSI report through the PUCCH.

Alternatively, the UE may transmit the CSI report through the PUSCH if the PUCCH for the CSI report overlaps with the PUSCH. The location of the slot in which the PUCCH including the CSI report is transmitted may be indicated through a slot interval period of the CSI report configured through higher layer signaling and a slot interval between a slot in which higher layer signaling is activated and the PUCCH including the CSI report. A start symbol within the slot and the symbol length may be indicated through a start symbol to which the PUCCH resources configured through higher layer signaling is allocated and a symbol length.

Regarding the aforementioned CSI report setting (CSI-ReportConfig), each report setting (CSI-ReportConfig) may be associated with CSI resource setting associated with corresponding report setting and one downlink (DL) BWP identified by a higher layer parameter bandwidth part identifier (bwp-id) given by CSI-ResourceConfig. A time-domain reporting operation with respect to each report setting (CSI-ReportConfig) may support an “aperiodic,” “semi-persistent,” or “periodic” scheme, and the reporting method may be configured from the base station for the UE by a reportConfigType parameter configured via a higher layer. A semi-persistent CSI reporting method supports a “PUCCH-based semi-persistent (semi-PersistentOnPUCCH)” reporting method and a “PUSCH-based semi-persistent (semi-PersistentOnPUSCH)” reporting method. In the case of the periodic or semi-persistent CSI reporting method, the UE may be configured, from the base station by higher layer signaling, with a PUCCH or PUSCH resource to transmit CSI. The periodicity and slot offset of the PUCCH or PUSCH resource to transmit CSI may be given by numerology of an uplink (UL) BWP configured for transmission of the CSI report. In the case of the aperiodic CSI reporting method, the UE may receive, from the base station by L1 signaling (DCI format 0_1 described above), scheduling of a PUSCH resource to transmit CSI.

Regarding the CSI resource setting (CSI-ResourceConfig), each CSI resource setting CSI-ReportConfig may include S(≥1) CSI resource sets (given by higher layer parameter csi-RS-ResourceSetList). The CSI resource set list may be configured by a non-zero power (NZP) CSI-RS resource set and an SS/PBCH block set or may be configured by a CSI-interference measurement (CSI-IM) resource set. Each CSI resource setting may be located on a downlink (DL) BWP identified by higher layer parameter bwp-id, and the CSI resource setting may be associated with CSI report setting of the same DL BWP. A time-domain operation of a CSI-RS resource in the CSI resource setting may be configured to be one of “aperiodic,” “periodic,” or “semi-persistent” by higher layer parameter resourceType. For the periodic or semi-persistent CSI resource setting, the number of CSI-RS resource sets may be limited to S=1, and configured periodicity and slot offset may be given by numerology of the DL BWP identified by bwp-id.

The UE may be configured, from the base station by higher layer signaling, with one or more CSI resource settings for channel or interference measurement, and for example, the CSI resource settings configured by the base station may include CSI resources below:
CSI-IM resource for interference measurement;
NZP CSI-RS resource for interference measurement; and/or
NZP CSI-RS resource for channel measurement.

For CSI-RS resource sets associated with resource setting configured to be “aperiodic,” “periodic,” or “semi-persistent” by higher layer parameter resourceType, a trigger state with respect to CSI report setting in which reportType is configured to be “aperiodic” and resource setting for channel or interference measurement of one or more component cells (CCs) may be configured by higher layer parameter CSI-AperiodicTriggerStateList.

The aperiodic CSI reporting of the UE may be performed by using a PUSCH. The periodic CSI reporting of the UE may be performed by using a PUCCH. In case that the semi-persistent CSI reporting is triggered or activated by DCI, the semi-persistent CSI reporting of the UE may be performed by using a PUSCH, and after the semi-persistent CSI reporting is activated by a MAC control element (CE), the semi-persistent CSI reporting of the UE may be performed by using a PUCCH. As described above, CSI resource setting may also be configured to be “aperiodic,” “periodic” or “semi-persistent.” Combinations of the CSI report setting and the CSI resource setting may be supported based on Table 9 below, but may not be limited thereto.

TABLE 9
Table 5.2.1.4-1: Triggering/Activation of CSI Reporting for the possible CSI-RS Configurations.

| | | Semi-Persistent | |
|---|---|---|---|
| CSI-RS | Periodic CSI | CSI | Aperiodic CSI |
| Configuration | Reporting | Reporting | Reporting |
| Periodic CSI-RS | No dynamic | For reporting on | Triggered by DCI; |
| | triggering/activation | PUCCH, the UE | additionally, |
| | | receives an activation | activation command |
| | | command [10, TS | [10, TS 38.321] |
| | | 38.321]; for reporting | possible as defined in |
| | | on PUSCH, the UE | Subclause 5.2.1.5.1. |
| | | receives triggering on | |
| | | DCI | |
| Semi-Persistent CSI-RS | Not Supported | For reporting on | Triggered by DCI; |
| | | PUCCH, the UE | additionally, |
| | | receives an activation | activation command |
| | | command [10, TS | [10, TS 38.321] |
| | | 38.321]; for reporting | possible as defined in |
| | | on PUSCH, the UE | Subclause 5.2.1.5.1. |
| | | receives triggering on | |
| | | DCI | |
| Aperiodic CSI-RS | Not Supported | Not Supported | Triggered by DCI; |
| | | | additionally, |
| | | | activation command |
| | | | [10, TS 38.321] |
| | | | possible as defined in |
| | | | Subclause 5.2.1.5.1. |

The aperiodic CSI reporting may be triggered by a “CSI request” field of the aforementioned DCI format 0_1 corresponding to scheduling DCI with respect to a PUSCH. The UE may monitor a PDCCH, may obtain the DCI format 0_1, and may obtain scheduling information with respect to a PUSCH and a CSI request indicator. The CSI request indicator may be configured with NTS(=0, 1, 2, 3, 4, 5, or 6) bits, and may be determined by higher layer signaling (reportTriggerSize). One trigger state from among one or multiple aperiodic CSI report trigger states configurable by higher layer signaling (CSI-AperiodicTriggerStateList) may be triggered by the CSI request indicator. Of course, this is not limited to the examples below.
When all bits of the CSI request field are 0, this may indicate that a CSI report is not requested.
If the number (M) of CSI trigger states in configured CSI-AperiodicTriggerStateLite is greater than 2NTs-1, M CSI trigger states may be mapped to 2NTs-1 according to a predefined mapping relation, and one trigger state from among 2NTs-1 CSI trigger states may be indicated by the CSI request field.
If the number (M) of CSI trigger states in configured CSI-AperiodicTriggerStateLite is equal to or smaller than 2NTs-1, one of M CSI trigger states may be indicated by the CSI request field.

Table 10 below shows an example of a relation between a CSI request indicator and a CSI trigger state indicative by the indicator. Of course, this is not limited to the examples below.

TABLE 10

| CSI request | CSI | CSI- | CSI- |
|---|---|---|---|
| field | trigger state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

The UE may perform measurement on a CSI resource in the CSI trigger state triggered by the CSI request field and may generate CSI (including at least one of CQI, PMI, CRI, SSBRI, LI, RI, or LI-RSRP described above) from a result of the measurement. The UE may transmit the obtained CSI by using the PUSCH scheduled by the corresponding DCI format 0_1. When one bit corresponding to an uplink (UL) data indicator (UL-SCH indicator) in the DCI format 0_1 indicates “1,” the UE may multiplex UL data (UL-SCH) and the obtained CSI with a PUSCH resource scheduled by the DCI format 0_1 and may transmit the same. When one bit corresponding to a UL data indicator (UL-SCH indicator) in the DCI format 0_1 indicates “0,” the UE may map only the CSI to a PUSCH resource scheduled by the DCI format 0_1, without UL data (UL-SCH), and may transmit the same.

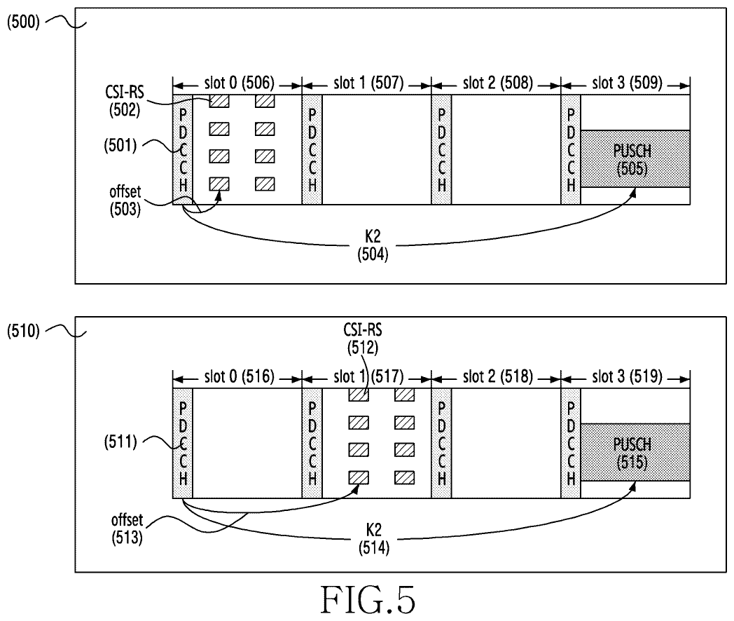

FIG. 5 illustrates examples of an aperiodic CSI reporting method according to an embodiment of the present disclosure.

Referring to FIG. 5, in an example (indicated by reference numeral 500), the UE may obtain DCI format 0_1 by monitoring a PDCCH 501, and may obtain, from the DCI format 0_1, scheduling information with respect to a PUSCH 505 and CSI request information. The UE may obtain, from the received CSI request indicator, resource information with respect to a CSI-RS 502 to be measured. Based on a time point of reception of the DCI format 0_1 and a parameter (aforementioned aperiodicTriggeringOffset) with respect to offset within CSI resource set configuration (e.g., NZP CSI-RS resource set configuration (NZP-CSI-RS-ResourceSet)), the UE may determine that the measurement of the CSI-RS 502 transmitted at a predetermined time point may be performed. More specifically, the UE may be configured, from the base station by higher layer signaling, with an offset value X of parameter aperiodicTriggeringOffset in NZP-CSI-RS resource set configuration. The configured offset value X may indicate offset between a slot in which DCI to trigger an aperiodic CSI report is received and a slot in which a CSI-RS resource is to be transmitted. For example, the parameter value of the aperiodicTriggeringOffset and the offset value X may have mapping relations described in Table 11 below. Of course, this is not limited to the examples below.

TABLE 11

| aperiodicTriggeringOffset | Offset X |
|---|---|
| 0 | 0 slot |
| 1 | 1 slot |
| 2 | 2 slots |
| 3 | 3 slots |
| 4 | 4 slots |
| 5 | 16 slots |
| 6 | 24 slots |

In the example 500 of FIG. 5, the aforementioned offset value is configured as X=0. In this case, the UE may receive the CSI-RS 502 in a slot (corresponding to a slot 0 506 of FIG. 5) in which the DCI format 0_1 triggering the aperiodic CSI report is received. In addition, the UE may report CSI information to the base station through the PUSCH 505, the CSI information being measured by using the received CSI-RS. The UE may obtain, from the DCI format 0_1, scheduling information (pieces of information respectively corresponding to fields of the DCI format 0_1) with respect to the PUSCH 505 for a CSI report. For example, the UE may obtain information about a slot in which the PUSCH 505 is to be transmitted, from time-domain resource allocation information of the DCI format 0_1 with respect to the PUSCH 505. In the example 500 of FIG. 5, the UE may obtain 3 as a value of K2 corresponding to a slot offset value for PDCCH-to-PUSCH. Accordingly, the PUSCH 505 may be transmitted in a slot 3 509 that is distant, by 3 slots, at a time point at which the PDCCH 501 is received (e.g., a slot 0 506).

In an example 510 of FIG. 5, the UE may obtain DCI format 0_1 by monitoring a PDCCH 511, and may obtain, from the DCI format 0_1, scheduling information with respect to a PUSCH 515 and CSI request information. The UE may obtain, from a received CSI request indicator, resource information with respect to a CSI-RS 512 to be measured. In the example 510 of FIG. 5, the aforementioned offset value for CSI-RS is configured as X=1. In this case, the UE may receive the CSI-RS 512 in a slot (slot 0 516 of FIG. 5) in which the DCI format 0_1 triggering an aperiodic CSI report is received, and may report, to the base station via the PUSCH 515, CSI information measured by using a received CSI-RS.

The aperiodic CSI report may include at least one of CSI part 1 or CSI part 2 or both CSI part 1 and CSI part 2. In case that the aperiodic CSI report is to be transmitted through a PUSCH, the aperiodic CSI report and a transport block may be multiplexed. For the multiplexing, a CRC may be inserted into an input bit of aperiodic CSI and encoding and rate matching may be performed thereon, and then, the input bit may be mapped with a particular pattern to a resource element in a PUSCH and transmitted. The CRC insertion may be omitted depending on a coding method or a length of input bits. The number of modulation symbols to be calculated for rate matching in multiplexing of CSI part 1 or CSI part 2 included in the aperiodic CSI report may be calculated as in Table 12 below. Of course, this is not limited to the examples below.

TABLE 12
For CSI part 1 transmission on PUSCH not using repetition type B with UL-SCH, the number of
coded modulation symbols per layer for CSI part 1 transmission, denoted as Q_{CSI-part1}′ , is
determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ ,$ $⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$ $…$
For CSI part 1 transmission on an actual repetition of a PUSCH with repetition Type B with UL-
SCH, the number of coded modulation symbols per layer for CSI part 1 transmission, denoted as
Q_{CSI-part1}′, is determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ ,$ $⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} , {\sum }_{l = 0}^{{N}_{symb , actual}^{PUSCH} - 1} {M}_{sc , actual}^{UCI} ( l ) - {Q}_{ACK / CG - UCI}^{′} \}$ $…$
For CSI part 1 transmission on PUSCH without UL-SCH, the number of coded modulation
symbols per layer for CSI part 1 transmission, denoted as Q_{CSI-part1}′, is determined as follows:
if there is CSI part 2 to be transmitted on the PUSCH,
${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$ $else$ ${Q}_{CSI - 1}^{′} = {\sum }_{l = 0}^{{N}_{symb , all}^{PUSCH} - 1} {M}_{sc}^{UCI} ( l ) - {Q}_{ACK}^{′}$
end if
...
For CSI part 2 transmission on PUSCH not using repetition type B with UL-SCH, the number of
coded modulation symbols per layer for CSI part 2 transmission, denoted as Q_{CSI-part2}′ , is
determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ ,$ $⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \}$
For CSI part 2 transmission on an actual repetition of a PUSCH with repetition Type B with UL-
SCH, the number of coded modulation symbols per layer for CSI part 2 transmission, denoted as
Q_{CSI-part2}′, is determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ ,$ $⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} ,$ ${\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′} \}$ $…$
For CSI part 2 transmission on PUSCH without UL-SCH, the number of coded modulation
symbols per layer for CSI part 2 transmission, denoted as Q_{CSI-part2}′, is determined as follows:
Q_{CSI-2}′ = Σₜ₌₀^{N}_{_{symb,all}}^{^{PUSCH}}⁻¹ M_{sc}^{UCI}(l) − Q_{ACK}′ − Q_{CSI-1}′

In particular, in the case of PUSCH repetition types A and B, the UE may multiplex and transmit the aperiodic CSI report only in first repeated transmission from among PUSCH repeated transmissions. According to the aforementioned transmission method, the aperiodic CSI report information to be multiplexed is encoded by using a polar code scheme, and here, in order to multiplex the aperiodic CSI report information for multiple PUSCH repetitions, each of the PUSCH repetitions may have the same frequency and time resource allocation. Particularly, in a case of the PUSCH repetition type B, each actual repetition may have a different OFDM symbol length, and thus, the aperiodic CSI report may be multiplexed and transmitted only in first PUSCH repetition.

In addition, for the PUSCH repetition type B, in case that the UE receives DCI to schedule the aperiodic CSI report or to activate a semi-persistent CSI report without scheduling of a transport block, even when the number of PUSCH repeated transmissions configured by higher layer signaling is greater than 1, the UE may assume a value of nominal repetition as 1. In addition, when the UE schedules or activates the aperiodic or semi-persistent CSI report without scheduling of a transport block based on the PUSCH repetition type B, the UE may expect that first nominal repetition is the same as first actual repetition. For a PUSCH being transmitted while including semi-persistent CSI based on the PUSCH repetition type B without scheduling of DCI after the semi-persistent CSI report is activated by DCI, if first nominal repetition is different from first actual repetition, transmission with respect to the first nominal repetition may be ignored.

### [CSI Computation Time]

When the base station indicates the aperiodic CSI report or the semi-persistent CSI report to the UE through DCI, it may be determined that the UE is able to perform a valid channel report through the indicated CSI report in consideration of a channel computation time required for the CSI report (CSI computation time). For the aperiodic CSI report or the semi-persistent CSI report indicated through DCI, the UE may perform the valid CSI report from an uplink symbol after Z symbols from the end of the last symbol included in the PDCCH including DCI indicating the CSI report. The aforementioned Z symbols may differ depending on numerology of a downlink BWP corresponding to the PDCCH including DCI indicating the CSI report, numerology of an uplink BWP corresponding to the PUSCH transmitting the CSI report, and a type or a characteristic of channel information reported by the CSI report (e.g., report quantity, frequency band granularity, the number of ports of reference signals, and a codebook type).

In other words, it may be understood to mean that in order to determine a CSI report to be valid (in order to make a CSI report to be a valid CSI report), uplink transmission of the CSI report may not be performed earlier than a symbol Zref, including timing advance. Here, the symbol Zref may be an uplink symbol starting a cyclic prefix (CP) after a time T_{proc,CSI}=(Z)(2048+144)·K2^{-μ}·T_{C} from the moment at which the last symbol of the triggering PDCCH ends. A detailed value of Z follows the description below, and T_{c}=1/(Δfₘₐₓ·N_{f}), Δfₘₐₓ=480·10³ Hz, N_{f}=4096, κ=64, and μ may be numerology. In this case, μ may be appointed such that a value causing the largest T_{proc,CSI} among (μ_{PDCCH}, μ_{CSI-RS}, μ_{UL}) is used, μ_{PDCCH} denotes subcarrier spacing used for PDCCH transmission, μ_{CSI-RS} denotes subcarrier spacing used for CSI-RS transmission, and μ_{UL} denotes subcarrier spacing of an uplink channel used for uplink control information (UCI) transmission for CSI reporting. In an example, μ may be appointed such that a value causing the largest T_{proc,CSI} among (μ_{PDCCH}, μ_{UL}) is used. Definition of μ_{PDCCH} and μ_{UL} refer to the above description. For convenience of later description, satisfaction of the above condition may be referred to as satisfaction of CSI reporting validity condition 1.

When the reference signal for channel measurement for the aperiodic CSI report indicated to the UE through DCI is an aperiodic reference signal, the UE may perform the valid CSI report from an uplink symbol after Z′ symbols from the end of the last symbol including the reference signal, and the Z′ symbols may differ depending on numerology of a downlink BWP corresponding to the PDCCH including DCI indicating the CSI report, numerology of a BWP corresponding to a reference signal for channel measurement for the CSI report, numerology of an uplink BWP corresponding to the PUSCH transmitting the CSI report, and a type or a characteristic of channel information reported by the CSI report (e.g., report quantity, frequency band granularity, the number of ports of reference signals, or codebook type).

In other words, in order to determine which CSI report is valid (in order to make the corresponding CSI report a valid CSI report), uplink transmission of the corresponding CSI report may not be performed earlier than a symbol Zref′, including timing advance. Here, the symbol Zref′ may be an uplink symbol starting a cyclic prefix (CP) after a time T′_{proc,CSI}=(Z′)(2048+144)·K2^{-μ}. T_{C} from the moment at which the last symbol of the aperiodic CSI-RS or aperiodic CSI-IM triggered by the triggering PDCCH ends. In this case, a detailed value of Z′ follows the description below, and T_{c}=1/(Δfₘₐₓ·N_{f}), Δfₘₐₓ=480·10³ Hz, N_{f}=4096, κ=64, and μ may be numerology. In this case, μ may be appointed such that a value causing the largest T_{proc,CSI} among (μ_{PDCCH}, μ_{CSI-RS}, μ_{UL}) is used, μ_{PDCCH} denotes subcarrier spacing used for PDCCH transmission, μ_{CSI-RS} denotes subcarrier spacing used for CSI-RS transmission, and Luz denotes subcarrier spacing of an uplink channel used for uplink control information (UCI) transmission for CSI reporting. In an example, μ may be appointed such that a value causing the largest T_{proc,CSI} among (μ_{PDCCH}, μ_{UL}) is used. Definition of μ_{PDCCH} and μ_{UL} refer to the above description. For convenience of later description, satisfaction of the above condition may mean satisfaction of CSI reporting validity condition 2.

When the base station indicates the aperiodic CSI report for the aperiodic reference signal to the UE through DCI, the UE may perform the valid CSI report from a first uplink symbol satisfying both a time point after Z symbols after the end of the last symbol included in the PDCCH including DCI indicating the CSI report and a time point after Z′ symbols after the end of the last symbol including the reference signal. For example, only when both CSI reporting validity conditions 1 and 2 are satisfied, the aperiodic CSI reporting based on the aperiodic reference signal may be determined as the valid CSI report.

When the CSI report time point indicated by the base station does not satisfy a CSI computation time requirement, the UE may determine that the CSI report that does not satisfy the CSI computation time requirement is not valid and may not consider an update of the channel information state for the CSI report.

The Z and Z′ symbols for calculating the CSI computation time may follow Table 13 and Table 14 below. For example, when channel information reported by the CSI report includes only wideband information, the number of ports of the reference signal is equal to or smaller than 4, the number of reference signal resources is 1, and the codebook type is “typeI-SinglePanel” or the report channel information type (report quantity) is “cri-RI-CQI,” the Z and Z′ symbols follow values of Z₁ and Z₁′ in Table 14. The aforementioned condition may be referred to as delay requirement 2. In addition, when the PUSCH including the CSI report does not include a TB or HARQ-ACK and CPU occupation of the UE is 0, the Z and Z′ symbols follow values of Z₁ and Z₁′ of Table 13. The aforementioned condition may be named delay requirement 1. The aforementioned CPU occupation may be explained in more detail below. In addition, when the report quantity is “cri-RSRP” or “ssb-Index-RSRP,” the Z and Z′ symbols may follow values of Z₃ and Z₃′ in Table 14. X1, X2, X3, and X4 in Table 14 may indicate UE capability for a beam report time, and KB₁ and KB₂ in Table 14 may indicate UE capability for a beam change time. In case of not corresponding to the type or the characteristic of the channel information reported by the CSI report, Z and Z′ symbols may follow Z₂ and Z₂′ in Table 14. Of course, this is not limited to the example below.

TABLE 13

| | Z₁ [symbols] | |
|---|---|---|
| μ | Z₁ | Z′₁ |
| 0 | 10 | 8 |
| 1 | 13 | 11 |
| 2 | 25 | 21 |
| 3 | 43 | 36 |

TABLE 14

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₁ |
| 1 | 33 | 30 | 72 | 69 | 33 | X₂ |
| 2 | 44 | 42 | 141 | 140 | min(44, X₃ + KB₁) | X₃ |
| 3 | 97 | 85 | 152 | 140 | min(97, X₄ + KB₂) | X₄ |

### [CSI Reference Resource]

When indicating the aperiodic/semi-persistent/periodic CSI report to the UE, the base station may configure a CSI reference resource to determine a reference time and frequency for the channel to be reported in the CSI report. The frequency of the CSI reference resource may be information on a carrier and a subband in which CSI is to be measured, as indicated in the CSI report configuration. The information on the carrier and subband to measure CSI may correspond to the carrier and reportFreqConfiguration in the higher layer signaling CSI-ReportConfig, respectively. The time of the CSI reference resource may be defined based on the time at which the CSI report is transmitted. For example, when CSI report #X is indicated to be transmitted in an uplink slot n′ of the carrier and BWP in which the CSI report is to be transmitted, the time of the CSI reference resource for CSI report #X may be defined as downlink slot n-nCSI-ref of the carrier and BWP in which the CSI is measured. Downlink slot n is calculated as n=└n′·2^{μ}^{_{DL}}/2^{μ}^{_{UL}}┘ when the numerology of the carrier and BWP measuring CSI is named as μDL, and the numerology of the carrier and BWP transmitting CSI report #X is named as μUL, respectively.

In case that CSI report #X transmitted in uplink slot n′ is the semi-persistent report or the periodic CSI report, nCSI-ref that is a slot interval between downlink slot n and the CSI reference resource may follow n_{CSI-ref}=4·2^{μ}^{_{DL}} if a single CSI-RS/SSB resource is connected to the corresponding CSI report according to the number of CSI-RS/SSB resources for channel measurement, and may follow n_{CSI-ref}=5·2^{μ}^{_{DL}} if multiple CSI-RS/SSB resources are connected to the CSI report. When CSI report #X transmitted in uplink slot n′ is the aperiodic CSI report, n_{CSI-ref}=└Z′/N_{symb}^{slot}┘ calculated in consideration of the CSI computation time Z′ for channel measurement. The aforementioned N_{symb}^{slot} is the number of symbols included in one slot, and it may be assumed that N_{symb}^{slot}=14 in NR.

When the base station indicates transmission of any CSI report in uplink slot n′ to the UE through higher layer signaling or DCI, the UE may report the CSI by performing channel measurement or interference measurement for CSI-RS resources, CSI-IM resources, or SSB resources that are transmitted not later than a CSI reference resource slot of the CSI report transmitted in uplink slot n′ among CSI-RS resources, CSI-IM resources, or SSB resources associated with the CSI report indicated to be transmitted by the base station. The CSI-RS resources associated with the CSI report indicated to be transmitted by the base station, the CSI-IM resources, or the SSB resources may be CSI-RS resources, CSI-IM resources, or SSB resources, which are included in the resource set configured in resource setting referred to by report setting for the CSI report of the UE configured through higher layer signaling. Alternatively, the CSI-RS resources associated with the CSI report indicated to be transmitted by the base station, the CSI-IM resources, or the SSB resources may indicate CSI-RS resources, CSI-IM resources, or SSB resources, which are referred to by a CSI report trigger state including a parameter for the CSI report, or CSI-RS resources, CSI-IM resources, or SSB resources, which are indicated by an ID of a reference signal (RS) set.

In some embodiments of the disclosure, the CSI-RS/CSI-IM/SSB occasion may indicate a time point at which CSI-RS/CSI-IM.SSB resource(s) determined by a higher layer configuration or a combination of the higher layer configuration and DCI triggering are transmitted. For example, with respect to the semi-persistent or periodic CSI-RS resources, a slot transmitted according to a slot period and a slot offset configured through higher layer signaling may be determined, and transmission symbol(s) within the slot may be determined according to resource mapping information (resourceMapping). In an example, with respect to the aperiodic CSI-RS resources, a slot transmitted according to a slot offset with the PDCCH including DCI indicating the channel report configured through higher layer signaling may be determined, and transmission symbol(s) within the slot may be determined according to resource mapping information (resourceMapping).

The aforementioned CSI-RS occasion may be determined by independently considering a time point at which each CSI-RS resource is transmitted or by comprehensively considering a time point at which one or more CSI-RS resource(s) included in the resource set are transmitted. According to the aforementioned methods, two interpretations below are possible for the CSI-RS occasion according to each resource set configuration. This is not limited to the examples below:
Interpretation 1-1: from a start point of the earliest symbol to an end point of the latest symbol in which one specific resource is transmitted among one or more CSI-RS resources included in resource set(s) configured in resource setting referred to by report setting configured for the CSI report, and
Interpretation 1-2: from a start point of the earliest symbol in which CSI-RS resources transmitted at the earliest time point are transmitted to an end point of the latest symbol in which CSI-RS resources transmitted at the latest time point are transmitted among all CSI-RS resources included in resource set(s) configured in resource setting referred to by report setting configured for the CSI report.

Hereinafter, in the embodiments of the disclosure, the individual application is possible by considering both the two interpretations for the CSI-RS occasion. In addition, like in the case of the CSI-RS occasion, both the two interpretations can be considered for the CSI-IM occasion and the SSB occasion, but the principle is similar to the above description, and thus a redundant description is omitted hereinafter.

In embodiments of the disclosure, “CSI-RS/CSI-IM/SSB occasion” for CSI report #X transmitted in “uplink slot n” may refer to a set of at least one of the CSI-RS occasion, the CSI-IM occasion, and the SSB occasion which are not later than CSI reference resources of CSI report #X transmitted in uplink slot n′ among CSI-RS occasions, CSI-IM occasions, and SSB occasions of CSI-RS resources, CSI-IM resources, and SSB resources included in the resource set configured in resource setting referred to by report setting configured for CSI report #X.

In embodiments of the disclosure, the “latest CSI-RS/CSI-IM/SSB occasion” among the CSI-RS/CSI-IM/SSB occasions for CSI report #X transmitted in “uplink slot n” may have two interpretations below. Of course, this is not limited to the examples below.
Interpretation 2-1: a set of occasions including the latest CSI-RS occasion among CSI-RS occasions for CSI report #X transmitted in uplink slot n′, the latest CSI-IM occasion among CSI-RS occasions for CSI report #X transmitted in uplink slot n′, and the latest SSB occasion among SSB occasions for CSI report #0 transmitted in uplink slot n′
Interpretation 2-2: the latest occasion among all of the CSI-RS occasions, the CSI-IM occasions, and the SSB occasions for CSI report #X transmitted in uplink slot n′

Hereinafter, in embodiments of the disclosure, the individual application is possible in consideration of the two interpretations for the “latest CSI-RS/CSI-IM/SSB occasion” among the CSI-RS/CSI-IM/SSB occasions for CSI report #X transmitted in “uplink slot n.” When the two interpretations (interpretation 1-1 and interpretation 1-2) are considered for the CSI-RS occasion, the CSI-IM occasion, and the SSB occasion, the “latest CSI-RS/CSI-IM/SSB occasion” among the CSI-RS/CSI-IM/SSB occasions for CSI report #X transmitted in “uplink slot n” may be individually applied in consideration of all of four different interpretations (the application of interpretation 1-1 and interpretation 2-1, the application of interpretation 1-1 and interpretation 2-2, and the application of interpretation 1-2 and interpretation 2-1, and the application of interpretation 1-2 and interpretation 2-2) in embodiments of the disclosure.

The base station may indicate the CSI report in consideration of an amount of channel information which can be simultaneously calculated by the UE for the CSI report (e.g., the number of channel information computation units (CSI processing units (CPUs) of the UE). When the number of channel information computation units which the UE can simultaneously calculate is NCPU, the UE may not expect the CSI report indication of the base station which requires channel information computations larger than N_{CPU} or may not consider an update of channel information which requires channel information computations larger than N_{CPU}. N_{CPU} may be reported to the base station by the UE through higher layer signaling or may be configured by the base station through higher layer signaling.

It may be assumed that the CSI report indicated to the UE by the base station occupies some or all of the CPUs for channel information computation among the total number N_{CPU} of pieces of channel information which can be simultaneously calculated by the UE. When the number of channel information computation units required for each CSI report, for example, CSI report n (n=0, 1, . . . , N−1) is O_{CPU}⁽ⁿ⁾, the number of channel information computation units required for a total of N CSI reports may be Σₙ₌₀^{N-1} O_{CPU}⁽ⁿ⁾. The channel information computation units required for each reportQuantity configured in the CSI report may be configured as shown in Table 15 below. Of course, this is not limited to the examples below.

```
TABLE 15
- O_{CPU}⁽ⁿ⁾ = 0 : reportQuantity configured in CSI report is configured as “none” and trs-Info is
configured in CSI-RS resource set connected to CSI report
- O_{CPU}⁽ⁿ⁾ = 1 : reportQuantity configured in CSI report is configured as “none,” “cri-RSRP,” or “ssb-
Index-RSRP” and trs-Info is not configured in CSI-RS resource set connected to CSI report
- reportQuantity configured in CSI report is configured as “cri-RI-PMI-CQI,” “cri-RI-i1,” “cri-RI-
i1-CQI,” “cri-RI-CQI,” or “cri-RI-LI-PMI-CQI”
>> O_{CPU}⁽ⁿ⁾ = N_{CPU} : aperiodic CSI report is triggered and corresponding CSI report is not multiplexed
  with one or all of TB/HARQ-ACK. Corresponding CSI report is wideband CSI, corresponds
  to maximum of 4 CSI-RS port, and corresponds to a single resource having no CRI report,
  wherein codebookType corresponds to “typeI-SinglePanel” or reportQuantity corresponds to
  “cri-RI-CQI.”
(corresponding case may be the case corresponding to delay requirement 1 described above in which
  the UE rapidly calculates CSI by using all available CPUs and report the same)
>> O_{CPU}⁽ⁿ⁾ = Kₛ : all the remaining cases except for the above cases. Kₛ indicates the number of CSI-
  RS resources within CSI-RS resource set for channel measurement.
```

When the number of channel information computations required by the UE for a plurality of CSI reports at a specific time point is larger than the number N_{CPU} of channel information computation units which can be simultaneously calculated by the UE, the UE may not consider an update of channel information for some CSI reports. Among the plurality of indicated CSI reports, a CSI report which does not consider the update of the channel information may be determined by considering a time during which channel information computation required for at least the CSI report occupies the CPU and a priority of the reported channel information. For example, the update of channel information for the CSI report starting at the latest time point of the time during which channel information computation required for the CSI report occupies the CPU may not be considered and the update of channel information may not be preferentially considered for the CSI report having a low priority of channel information.

The priority of the channel information may be determined with reference to Table 16. Of this, this is not limited to the examples below.

```
TABLE 16
CSI priority value Pri_{iCSI} (y, k, c, s) = 2 · N_{cells} · Mₛ · y + N_{cells} · Mₛ · k + Mₛ · c + s,
  - y = 0 in case of aperiodic CSI report transmitted through PUSCH, y = 1 in case of semi-
  persistent CSI report transmitted through PUSCH, y = 2 in case of semi-persistent CSI report
  transmitted through PUCCH, and y = 3 in case of periodic CSI report transmitted through
  PUCCH;
  - k = 0 when CSI report includes L1-RSRP, and k = 1 when CSI report does not include L1-
  RSRP;
  - c : serving cell index, N_{cells} : maximum number of serving cells (maxNrofServingCells)
  configured through higher layer signaling;
  - s : CSI report configuration index (reportConfigID), Mₛ: maximum number of CSI report
  configurations (maxNrofCSI-ReportConfigurations) configured through higher layer signaling
```

The CSI priority for the CSI report may be determined through the priority value Pri_{iCSI}(y,k,c,s) in Table 16. Referring to Table 16, the CSI priority value may be determined through at least one of a type of channel information included in the CSI report, a time axis report characteristic of the CSI report (aperiodic, semi-persistent, periodic), a channel (PUSCH or PUCCH) in which the CSI report is transmitted, a serving cell index, or a CSI report configuration index. Regarding the CSI priority for the CSI report, priority values Pri_{iCSI}/(y,k,c,s) are compared and it may be determined that a CSI priority for the CSI report having a smaller priority value is higher.

When a time occupied by the CPU to calculate channel information required for the CSI report which the base station indicates to UE is called CPU occupation time, the CPU occupation time may be determined by considering at least one of some of all of a type of channel information included in the CSI report (report quantity), a time axis characteristic of the CSI report (aperiodic, semi-persistent, periodic), a slot or a symbol occupied by higher layer signaling or DCI indicating the CSI report, and a slot or a symbol occupied by a reference signal for channel state measurement.

### [PDCCH: Regarding DCI]

Next, downlink control information (DCI) in a 5G communication system will be described in detail.

In a 5G system, scheduling information regarding uplink data (or physical uplink shared channel (PUSCH)) or downlink data (or physical downlink shared channel (PDSCH)) may be transferred from a base station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through or on a physical downlink control channel (PDCCH). A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 17 below, for example. Obviously, the example given below is not limiting.

TABLE 17

| | |
|---|---|
| - | Identifier for DCI formats − [1] bit |
| - | Frequency domain resource assignment −[ ┌log₂ ( N_{RB}^{UL,BWP} |

(N_{RB}^{UL,BWP} + 1)/2)┐ ] bits

| | |
|---|---|
| - | Time domain resource assignment − X bits |
| - | Frequency hopping flag − 1 bit. |
| - | Modulation and coding scheme − 5 bits |
| - | New data indicator − 1 bit |
| - | Redundancy version − 2 bits |
| - | HARQ process number − 4 bits |
| - | Transmit power control (TPC) command for scheduled PUSCH − [2] bits |
| - | Uplink/supplementary uplink (UL/SUL) indicator − 0 or 1 bit |

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 18 below, for example. Obviously, the example given below is not limiting.

TABLE 18

| | |
|---|---|
| - | Carrier indicator − 0 or 3 bits |
| - | UL/SUL indicator − 0 or 1 bit |
| - | Identifier for DCI formats − [1] bits |
| - | Bandwidth part indicator − 0, 1 or 2 bits |
| - | Frequency domain resource assignment |
| | * For resource allocation type 0, ┌N_{RB}^{UL,BWP} /P┐ bits |
| | * For resource allocation type 1, ┌log₂ ( N_{RB}^{UL,BWP} (N_{RB}^{UL,BWP} + 1)/2)┐ bits |
| - | Time domain resource assignment −1, 2, 3, or 4 bits |
| - | Virtual resource block (VRB)-to-physical resource block (PRB) mapping − 0 or 1 |

bit, only for resource allocation type 1.

| | |
|---|---|
| | * 0 bit if only resource allocation type 0 is configured; |
| | * 1 bit otherwise. |
| - | Frequency hopping flag − 0 or 1 bit, only for resource allocation type 1. |
| | * 0 bit if only resource allocation type 0 is configured; |
| | * 1 bit otherwise. |
| - | Modulation and coding scheme − 5 bits |
| - | New data indicator − 1 bit |
| - | Redundancy version − 2 bits |
| - | HARQ process number − 4 bits |
| - | 1st downlink assignment index− 1 or 2 bits |
| | * 1 bit for semi-static HARQ-ACK codebook; |
| | * 2 bits for dynamic HARQ-ACK codebook with single HARQ-ACK |
| | codebook. |
| - | 2nd downlink assignment index − 0 or 2 bits |
| | * 2 bits for dynamic HARQ-ACK codebook with two HARQ-ACK sub- |
| | codebooks; |
| | 0 bit otherwise. |
| - | TPC command for scheduled PUSCH − 2 bits [symbol] [symbol] |
| - | SRS resource indicator − ┌log₂ (Σₖ₌₁^{LmaxΣ} (N_{SRS}^{ₖ}) ( )) ┐ or ┌log₂ (N_{SRS})┐ bits |
| | * ┌log₂ (Σₖ₌₁^{LmaxΣ} (N_{SRSk}) ( )) ┐┐┐ bits for non-codebook based PUSCH |
| | transmission; |
| | * ┌log₂ (N_{SRS})┐ bits for codebook based PUSCH transmission. |
| - | Precoding information and number of layers − up to 6 bits |
| - | Antenna ports − up to 5 bits |
| - | SRS request − 2 bits |
| - | Channel state information (CSI) request − 0, 1, 2, 3, 4, 5, or 6 bits |
| - | Code block group (CBG) transmission information − 0, 2, 4, 6, or 8 bits |
| - | Phase tracking reference signal (PTRS)-demodulation reference signal (DDMRS) |

association − 0 or 2 bits.

| | |
|---|---|
| - | beta_offset indicator − 0 or 2 bits |
| - | DMRS sequence initialization − 0 or 1 bit |

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 19 below, for example. Obviously, the example given below is not limiting.

TABLE 19

| | |
|---|---|
| - | Identifier for DCI formats − [1] bit |
| - | Frequency domain resource assignment − [┌log₂ ( N_{RB}^{DL,BWP} |
| | (N_{RB}^{DL,BWP} + 1)/2)┐ ]bits |
| - | Time domain resource assignment − X bits |
| - | VRB-to-PRB mapping − 1 bit. |
| - | Modulation and coding scheme − 5 bits |
| - | New data indicator − 1 bit |
| - | Redundancy version − 2 bits |
| - | HARQ process number − 4 bits |
| - | Downlink assignment index − 2 bits |
| - | TPC command for scheduled PUCCH − [2] bits |
| - | Physical uplink control channel (PUCCH) resource indicator − 3 bits |
| - | PDSCH-to-HARQ feedback timing indicator − [3] bits |

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 20 below, for example. Obviously, the example given below is not limiting.

TABLE 20

| | |
|---|---|
| - | Carrier indicator − 0 or 3 bits |
| - | Identifier for DCI formats − [1] bits |
| - | Bandwidth part indicator − 0, 1 or 2 bits |
| - | Frequency domain resource assignment |
| | * For resource allocation type 0, ┌N_{RB}^{DL,BWP} / p┐ bits |
| | * For resource allocation type 1, ┌log₂ ( N_{RB}^{DL,BWP} (N_{RB}^{DL,BWP} + 1)/2)┐ bits |
| - | Time domain resource assignment −1, 2, 3, or 4 bits |
| - | VRB-to-PRB mapping − 0 or 1 bit, only for resource allocation type 1. |
| | * 0 bit if only resource allocation type 0 is configured; |
| | * 1 bit otherwise. |
| - | Physical resource block (PRB) bundling size indicator − 0 or 1 bit |
| - | Rate matching indicator − 0, 1, or 2 bits |
| - | Zero power (ZP) channel state information (CSI)-reference |

signal (RS) trigger − 0, 1, or 2 bits

| | For transport block 1: | |
|---|---|---|
| | - | Modulation and coding scheme − 5 bits |
| | - | New data indicator − 1 bit |
| | - | Redundancy version − 2 bits |
| | For transport block 2: | |
| | - | Modulation and coding scheme − 5 bits |
| | - | New data indicator − 1 bit |
| | - | Redundancy version − 2 bits |
| - | | HARQ process number − 4 bits |
| - | | Downlink assignment index − 0 or 2 or 4 bits |
| - | | TPC command for scheduled PUCCH − 2 bits |
| - | | PUCCH resource indicator − 3 bits |
| - | | PDSCH-to-HARQ_feedback timing indicator − 3 bits |
| - | | Antenna ports − 4, 5 or 6 bits |
| - | | Transmission configuration indication − 0 or 3 bits |
| - | | SRS request − 2 bits |
| - | | CBG transmission information − 0, 2, 4, 6, or 8 bits |
| - | | CBG flushing out information − 0 or 1 bit |
| - | | DMRS sequence initialization − 1 bit |

### [PDCCH: CORESET, REG, CCE, and Search Space]

Hereinafter, a downlink control channel in a 5G communication system will be described in more detail with reference to the accompanying drawings.

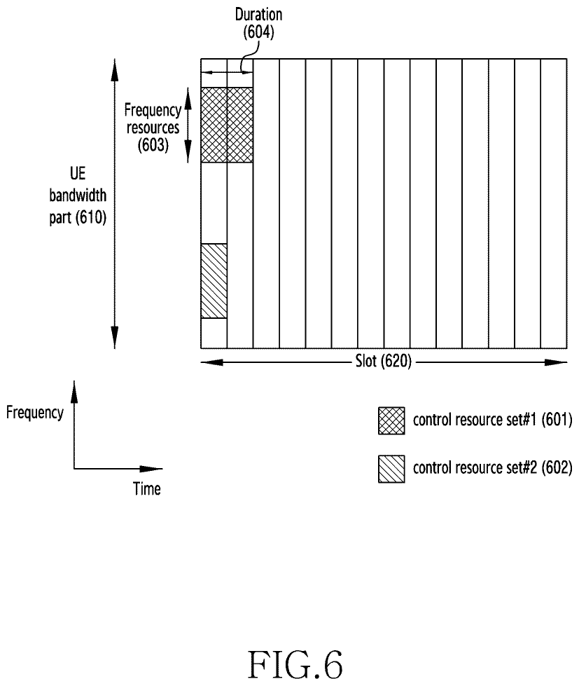

FIG. 6 illustrates an example of a configuration of a control resource set (CORESET) used to transmit a downlink control channel in a wireless communication system according to an embodiment of the present disclosure. FIG. 6 illustrates an example in which a UE bandwidth part 610 is configured along the frequency axis, and two control resource sets (control resource set #1 601 and control resource set #2 602) are configured within one slot 620 along the time axis. The control resource sets 601 and 602 may be configured in a specific frequency resource 603 within the entire UE bandwidth part 610 along the frequency axis. One or multiple OFDM symbols may be configured along the time axis, and this may be defined as a control resource set duration 604. Referring to the example illustrated in FIG. 6, control resource set #1 601 is configured to have a control resource set duration corresponding to two symbols, and control resource set #2 602 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, the configuration information may include the following pieces of information given in Table 21.

TABLE 21

| ConControlResourceSet ::= | SEQUENCE { |
|---|---|
| -- Corresponds to L1 parameter “CORESET-ID” | |
| controlResourceSetId | ControlResourceSetId, |
| (control resource set identity)) | |
| frequencyDomainResources | BIT STRING (SIZE (45)), |
| (frequency domain resource allocation information) | |
| duration | INTEGER |
| (1..maxCoReSetDuration), | |
| (time domain resource allocation information) | |
| cce-REG-MappingType | CHOICE |
| { | |
| (CCE-to-REG mapping type) | |
| interleaved | |
| SEQUENCE { | |
| reg-BundleSize | |
| ENUMERATED {n2, n3, n6}, | |
| (REG bundle size) | |
| precoderGranularity | |
| ENUMERATED {sameAsREG-bundle, allContiguousRBs}, | |
| interleaverSize | |
| ENUMERATED {n2, n3, n6} | |
| (interleaver size) | |
| shiftIndex | |
| INTEGER(0..maxNrofPhysicalResourceBlocks−1) | |
| OPTIONAL | |
| (interleaver shift) | |
| }, | |
| nonInterleaved | NULL |
| }, | |
| tci-StatesPDCCH | SEQUENCE(SIZE |
| (1..maxNrofTCI-StatesPDCCH)) OF TCI-StateId | |
| OPTIONAL, | |
| (QCL configuration information) | |
| tci-PresentInDCI | ENUMERATED {enabled} |

```
            OPTIONAL, -- Need S
  }
```

In Table 21, tci-StatesPDCCH (simply referred to as transmission configuration indication (TCI) state) configuration information may include information of one or multiple SS/PBCH block indexes or channel state information reference signal (CSI-RS) indexes, which are quasi-co-located (QCLed) with a DMRS transmitted in a corresponding control resource set. Obviously, the example given above is not limiting.

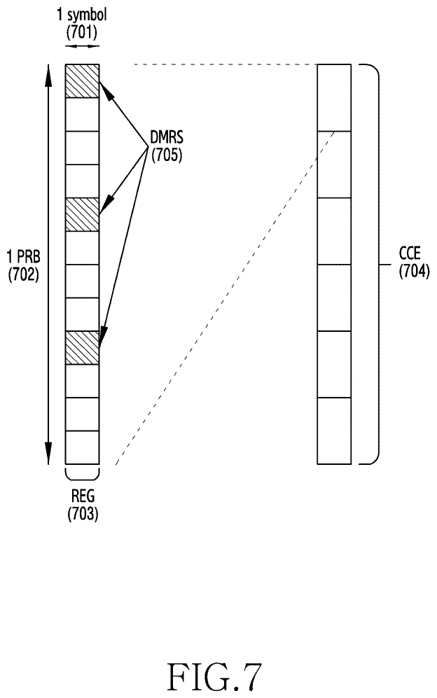

FIG. 7 illustrates a structure of a downlink control channel in a wireless communication system according to an embodiment of the present disclosure.

Referring to FIG. 7, FIG. 7 illustrates an example of a basic unit of time and frequency resources constituting a downlink control channel available in a 5G system. According to FIG. 7, the basic unit of time and frequency resources constituting a control channel may be referred to as a resource element group (REG) 703, and the REG 703 may be defined by one OFDM symbol 701 along the time axis and one physical resource block (PRB) 702 (that is, 12 subcarriers) along the frequency axis. The base station may configure a downlink control channel allocation unit by concatenating the REGs 703.

Provided that the basic unit of downlink control channel allocation in 5G is a control channel element 704 as illustrated in FIG. 7, one CCE 704 may include multiple REGs 703. To describe the REG 703 illustrated in FIG. 7, for example, the REG 703 may include 12 REs, and if one CCE 704 includes six REGs 703, one CCE 704 may then include 72 REs. A downlink control resource set, once configured, may include multiple CCEs 704, and a specific downlink control channel may be mapped to one or multiple CCEs 704 and then transmitted according to the aggregation level (AL) in the control resource set. The CCEs 704 in the control resource set are distinguished by numbers, and the numbers of CCEs 704 may be allocated according to a logical mapping scheme.

The basic unit of the downlink control channel illustrated in FIG. 7, that is, the REG 703 may include both REs to which DCI is mapped, and an area to which a reference signal (DMRS 705) for decoding the same is mapped. As in FIG. 7, three DMRSs 705 may be transmitted inside one REG 703. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the configuration information may include the following pieces of information given in Table 22. Obviously, the example given below is not limiting.

TABLE 22

| | |
|---|---|
| SearchSpace ::= | SEQUENCE { |

```
    -- Identity of the search space. SearchSpaceId = 0 identifies the SearchSpace configured via
  PBCH (MIB) or ServingCellConfigCommon.
```

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicity AndOffset | CHOICE { |

```
  (monitoring slot level periodicity)
      sl1
    NULL,
      sl2
    INTEGER (0..1),
      sl4
    INTEGER (0..3),
      sl5
    INTEGER (0..4),
      sl8
    INTEGER (0..7),
      sl10
    INTEGER (0..9),
      sl16
    INTEGER (0..15),
      sl20
    INTEGER (0..19)
    }
```

OPTIONAL,

duration (monitoring duration) INTEGER (2..2559)

| | |
|---|---|
| monitoringSymbolsWithinSlot | BIT STRING (SIZE |

```
(14))
      OPTIONAL,
  (monitoring symbols within slot)
```

| | |
|---|---|
| nrofCandidates | SEQUENCE { |

(number of PDCCH candidates for each aggregation level)

| | |
|---|---|
| aggregationLevel1 | ENUMERATED |

{n0, n1, n2, n3, n4, n5, n6, n8},

| | |
|---|---|
| aggregationLevel2 | ENUMERATED |

{n0, n1, n2, n3, n4, n5, n6, n8},

| | |
|---|---|
| aggregationLevel4 | ENUMERATED |

{n0, n1, n2, n3, n4, n5, n6, n8},

| | |
|---|---|
| aggregationLevel8 | ENUMERATED |

{n0, n1, n2, n3, n4, n5, n6, n8},

| | |
|---|---|
| aggregationLevel16 | ENUMERATED |

{n0, n1, n2, n3, n4, n5, n6, n8}
},

| | |
|---|---|
| searchSpaceType | CHOICE { |

```
    (search space type)
    -- Configures this search space as common search space (CSS) and DCI formats to monitor.
    common
    SEQUENCE {
    (common search space)
  }
    ue-Specific
    SEQUENCE {
    (UE-specific search space)
    -- Indicates whether the UE monitors in this USS for DCI formats 0-0 and 1-0 or for formats
0-1 and 1-1.
    formats
    ENUMERATED {formats0-0-And-1-0, formats0-1-And-1-1},
    ...
  }
```

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the example given below is not limiting:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

Combinations of DCI formats and RNTIs given below may be monitored in a UE-specific search space. Obviously, the example given below is not limiting:
DCI format 0_0/1_0 with CRC scrambled by C-RNTI, CS-RNTI, TC-RNTI; and/or
DCI format 1_0/1_1 with CRC scrambled by C-RNTI, CS-RNTI, TC-RNTI.

Enumerated RNTIs may follow the definition and usage given below:
Cell RNTI (C-RNTI): used to schedule a UE-specific PDSCH;
Temporary cell RNTI (TC-RNTI): used to schedule a UE-specific PDSCH;
Configured scheduling RNTI (CS-RNTI): used to schedule a semi-statically configured UE-specific PDSCH;
Random access RNTI (RA-RNTI): used to schedule a PDSCH in a random access step;
Paging RNTI (P-RNTI): used to schedule a PDSCH in which paging is transmitted;
System information RNTI (SI-RNTI): used to schedule a PDSCH in which system information is transmitted;
Interruption RNTI (INT-RNTI): used to indicate whether a PDSCH is punctured;
Transmit power control for PUSCH RNTI (TPC-PUSCH-RNTI): used to indicate a power control command regarding a PUSCH;
Transmit power control for PUCCH RNTI (TPC-PUCCH-RNTI): used to indicate a power control command regarding a PUCCH; and/or
Transmit power control for SRS RNTI (TPC-SRS-RNTI): used to indicate a power control command regarding an SRS.

The DCI formats enumerated above may follow the definitions given in Table 23 below.

TABLE 23

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

In 5G, the search space at aggregation level L in connection with control resource set p and search space set s may be expressed by Equation 1 below:

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 1 ]$$

L: aggregation level;
n_{CI}: carrier index;
N_{CCE,p}: total number of CCEs existing in control resource set p;
n_{s,f}^{μ}: slot index;
M_{s,max}^{(L)}: number of PDCCH candidates at aggregation level L;
m_{s,n}_{_{CI}}=0, . . . , M_{s,max}^{(L)}−1: PDCCH candidate index at aggregation level L;
i=0, . . . , L−1;
Y_{p,n}_{_{s,f}}_{^{μ}}=(Ap·Y_{p,n}_{_{s,f}}_{^{μ}}−1)mod D, Y_{p,-1}=N_{RNTI}≠0, Aₚ=39827 for pmod3=0, Aₚ=39829 for pmod3=1, Aₚ=39839 for pmod3=2, D=65537; and
N_{RNTI}: UE identity.

The Y_{p,n}_{_{s,f}}_{^{μ}} value may correspond to 0 in the case of a common search space.

The Y_{p,n}_{_{s,f}}_{^{μ}} value may correspond to a value changed by the UE's identity (C-RNTI or ID configured for the UE by the base station) and the time index in the case of a UE-specific search space.

In a 5G system, multiple search space sets may be configured by different parameters (for example, parameters in Table 22), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

[PUSCH: regarding transmission scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 29 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 24 through upper signaling. If PUSCH transmission is operated by a configured grant, parameters applied to the PUSCH transmission are applied through configuredGrantConfig (upper signaling) in Table 24 except for dataScramblingIdentityPUSCH, txConfig, codebookSubset, maxRank, and scaling of UCI-OnPUSCH, which are provided by pusch-Config (upper signaling) in Table 25. If provided with transformPrecoder inside configuredGrantConfig (upper signaling) in Table 24, the UE applies tp-pi2BPSK inside pusch-Config in Table 25 to PUSCH transmission operated by a configured grant. Obviously, the example given above is not limiting.

```
TABLE 24
ConfiguredGrantConfig ::= SEQUENCE {
frequency Hopping ENUMERATED {intraSlot, interSlot} OPTIONAL, -- Need S,
cg-DMRS-Configuration DMRS-UplinkConfig,
mcs-Table ENUMERATED {qam256, qam64LowSE} OPTIONAL, -- Need S
mcs-TableTransformPrecoder ENUMERATED {qam256, qam64LowSE} OPTIONAL, --
Need S
uci-OnPUSCH SetupRelease { CG-UCI-OnPUSCH } OPTIONAL, -- Need M
resource Allocation ENUMERATED { resourceAllocationType0, resourceAllocationType1,
dynamicSwitch },
rbg-Size ENUMERATED {config2} OPTIONAL, -- Need S
powerControlLoopToUse ENUMERATED {n0, n1},
p0-PUSCH-Alpha P0-PUSCH-AlphaSetId,
transformPrecoder ENUMERATED {enabled, disabled} OPTIONAL, -- Need S
nrofHARQ-Processes INTEGER(1..16),
repK ENUMERATED {n1, n2, n4, n8},
repK-RV ENUMERATED {s1-0231, s2-0303, s3-0000} OPTIONAL, -- Need R
periodicity ENUMERATED {
  sym2, sym7, sym1x14, sym2x14, sym4x14, sym5x14, sym8x14, sym10x14, sym16x14,
sym20x14,
  sym32x14, sym40x14, sym64x14, sym80x14, sym128x14, sym160x14, sym256x14,
sym320x14, sym512x14,
  sym640x14, sym1024x14, sym1280x14, sym2560x14, sym5120x14,
  sym6, symlx12, sym2x12, sym4x12, sym5x12, sym8x12, sym10x12, sym16x12,
sym20x12, sym32x12,
  sym40x12, sym64x12, sym80x12, sym128x12, sym160x12, sym256x12, sym320x12,
sym512x12, sym640x12,
  sym1280x12, sym2560x12
},
configuredGrantTimer INTEGER (1..64) OPTIONAL, -- Need R
rrc-ConfiguredUplinkGrant SEQUENCE {
timeDomainOffset INTEGER (0..5119),
timeDomainAllocation INTEGER (0..15),
frequencyDomainAllocation BIT STRING (SIZE(18)),
antennaPort INTEGER (0..31),
dmrs-SeqInitialization INTEGER (0..1) OPTIONAL, -- Need R
precodingAndNumberOfLayers INTEGER (0..63),
srs-ResourceIndicator INTEGER (0..15) OPTIONAL, -- Need R
mcsAndTBS INTEGER (0..31),
frequencyHoppingOffset INTEGER (1.. maxNrofPhysicalResourceBlocks−1) OPTIONAL, -
- Need R
pathlossReferenceIndex INTEGER (0..maxNrofPUSCH-PathlossReferenceRSs−1),
...
} OPTIONAL, -- Need R
...
}
```

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 30, which is upper signaling, is “codebook” or “nonCodebook.”

As described above, PUSCH transmission may be dynamically scheduled through DCI format 0_0 or 0_1 and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 25, the UE may not expect scheduling through DCI format 0_1.

```
TABLE 25
PUSCH-Config ::= SEQUENCE {
dataScramblingIdentityPUSCH INTEGER (0..1023) OPTIONAL, -- Need S
txConfig ENUMERATED {codebook, nonCodebook} OPTIONAL, -- Need S
dmrs-UplinkForPUSCH-MappingTypeA SetupRelease { DMRS-UplinkConfig } OPTIONAL,
-- Need M
dmrs-UplinkForPUSCH-MappingTypeB SetupRelease { DMRS-UplinkConfig } OPTIONAL,
-- Need M
pusch-PowerControl PUSCH-PowerControl OPTIONAL, -- Need M
frequencyHopping ENUMERATED {intraSlot, interSlot} OPTIONAL, -- Need S
frequencyHoppingOffsetLists SEQUENCE (SIZE (1..4)) OF INTEGER (1 ..
maxNrofPhysicalResourceBlocks-1)
  OPTIONAL, -- Need M
resourceAllocation ENUMERATED { resourceAllocationType0, resourceAllocationType1,
dynamicSwitch},
pusch-TimeDomainAllocationList SetupRelease { PUSCH-TimeDomainResourceAllocationList }
OPTIONAL, -- Need M
pusch-AggregationFactor ENUMERATED { n2, n4, n8 } OPTIONAL, -- Need S
mcs-Table ENUMERATED {qam256, qam64LowSE} OPTIONAL, -- Need S
mcs-TableTransformPrecoder ENUMERATED {qam256, qam64LowSE} OPTIONAL, --
Need S
transformPrecoder ENUMERATED {enabled, disabled} OPTIONAL, -- Need S
codebookSubset ENUMERATED {fullyAndPartialAndNonCoherent,
partialAndNonCoherent, nonCoherent}
  OPTIONAL, -- Cond codebookBased
maxRank INTEGER (1..4) OPTIONAL, -- Cond codebookBased
rbg-Size ENUMERATED { config2} OPTIONAL, -- Need S
uci-OnPUSCH SetupRelease { UCI-OnPUSCH} OPTIONAL, -- Need M
tp-pi2BPSK ENUMERATED {enabled} OPTIONAL, -- Need S
...
}
```

Hereinafter, codebook-based PUSCH transmission will be described. The codebook-based PUSCH transmission may be dynamically scheduled through DCI format 0_0 or 0_1 and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI may be used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebookSubset inside pusch-Config (upper signaling) may be configured to be one of “fully AndPartial AndNonCoherent,” “partialAndNonCoherent,” or “noncoherent,” based on UE capability reported by the UE to the base station. If the UE reported “partialAndNonCoherent” as UE capability, the UE may not expect that the value of codebookSubset (upper signaling) may be configured as “fullyAndPartial AndNonCoherent.” In addition, if the UE reported “nonCoherent” as UE capability, UE may not expect that the value of codebookSubset (upper signaling) may be configured as “fully AndPartialAndNonCoherent” or “partial AndNonCoherent.” If nrofSRS-Ports inside SRS-ResourceSet (upper signaling) indicates two SRS antenna ports, the UE does not expect that the value of codebookSubset (upper signaling) may be configured as “partialAndNonCoherent.”

The UE may have one SRS resource set configured therefor, wherein the value of usage inside SRS-ResourceSet (upper signaling) is “codebook,” and one SRS resource may be indicated through an SRI inside the corresponding SRS resource set. If multiple SRS resources are configured inside the SRS resource set wherein the value of usage inside SRS-ResourceSet (upper signaling) is “codebook,” the UE may expect that the value of nrofSRS-Ports inside SRS-Resource (upper signaling) is identical for all SRS resources.

The UE may transmit, to the base station, one or multiple SRS resources included in the SRS resource set wherein the value of usage is configured as “codebook” according to upper signaling, and the base station may select one from the SRS resources transmitted by the UE and indicate the UE to be able to transmit a PUSCH by using transmission beam information of the corresponding SRS resource. In connection with the codebook-based PUSCH transmission, the SRI may be used as information for selecting the index of one SRS resource and may be included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1 and may be operated semi-statically by a configured grant. If at least one SRS resource is configured inside an SRS resource set wherein the value of usage inside SRS-ResourceSet (upper signaling) is “nonCodebook,” non-codebook-based PUSCH transmission may be scheduled for the UE through DCI format 0_1.

With regard to the SRS resource set wherein the value of usage inside SRS-ResourceSet (upper signaling) is “nonCodebook,” one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic,” the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00.” The corresponding DCI may not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier may not be configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE may not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI may refer to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook,” and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook,” and the base station may select one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the base station may be the number of transmission layers of the PUSCH, and the UE may transmit the PUSCH by applying the precoder applied to SRS resource transmission to each layer.

### [Regarding SRS]

Next, an uplink channel estimation method using sounding reference signal (SRS) transmission of a UE will be described. The base station may configure at least one SRS configuration with regard to each uplink BWP in order to transfer configuration information for SRS transmission to the UE and may also configure as least one SRS resource set with regard to each SRS configuration. As an example, the base station and the UE may exchange upper signaling information as follows, in order to transfer information regarding the SRS resource set. Obviously, the example given below is not limiting:
srs-ResourceSetId: an SRS resource set index;
srs-ResourceIdList: a set of SRS resource indices referred to by SRS resource sets;
resource Type: time domain transmission configuration of SRS resources referred to by SRS resource sets, and may be configured as one of “periodic,” “semi-persistent,” and “aperiodic.” If configured as “periodic” or “semi-persistent,” associated CSI-RS information may be provided according to the place of use of SRS resource sets. If configured as “aperiodic,” an aperiodic SRS resource trigger list/slot offset information may be provided, and associated CSI-RS information may be provided according to the place of use of SRS resource sets;
usage: a configuration regarding the place of use of SRS resources referred to by SRS resource sets, and may be configured as one of “beamManagement,” “codebook,” “nonCodebook,” and “antennaSwitching”; and/or
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

In addition, the base station and the UE may transmit/receive upper layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. The individual configuration information regarding SRS resources may include time domain transmission configuration of SRS resources and may be configured as one of “periodic,” “semi-persistent,” and “aperiodic” The time domain transmission configuration of SRS resources may be limited to have the same time domain transmission configuration as the SRS resource set including the SRS resources. If the time domain transmission configuration of SRS resources is configured as “periodic” or “semi-persistent,” the time domain transmission configuration may further include an SRS resource transmission cycle and a slot offset (for example, periodicity AndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resourceType configured as “periodic” through upper layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicity AndOffset configured for the SRS resource. In addition, the spatial domain transmission filter applied to the transmitted SRS resource may refer to spatial relation info configured for the SRS resource or may refer to associated CSI-RS information configured for the SRS resource set including the SRS resource. The UE may transmit the SRS resource inside the uplink BWP activated with regard to the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent.” Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource or may refer to associated CSI-RS information configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through upper layer signaling.

For example, the base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource may follow resource mapping information configured for the SRS resource. In addition, slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the transmitted SRS resource may refer to spatial relation info configured for the SRS resource or may refer to associated CSI-RS information configured for the SRS resource set including the SRS resource. The UE may transmit the SRS resource inside the uplink BWP activated with regard to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. The minimum time interval may have a different value depending on the place of use of the SRS resource set including the transmitted SRS resource. For example, the minimum time interval may be determined as N2 symbols defined in consideration of UE processing capability that follows the UE's capability with reference to the UE's PUSCH preparation procedure time.

In addition, if the place of use of the SRS resource set is configured as “codebook” or “antennaSwitching” in view of the place of use of the SRS resource set including the transmitted SRS resource, the minimum time interval may be determined as N2 symbols, and if the place of use of the SRS resource set is configured as “nonCodebook” or “beamManagement,” the minimum time interval may be determined as N2+14 symbols. The UE may transmit an aperiodic SRS if the time interval for aperiodic SRS transmission is larger than or equal to the minimum time interval and may ignore the DCI that triggers the aperiodic SRS if the time interval for aperiodic SRS transmission is smaller than the minimum time interval. Obviously, the example given below is not limiting.

TABLE 26

| SRS-Resource ::= | SEQUENCE { | |
|---|---|---|
| srs-ResourceId | SRS-ResourceId, | |
| nrofSRS-Ports | ENUMERATED {port1, ports2, ports4}, | |
| ptrs-PortIndex | ENUMERATED {n0, n1 } | OPTIONAL, -- Need R |

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, sequenceHopping }, |
| resourceType | CHOICE { |
| aperiodic | SEQUENCE { |

```
      ...
    },
```

| | |
|---|---|
| semi-persistent | SEQUENCE { |
| periodicityAndOffset-sp | SRS-PeriodicityAndOffset, |

```
      ...
    },
```

| | |
|---|---|
| periodic | SEQUENCE { |
| periodicityAndOffset-p | SRS-PeriodicityAndOffset, |

```
      ...
    }
  },
```

| sequenceId | INTEGER (0..1023), | |
|---|---|---|
| spatialRelationInfo | SRS-SpatialRelationInfo | OPTIONAL, -- Need R |

...
}

Configuration information spatialRelationInfo in Table 26 above is applied, with reference to one reference signal, to a beam used for SRS transmission corresponding to beam information of the corresponding reference signal. For example, configuration of spatialRelationInfo may include information as in Table 27 below. Obviously, the example given below is not limiting.

TABLE 27

```
SRS-SpatialRelationInfo ::= SEQUENCE {
  servingCellId ServCellIndex OPTIONAL, -- Need S
  referenceSignal CHOICE
    ssb-Index SSB-Index,
    csi-RS-Index NZP-CSI-RS-ResourceId,
    srs SEQUENCE {
      resourceId SRS-ResourceId,
      uplinkBWP BWP-Id
    }
  }
}
```

Referring to the spatialRelationInfo configuration, an SS/PBCH block index, CSI-RS index, or SRS index may be configured as the index of a reference signal to be referred to in order to use beam information of a specific reference signal. Upper signaling referenceSignal corresponds to configuration information indicating which reference signal's beam information is to be referred to for corresponding SRS transmission, ssb-Index refers to the index of an SS/PBCH block, csi-RS-Index refers to the index of a CSI-RS, and srs refers to the index of an SRS. If upper signaling referenceSignal has a configured value of “ssb-Index,” the UE may apply the reception beam which was used to receive the SS/PBCH block corresponding to ssb-Index as the transmission beam for the corresponding SRS transmission. If upper signaling referenceSignal has a configured value of “ssb-Index,” the UE may apply the reception beam which was used to receive the SS/PBCH block corresponding to ssb-Index as the transmission beam for the corresponding SRS transmission. If upper signaling referenceSignal has a configured value of “srs,” the UE may apply the reception beam which was used to transmit the SRS corresponding to srs as the transmission beam for the corresponding SRS transmission.

### [Regarding UE Capability Report]

In LTE and NR, a UE may perform a procedure in which, while being connected to a serving base station, the UE reports capability supported by the UE to the corresponding base station. In the following description, the above-described procedure will be referred to as a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. For example, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

According to an embodiment, upon receiving the UE capability report request from the base station, the UE may configure UE capability according to band information and RAT type requested by the base station. The method in which the UE configures UE capability in an NR system is summarized below.

1. If the UE receives a list regarding LTE and/or NR bands from the base station at a UE capability request, the UE may construct band combinations (BCs) regarding EN-DC and NR standalone (SA). That is, the UE may configure a candidate list of BCs regarding EN-DC and NR SA, based on bands received from the base station at a request through FreqBandList. In addition, bands may have priority in the order described in FreqBandList.

2. If the base station has set “eutra-nr-only” flag or “eutra” flag and requested a UE capability report, the UE may remove everything related to NR SA BCs from the configured BC candidate list. Such an operation may occur only if an LTE base station (eNB) requests “eutra” capability.

3. The UE may then remove fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same can be omitted. This step may be applied in MR-DC as well, that is, LTE bands may also be applied. BCs remaining after the above step may constitute the final “candidate BC list.”

4. The UE may select BCs appropriate for the requested RAT type from the final “candidate BC list” and select BCs to report. In this step, the UE may configure supportedBandCombinationList in a determined order. That is, the UE may configure BCs and UE capability to report according to a preconfigured rat-Type order. (nr->eutra-nr->eutra). In addition, the UE may configure featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs and may be provided from feature set combinations of containers of UE-NR-Capabilities and UE-MRDC-Capabilities.

5. If the requested RAT type is eutra-nr and has an influence, featureSetCombinations may be included on both containers of UE-MRDC-Capabilities and UE-NR-Capabilities. However, the feature set of NR may be included only in UE-NR-Capabilities.

After the UE capability is configured, the UE may transfer a UE capability information message including the UE capability to the base station. The base station may perform scheduling and transmission/reception management appropriate for the UE, based on the UE capability received from the UE.

Hereinafter, embodiments of the disclosure will be described in detail in conjunction with the accompanying drawings. The contents of the disclosure may be applied to FDD and TDD systems. As used herein, upper signaling (or upper layer signaling”) is a method for transferring signals from a base station to a UE by using a downlink data channel of a physical layer, or from the UE to the base station by using an uplink data channel of the physical layer, and may also be referred to as “RRC signaling,” “PDCP signaling,” or “MAC control element (MAC CE).”

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through multiple embodiments, but they are not independent of each other, and one or more embodiments may be applied simultaneously or in combination.

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, when actually applied, a TRP, a beam, or a TCI state may be appropriately replaced with one of the above terms.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed, for the sake of descriptive convenience, that NC-JT case refers to a case in which the UE receives a PDSCH to which cooperative communication is applied, based on conditions similar to those described above.

In the following description of the disclosure, upper layer signaling may refer to signaling corresponding to at least one signaling among the following signaling, or a combination of one or more thereof. Obviously, the examples given below are not limiting:
Master information block (MIB);
System information block (SIB) or SIB X (X=1, 2, . . . );
Radio resource control (RRC); and/or
Medium access control (MAC) control element (CE).

In addition, L1 signaling may refer to signaling corresponding to at least one signaling method among signaling methods using the following physical layer channels or signaling, or a combination of one or more thereof. Obviously, the examples given below are not limiting:
Physical downlink control channel (PDCCH);
Downlink control information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical uplink control channel (PUCCH); and/or
Uplink control information (UCI).

Hereinafter, determining priority between A and B may be variously described as, for example, selecting an entity having a higher priority according to a predetermined priority rule and performing an operation corresponding thereto, or omitting or dropping operations regarding an entity having a lower priority.

As used herein, the term “slot” may generally refer to a specific time unit corresponding to a transmit time interval (TTI), may specifically refer to a slot used in a 5G NR system, or may refer to a slot or a subframe used in a 4G LTE system.

Hereinafter, the above examples may be described through multiple embodiments, but they are not independent of each other, and one or more embodiments may be applied simultaneously or in combination.

### First Embodiment: Non-Codebook-Based PUSCH Transmission Method of UE

An embodiment of the disclosure describes a non-codebook-based PUSCH transmission method of a UE. This embodiment may operate in combination with other embodiments.

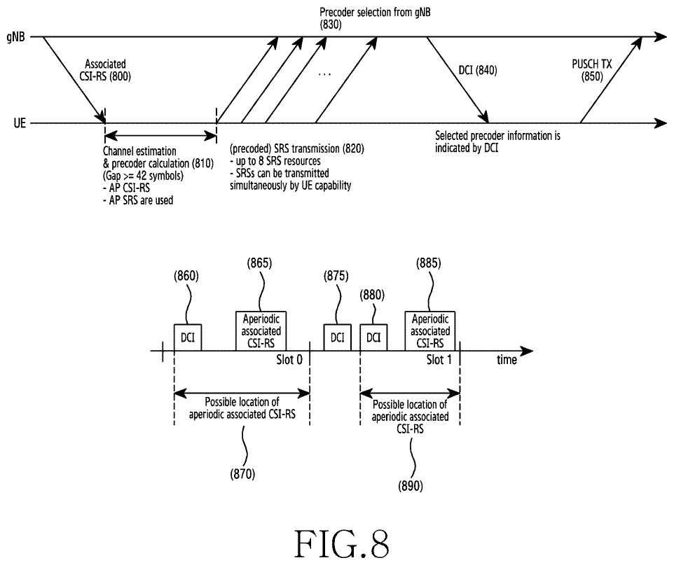

FIG. 8 illustrates a non-codebook-based PUSCH transmission process according to an embodiment of the present disclosure.

Referring to FIG. 8, the UE may receive an associated CSI-RS from a base station (operation 800). The UE may estimate a channel between the base station and the UE, based on the associated CSI-RS received from the base station, and then calculate, based on the estimated channel, a precoder to be used for non-codebook-based PUSCH transmission (operation 810). The UE may calculate the same precoder for all frequency resource areas for which the UE is to calculate the precoder or may calculate different precoders for different partial frequency resource areas. For example, the UE may calculate a wideband precoder or a subband precoder. Thereafter, the UE may apply a vector for each layer of the calculated overall precoding matrix to each SRS resource and transmit the same to the base station. Depending on a UE capability report of the UE and a higher layer signaling configuration of the base station (or one or more of the UE capability report of the UE and the higher layer signaling configuration of the base station), the layer values and the number of SRS resources of the overall precoding matrix may be determined. Accordingly, the UE may simultaneously transmit, to the base station, one or more SRS resources applied with the precoding matrix calculated by the UE by applying a vector for each layer of the overall precoding matrix configured by a maximum of eight layers to each of a maximum of eight SRS resources.

The UE may report, to the base station via UE capability, the maximum number of SRS resources that can be transmitted simultaneously to one or more SRS resources to which precoding matrix is applied (operation 820). In case that the associated CSI-RS is an aperiodic CSI-RS, and that SRS resources in an SRS resource set having usage configured as non-codebook are an aperiodic SRS, the UE may not expect a time interval between a time point at which the associated CSI-RS is received from the base station and a time of transmitting one or more SRS resources to which precoding is applied to be less than 42·2^{max (0,μ-3)} symbols. In this case, μ may be a value representing a subcarrier spacing. For example, the subcarrier spacing may be 15·2^{μ} kHz. Referring back to operation 810, when the associated CSI-RS is an aperiodic CSI-RS, and the SRS resource in the SRS resource set having usage configured as non-codebook is an aperiodic SRS, the UE may estimate a channel based on the associated CSI-RS and calculate a precoder, and may use a time corresponding to at least 42 symbols to apply precoding to the SRS resource and perform transmission (operation 810).

Upon receiving one or more SRS resources to which precoding is applied, the base station may determine a combination of SRS resources that is determined to have the best reception performance for each PUSCH precoding frequency resource unit. A combination of precoders applied to the one or more SRS resources selected based on the determined combination of SRS resources may be determined as the precoder of the UE for non-codebook-based PUSCH transmission in the corresponding PUSCH precoding frequency resource unit (operation 830). The UE may receive, from the base station via the SRI field in the DCI, information about the combination of SRS resources determined by the base station (operation 840). In this case, the UE may understand the number of SRS resources indicated to the UE via the SRI as rank information of the non-codebook-based PUSCH to be transmitted by the UE and may understand as precoder information of the non-codebook-based PUSCH to be transmitted by the UE through the one or more SRS resources indicated to the UE via the SRI. Based on the rank and precoder information, the UE may perform a non-codebook-based PUSCH transmission (operation 850).

The UE may expect the length of the SRS request field in DCI format 0_2 to be one of 0, 1, 2, or 3 bits, and may interpret the SRS request field for each bit length as follows. Of course, this is not limited to the following examples.
When srs-RequestDCI-0-2, which is higher layer signaling, is not configured, the SRS request field in DCI format 0_2 may be zero bits.
When the higher layer signaling srs-RequestDCI-0-2 is configured as 1 and supplementary Uplink in ServingCellConfig is not configured, the UE may consider the SRS request field in DCI format 0_2 as one bit. The interpretation of the one bit may follow Table 29 or the first two rows of Table 28. In case of using Table 28 below, the UE may interpret the operation corresponding to the first row “00” of the following Table 28 when the SRS request field has a value of 0 and may interpret the operation corresponding to the second row “01” of the following Table 28 when the SRS request field has a value of 1.
When the higher layer signaling srs-RequestDCI-0-2 is configured to have a value of 1 and supplementaryUplink in ServingCellConfig is configured, the UE may consider the SRS request field in DCI format 0_2 as two bits. The first bit of the two bits may be interpreted as indicating either non-SUL or SUL, and the interpretation of the remaining one bit may follow Table 29 below, or the first two rows of Table 28 below. When using Table 28 below, the UE may interpret the operation corresponding to the first row “00” of the following Table 28 when the SRS request field has a value of 0 and may interpret the operation corresponding to the second row “01” of the following Table 28 when the SRS request field has a value of 1.
When the higher layer signaling srs-RequestDCI-0-2 is configured to have a value of 2 and supplementary Uplink in ServingCellConfig is not configured, the UE may consider the SRS request field in DCI format 0_2 as two bits, and the interpretation of the two bits may follow Table 28 below.
When the higher layer signaling srs-RequestDCI-0-2 is configured to have a value of 2 and supplementaryUplink in ServingCellConfig is configured, the UE may consider the SRS request field in DCI format 0_2 as three bits, the first bit of which may be interpreted as indicating either non-SUL or SUL, and the interpretation of the remaining two bits may follow Table 28 below.

The UE may expect the length of the SRS request field in DCI format 1_2 to be one of 0, 1, 2, or 3 bits, and may interpret the SRS request field as follows for each bit length.
When srs-RequestDCI-1-2, which is higher layer signaling, is not configured, the SRS request field in DCI format 1_2 may be zero bits.
When the higher layer signaling srs-RequestDCI-1-2 is configured to have a value of 1 and supplementaryUplink in ServingCellConfig is not configured, the UE may consider the SRS request field in DCI format 1_2 as one bit. The interpretation of the one bit may follow Table 29 or the first two rows of Table 28. In case of using Table 28 below, the UE may interpret the operation corresponding to the first row “00” of the following Table 28 when the SRS request field has a value of 0 and may interpret the operation corresponding to the second row “01” of the following Table 28 when the SRS request field has a value of 1.
When the higher layer signaling srs-RequestDCI-1-2 is configured to have a value of 1 and supplementaryUplink in ServingCellConfig is configured, the UE may consider the SRS request field in DCI format 1_2 as two bits. The first bit of the two bits may be interpreted as indicating either non-SUL or SUL, and the interpretation of the remaining one bit may follow Table 29 below, or the first two rows of Table 28 below. In case of using Table 28 below, the UE may interpret the operation corresponding to the first row “00” of the following Table 28 when the SRS request field has a value of 0 and may interpret the operation corresponding to the second row “01” of the following Table 28 when the SRS request field has a value of 1.
When the higher layer signaling srs-RequestDCI-1-2 is configured to have a value of 2 and supplementary Uplink in ServingCellConfig is not configured, the UE may consider the SRS request field in DCI format 1_2 as two bits, and the interpretation of the two bits may follow Table 28 below.
When the higher layer signaling srs-RequestDCI-1-2 is configured to have a value of 2 and supplementaryUplink in ServingCellConfig is configured, the UE may consider the SRS request field in DCI format 1_2 as three bits, the first bit of which may be interpreted as indicating either non-SUL or SUL, and the interpretation of the remaining two bits may follow Table 28 below.

The UE may interpret the higher layer signaling srs-RequestDCI-0-2 as having the length of the SRS request field in DCI format 0_2, if supplementaryUplink in the higher layer signaling ServingCellConfig is not configured. Alternatively, when the supplementary Uplink in the higher layer signaling ServingCellConfig is configured, the UE may interpret that the higher layer signaling srs-RequestDCI-0-2 has a value that is 1 less than the length of the SRS request field in DCI format 0_2.

When the supplementaryUplink in the higher layer signaling ServingCellConfig is not configured, the UE may perform the bit length configuration and interpretation of the SRS request field according to the following configuration situations for srs-RequestDCI-0-2, respectively. Of course, this is not limited to the following examples. When the higher layer signaling srs-RequestDCI-0-2 is not configured, the UE may consider the length of the SRS request field in DCI format 0_2 as zero bits.

When srs-RequestDCI-0-2, which is higher layer signaling, is configured to have a value of 1, the UE may consider the SRS request field in DCI format 0_2 as one bit. The one bit may indicate one of the two values of Table 28 or one of the first two values in Table 28.

When the higher layer signaling srs-RequestDCI-0-2 is configured to have a value of 2, the UE may consider the SRS request field in DCI format 0_2 as two bits, and the corresponding two bits may indicate one of all rows in Table 28 below.

When the supplementaryUplink in the higher layer signaling ServingCellConfig is configured, the UE may consider an additional one bit for the SRS request field from the first bit position, and the additional one bit may indicate either non-SUL or SUL. In this case, even if the supplementary Uplink in the higher layer signaling ServingCellConfig is configured, the UE may consider the bit length of the SRS request field in DCI format 0_2 to be zero when the higher layer signaling srs-RequestDCI-0-2 is not configured.

When the supplementaryUplink in the higher layer signaling ServingCellConfig is not configured, the UE may interpret the higher layer signaling srs-RequestDCI-1-2 as having a value of the length of the SRS request field in DCI format 1_2. Alternatively, when the supplementary Uplink in the higher layer signaling ServingCellConfig is configured, the UE may interpret that the higher layer signaling srs-RequestDCI-1-2 has a value that is 1 less than the length of the SRS request field in DCI format 1_2.

When the supplementary Uplink in the higher layer signaling ServingCellConfig is not configured, the UE may perform the bit length configuration and interpretation of the SRS request field according to the following configuration situations for srs-RequestDCI-1-2, respectively. Of course, this is not limited to the following examples.
When the higher layer signaling srs-RequestDCI-1-2, is not configured, the UE may consider the length of the SRS request field in DCI format 1_2 to be zero bits.
When the higher layer signaling, srs-RequestDCI-1-2, is configured to have a value of 1, the UE may consider the SRS request field in DCI format 1_2 as one bit. The one bit may indicate one of the two values of Table 29 or one of the first two values in Table 28.
When the higher layer signaling srs-RequestDCI-1-2 is configured to have a value of 2, the UE may consider the SRS request field in DCI format 1_2 as two bits. The two bits may indicate one of all rows in Table 28.

When the supplementaryUplink in the higher layer signaling ServingCellConfig is configured, the UE may consider an additional one bit for the SRS request field from the first bit position, and the additional one bit may indicate either non-SUL or SUL. In this case, the UE may consider the bit length of the SRS request field in DCI format 1_2 to be zero when the higher layer signaling srs-RequestDCI-1-2 is not configured, even when the supplementary Uplink in the higher layer signaling ServingCellConfig is configured.

TABLE 28

| | One or more aperiodic SRS resource sets | |
|---|---|---|
| | triggered by DCI formats 0_1, 0_2, 1_1, | |
| | 1_2, and one or more aperiodic SRS | One or more aperiodic SRS resource |
| | resource sets triggered by DCI format 2_3 | sets triggered by DCI format 2_3 with |
| SRS request | with the higher layer signaling srs-TPC- | the higher layer signaling srs-TPC- |
| field value | PDCCH-Group configured as typeB | PDCCH-Group configured as typeA |
| 00 | Aperiodic SRS resource set not triggered | Aperiodic SRS resource set not |
| | | triggered |
| 01 | One or more SRS resource sets having | Within the first set, which includes a |
| | aperiodicSRS-ResourceTrigger in the | plurality of serving cells configured by |
| | higher layer signaling SRS-ResourceSet | higher layer signaling, one or more |
| | configured as 1 or one entry in the | SRS resource sets having usage |
| | aperiodicSRS-ResourceTriggerList | configured by antennaSwitching and |
| | configured as 1 | resourceType configured as aperiodic |
| | One or more SRS resource sets having, | within the higher layer signaling SRS- |
| | when a UE has received DCI formats 0_1, | ResourceSet |
| | 0_2, 1_1, and 1_2, the higher layer | |
| | signaling aperiodicSRS-ResourceTrigger | |
| | in the SRS-PosResourceSet configured as | |
| | 1 or one entry in the aperiodicSRS- | |
| | ResourceTriggerList configured as 1. | |
| 10 | One or more SRS resource sets having | Within the second set, which includes |
| | aperiodicSRS-ResourceTrigger | multiple serving cells configured by |
| | configured as 2 in the higher layer | higher layer signaling, one or more |
| | signaling SRS-ResourceSet, or one entry | SRS resource sets having usage |
| | in the aperiodicSRS-ResourceTriggerList | configured by antennaSwitching and |
| | configured as 2 | resourceType configured as aperiodic |
| | One or more SRS resource sets having, | within the higher layer signaling SRS- |
| | when the UE has received DCI formats | ResourceSet |
| | 0_1, 0_2, 1_1, and 1_2, the higher layer | |
| | signaling aperiodicSRS-ResourceTrigger | |
| | in the SRS-PosResourceSet configured as | |
| | 2 or one entry in the aperiodicSRS- | |
| | ResourceTriggerList configured as 2. | |
| 11 | One or more SRS resource sets having | Within the third set, which includes |
| | aperiodicSRS-ResourceTrigger | multiple serving cells configured by |
| | configured as 3 in the higher layer | higher layer signaling, one or more |
| | signaling SRS-ResourceSet or one entry in | SRS resource sets having usage |
| | the aperiodicSRS-ResourceTriggerList | configured by antennaSwitching and |
| | configured as 3 | resourceType configured as aperiodic |
| | One or more SRS resource sets having, | within the higher layer signaling SRS- |
| | when a UE has received DCI formats 0_1, | ResourceSet |
| | 0_2, 1_1, and 1_2, the higher layer | |
| | signaling aperiodicSRS-ResourceTrigger | |
| | in the SRS-PosResourceSet configured as | |
| | 3 or one entry in the aperiodicSRS- | |
| | ResourceTriggerList configured as 3 | |

TABLE 29

| SRS request | One or more aperiodic SRS resource sets triggered by DCI formats |
|---|---|
| field value | 0_2 and 1_2 |
| 0 | Aperiodic SRS resource set not triggered |
| 1 | One or more SRS resource sets having the higher layer signaling aperiodicSRS- |
| | ResourceTrigger configured as 1 or one entry in the aperiodicSRS- |
| | ResourceTriggerList configured as 1 |

When an aperiodic SRS resource set is configured (e.g., when the RRC parameter “resourceType” in the SRS resource set is aperiodic), the associated CSI-RS may be indicated via the SRS request field in DCI formats 0_1, 1_1, 0_2 or 1_2. However, in the case of DCI format 0_2 or 1_2, the associated CSI-RS may be indicated via the SRS request field only when the SRS request field exists in the DCI. In this case, the UE may receive, from the base station, a configuration of the higher layer signaling aperiodicSRS-Resource Trigger, AperiodicSRS-Resource TriggerList, srs-ResourceSetId, and csi-RS in the SRS resource set. The UE may define one or more SRS resource sets associated with the SRS request field in DCI formats 0_1 and 1_1 through entries in the higher layer signaling, srs-ResourceSetToAddModList. In addition, the UE may define one or more SRS resource sets associated with SRS request fields in DCI formats 0_2 and 1_2 through entries in the higher layer signaling srs-ResourceSetToAddModListDCI-0-2.

When the UE receives, from the base station, a configuration of SRS resource set having usage configured as non-codebook via higher layer signaling, the RRC parameter resourceType within the SRS resource set is aperiodic, and the associated CSI-RS configured in the same SRS resource set is also an aperiodic NZP CSI-RS, the UE may receive triggering instructions from the base station for an aperiodic associated CSI-RS via the SRS request field in the DCI. The UE may interpret the triggering instruction from the base station for the aperiodic associated CSI-RS through a combination of at least one of the following. Of course, the examples are not limited to the following.
With respect to the case in which the SRS request field in DCI format 0_1 or 1_1 is not “00” and the corresponding DCI is not for cross-carrier scheduling or cross-BWP scheduling, the UE may expect that there is an indication of the presence of an aperiodic associated CSI-RS. For example, when the SRS resource set having usage configured as non-codebook is associated with SRS request field value “01” (e.g., when a value of the higher layer signaling aperiodicSRS-ResourceTrigger is configured to have a value of 1, or one of the entries in aperiodicSRS-ResourceTriggerList is configured to have a value of 1), and when the UE receives from the base station an indication of “01” via the SRS request field in DCI format 0_1 or 1_1, the UE may interpret that the aperiodic associated CSI-RS has been triggered by the base station and transmitted to the UE, and may understand that the aperiodic associated CSI-RS exists.

With respect to the case in which the last two bits of the SRS request field in DCI format 0_1 or 1_1 is not “00” and the corresponding DCI is not for cross-carrier scheduling or cross-BWP scheduling, the UE may expect that there is an indication of the presence of an aperiodic associated CSI-RS. When the UE is not configured with the supplementary Uplink in the higher layer signaling ServingCellConfig, the UE may assume that the SRS request field in DCI format 0_1 or 1_1 is two bits. When the UE is configured with the supplementaryUplink in the higher layer signaling ServingCellConfig, the UE may assume that the SRS request field in DCI format 0_1 or 1_1 is three bits. When the SRS request field is three bits, the UE may interpret the first of the three bits as indicating either non-SUL or SUL and may interpret the subsequent two bits based on Table 28.
The UE may interpret the SRS request field in DCI format 0_2 or 1_2 to correspond to a combination of at least one of the following, depending on a configuration value of the higher layer signaling srs-RequestDCI-0-2 or srs-RequestDCI-1-2.
   In case that the UE receives srs-RequestDCI-0-2 or srs-RequestDCI-1-2 configured as 1 and does not receive supplementaryUplink configured in the higher layer signaling ServingCellConfig, the UE may assume that the SRS request field in DCI format 0_2 or 1_2 is one bit. In addition, the UE may expect that there is an indication of the presence of aperiodic associated CSI-RS for the case in that one bit of the SRS request field is not “0” and the corresponding DCI is not for cross-carrier scheduling or cross-BWP scheduling. For example, when the SRS resource set having usage configured as non-codebook is associated with the SRS request field value of “1” (e.g., when the higher layer signaling aperiodicSRS-ResourceTrigger is configured to have a value of 1, or when one of the entries in the aperiodicSRS-ResourceTriggerList is configured to have a value of 1), and when the UE receives from the base station an indication of “1” via the SRS request field in DCI format 0_2 or 1_2, the UE may interpret that the aperiodic associated CSI-RS has been triggered by the base station and transmitted to the UE, and may understand that the aperiodic associated CSI-RS exists.
   In case that the UE receives srs-RequestDCI-0-2 or srs-RequestDCI-1-2 configured as 1 and receives supplementaryUplink configured in the higher layer signaling ServingCellConfig, the UE may assume that the SRS request field in DCI format 0_2 or 1_2 is two bits. In addition, the UE may expect that there is an indication of the presence of aperiodic associated CSI-RS for the case in that the last one bit of the SRS request field is not “0” and the corresponding DCI is not for cross-carrier scheduling or cross-BWP scheduling. For example, when an SRS resource set having usage configured as non-codebook is associated with the last one bit of the SRS request field having a value of “1” (e.g., when the higher layer signaling aperiodicSRS-ResourceTrigger is configured to have a value of 1, or when one of the entries in the aperiodicSRS-ResourceTriggerList is configured to have a value of 1), and when the UE receives from the base station an indication of “1” of the last one bit of the SRS request field in DCI format 0_2 or 1_2, the UE may interpret that the aperiodic associated CSI-RS has been triggered by the base station and transmitted to the UE, and may understand that the aperiodic associated CSI-RS exists.
   In case that the UE receives srs-RequestDCI-0-2 or srs-RequestDCI-1-2 configured as 2 and does not receive supplementaryUplink configured in the higher layer signaling ServingCellConfig, the UE may assume that the SRS request field in DCI format 0_2 or 1_2 is two bits. In addition, the UE may expect that there is an indication of the presence of aperiodic associated CSI-RS for the case in that the SRS request field is not “00” and the corresponding DCI is not for cross-carrier scheduling or cross-BWP scheduling. For example, when an SRS resource set having usage configured as non-codebook is associated with the SRS request field value of “01” (e.g., when the higher layer signaling aperiodicSRS-ResourceTrigger is configured to have a value of 1, or when one of the entries in the aperiodicSRS-ResourceTriggerList is configured to have a value of 1), and when the UE receives from the base station an indication of “01” via the SRS request field in DCI format 0_2 or 1_2, the UE may interpret that the aperiodic associated CSI-RS has been triggered by the base station and transmitted to the UE, and may understand that the aperiodic associated CSI-RS exists.
   In case that the UE receives srs-RequestDCI-0-2 or srs-RequestDCI-1-2 configured as 2 and receives supplementaryUplink configured in the higher layer signaling ServingCellConfig, the UE may assume that the SRS request field in DCI format 0_2 or 1_2 is three bits. In addition, the UE may expect that there is an indication of the presence of aperiodic associated CSI-RS for the case in that the last two bits of the SRS request field are not “00” and the corresponding DCI is not for cross-carrier scheduling or cross-BWP scheduling. For example, when an SRS resource set having usage configured as non-codebook is associated with the last two bits of the SRS request field having a value of “01” (e.g., when the higher layer signaling aperiodicSRS-ResourceTrigger is configured to have a value of 1, or when one of the entries in the aperiodicSRS-ResourceTriggerList is configured to have a value of 1), and when the UE receives from the base station an indication of “01” via the last two bits of the SRS request field in DCI format 0_2 or 1_2, the UE may interpret that the aperiodic associated CSI-RS has been triggered by the base station and transmitted to the UE, and may understand that the aperiodic associated CSI-RS exists.

Cross-carrier scheduling may be understood to mean that a scheduling cell that receives DCI is different from a cell that performs transmission and reception via scheduling. Cross-BWP scheduling may be understood to mean that a bandwidth part for receiving DCI and a bandwidth part for performing transmissions and receptions via scheduling are different.

In this case, the UE may understand that the aperiodic associated CSI-RS is located within the same slot as that of DCI including the SRS request field that triggered the aperiodic associated CSI-RS.

When the UE has received, in slot 0, DCI 860 that has triggered an aperiodic associated CSI-RS 865, the UE may expect that the aperiodic associated CSI-RS 865 that can be triggered via the DCI 860 exists within the same slot 0. Further, even in the same slot 0, the UE may define a location in which the aperiodically associated CSI-RS 865 may exist within an interval from the first symbol in which the DCI 860 is transmitted to the last symbol of the corresponding slot 0 (operation 870). If the DCI that triggers the aperiodically associated CSI-RS 885 is repeatedly transmitted (indicated by reference numerals 875 and 880) (e.g., if two DCIs are repeated PDCCH candidates transmitted in two different search spaces with the same searchspacelinkingID configured), the UE may expect that the corresponding aperiodically associated CSI-RS 885 exists within slot 1 in which the corresponding repeated DCI exists. In addition, the UE may define, even within the same slot 1, a location in which a corresponding aperiodic associated CSI-RS 885 may exist within an interval from the first symbol of the DCI 880 that starts later in time among the two repeated DCIs to the last symbol of the corresponding slot 1 (operation 890).

In case that the UE has received an SRS resource set having usage configured as non-codebook from the base station via higher layer signaling, that the RRC parameter resourceType within the corresponding SRS resource set is aperiodic, and that the associated CSI-RS configured within the same SRS resource set is also an aperiodic NZP CSI-RS, if the UE has received the higher layer signaling minimumSchedulingOffsetK0 configured in the activated downlink bandwidth part and the configuration has a value greater than zero, the UE may not expect to receive scheduling DCI with an SRS request field having a value of “00.”

In case that the UE has received an SRS resource set having usage configured as non-codebook from the base station via higher layer signaling, that the RRC parameter resourceType within that SRS resource set is aperiodic, and that the associated CSI-RS set within the same SRS resource set is also an aperiodic NZP CSI-RS, if the UE has received the higher layer signaling minimumSchedulingOffsetK0 configured in the activated downlink bandwidth part and the configuration has a value greater than zero, the UE may perform a DCI reception operation in consideration of a combination of at least one of the following. Of course, the examples are not limited to the following.
In case that the UE receives DCI format 0_1 or 1_1, the UE may not expect to receive a value other than “00” for the SRS request field in the received DCI.
In case that the UE receives DCI format 0_1 or 1_1, the UE may not expect to receive a value other than “00” for the last two bits in the SRS request field of the received DCI, when the UE receives the supplementary Uplink configured in the higher layer signaling ServingCellConfig. When the UE does not receive supplementaryUplink configured in the higher layer signaling ServingCellConfig, the UE may not expect to receive a value other than “00” for the two bits in the SRS request field of the received DCI.
In case that the UE receives DCI format 0_2 or 1_2, if the UE has received srs-RequestDCI-0-2 or srs-RequestDCI-1-2 configured as 1 and does not receive supplementaryUplink configured in the higher layer signaling ServingCellConfig, the UE may consider that the SRS request field in DCI format 0_2 or 1_2 is one bit and may not expect to receive one bit having a value other than “0.”
In case that the UE receives DCI format 0_2 or 1_2, if the UE has received srs-RequestDCI-0-2 or srs-RequestDCI-1-2 configured as 1 and has received supplementaryUplink configured in the higher layer signaling ServingCellConfig, the UE may consider that the SRS request field in DCI format 0_2 or 1_2 is two bits and may not expect to receive the last one bit of the SRS request field having a value other than “0.”
In case that the UE receives DCI format 0_2 or 1_2, if the UE has received srs-RequestDCI-0-2 or srs-RequestDCI-1-2 configured as 2 and does not receive supplementary Uplink configured in the higher layer signaling ServingCellConfig, the UE may consider that the SRS request field in DCI format 0_2 or 1_2 is two bits and may not expect to receive the SRS request field having a value other than “00.”
In case that the UE receives DCI format 0_2 or 1_2, if the UE has received srs-RequestDCI-0-2 or srs-RequestDCI-1-2 configured as 2 and has received supplementaryUplink configured in the higher layer signaling ServingCellConfig, the UE may consider that the SRS request field in DCI format 0_2 or 1_2 is three bits and may not expect to receive the last two bits of the SRS request field having a value other than “00.”

When the UE is configured with the aperiodic associated CSI-RS associated with the aperiodic SRS resource, all TCI states configured in the cell being scheduled may not expect to receive the higher layer signaling qcl-Type configured as typeD. For example, all TCI states in the cell being scheduled may not include QCL-TypeD or may imply that the UE is operating in FR1.

For the operations described above, the UE may report corresponding UE capabilities. According to an embodiment, the UE may report a UE capability indicating support for an aperiodic associated CSI-RS. According to an embodiment, the UE may report a UE capability indicating that the UE is capable of triggering the aperiodic associated CSI-RS via DCI format 0_1, 1_1, 0_2, or 1_2. According to an embodiment, the UE may report a UE capability indicating that the UE supports supplementary Uplink. According to an embodiment, the UE may report a UE capability indicating support for minimumSchedulingOffsetK0.

### Second Embodiment: Method for Supporting a CSI-RS Configured by More than 32 CSI-RS Ports

An embodiment of the disclosure describes a method for supporting, by a UE, a CSI-RS configured by more than 32 CSI-RS ports. This embodiment may operate in combination with other embodiments.

Based on Table 7 described above, the UE may define a maximum of 32 CSI-RS ports in one CSI-RS resource. When the base station is able to use more than 32 antenna ports (e.g., 64, 96, 128 antenna ports), the UE and the base station may consider the following two methods to define more than 32 CSI-RS ports required to estimate the downlink channel between the base station and the UE. Of course, this is not limited to the following examples.

### [Method 1-1] Single CSI-RS Resource-Based Support Method

A UE and a base station may define more than 32 CSI-RS ports in a single CSI-RS resource. For example, the base station and UE may include 64, 96, 128, or 256 CSI-RS ports, more than 32, in a single CSI-RS resource. In addition, the base station and UE may define CSI-RS-ResourceMapping, which is higher layer signaling and includes an RE mapping scheme on the time and frequency resources, a CDM type, and/or a resource quantity density on the frequency resource to support 64, 96, 128, or 256 CSI-RS ports.
When a single CSI-RS resource contains more than 32 CSI-RS ports, fd-CDM2, cdm4-FD2-TD2, and cdm8-FD2-TD4 defined for a 32-port CSI-RS may be used for the CDM type. Further, at least one of cdm16-FD4-TD4, cdm32-FD8-TD4, or cdm32-FD4-TD8 may be additionally used.
When the single CSI-RS resource contains more than 32 CSI-RS ports, a resource quantity density of 1 or 0.5 on the frequency resource may be used. Further, the resource quantity density of 0.25, 0.125, etc. may be additionally used. In this case, the resource quantity density having a value of 1, 0.5, 0.25, 0.125 on the frequency resource may be understood to mean that CSI-RS RE mappings are made every RB, every 2 RBs, every 4 RBs, or every 8 RBs, respectively.
When the single CSI-RS resource contains more than 32 CSI-RS ports (for example, 256 CSI-RS ports), full RE mapping may not be possible because the number of REs within one RB is 168.

### [Method 1-2] Multiple CSI-RS Resources-Based Support Method

A UE and a base station may support more than 32 CSI-RS ports based on multiple CSI-RS resources. When the number of CSI-RS ports to be represented by multiple CSI-RS resources is Ptot, the number of CSI-RS ports to be represented by the i-th CSI-RS resource is Pi, and there are N CSI-RS resources, P1+ . . . +PN=Ptot may be established. In this case, every i-th CSI-RS resource may have the same number of CSI-RS ports or it is not excluded that they may have different numbers of CSI-RS ports. Further, the minimum value of Pi may be 1, 2, 4, 8, 12, 16, 24, or 32. For example, the UE may represent support for 64 CSI-RS ports by using two CSI-RS resources each containing 32 ports. The two CSI-RS resources may be included in the same CSI-RS resource set, and the lower indexed CSI-RS resource among the two CSI-RS resources may use ports 3000 to 3031 of the 64 ports, and the higher indexed CSI-RS resource among them may use ports 3032 to 3063 of the 64 ports. In another example, the UE may represent support for 128 CSI-RS ports by using four CSI-RS resources each containing 32 ports. The four CSI-RS resources may be included in the same CSI-RS resource set, and the CSI-RS resource having the nth lowest index among the four CSI-RS resources may use ports 3000+(n−1)*32+1 to 3000+n*32-1.

When the UE supports more than 32 Ptot CSI-RS ports by using multiple CSI-RS resources, the UE may receive from the base station the configuration of the multiple CSI-RS resources via higher layer signaling. The UE may also receive from the base station the configuration of the same or different values for some or all of the higher layer signaling included in the multiple CSI-RS resources. The UE may receive from the base station the higher layer signaling for each CSI-RS resource in the NZP-CSI-RS-Resource parameter. The UE may have the same or different conditions for each of multiple CSI-RS resources, with respect to each of the following higher layer signaling that can be configured in the NZP-CSI-RS-Resource, which is higher layer signaling that can be identified in Table 6 described above. Of course, this is not limited to the following examples:
nzp-CSI-RS-ResourceId: The UE may expect that different Ids are configured for each of the multiple CSI-RS resources;
powerControlOffset: The UE may expect that multiple CSI-RS resources each have the same powerControlOffset value. Multiple CSI-RS resources each having the same powerControlOffset value may be understood to mean that the same RE power ratio may exist between the multiple CSI-RS resources and the PDSCH;
powerControlOffsetSS: The UE may expect that multiple CSI-RS resources each have the same powerControlOffsetSS value. Multiple CSI-RS resources each having the same powerControlOffsetSS may be understood to mean that the same RE power ratio may exist between the multiple CSI-RS resources and the SSB;
scramblingId: The UE may expect that multiple CSI-RS resources each have the same scramblingId value. Multiple CSI-RS resources each having the same scramblingId value may be understood to mean that all of multiple CSI-RS resources are configured to have the same scrambling ID;
periodicity AndOffset: The UE may expect that multiple CSI-RS resources each have the same periodicity AndOffset value. Multiple CSI-RS resources each having the same periodicity AndOffset value may be understood to mean that, in the case of periodic CSI-RS or semi-periodic CSI-RS, they all have the same periodicity and slot offset, or that the Ptot CSI-RS ports supported through the multiple CSI-RS resources are all transmitted within the same slot. As another method, the UE may expect that multiple CSI-RS resources each have the same periodicity value and the same or different slot offset values in the periodicity AndOffset values. The same periodicity value and the same or different slot offset values of the periodicity AndOffset for each of the multiple CSI-RS resources may be understood as meaning that, in the case of periodic CSI-RS or semi-persistent CSI-RS, they all have the same periodicity, but the positions of the slots in which the CSI-RS ports contained in each CSI-RS resource are transmitted may be different. As another method, the UE may expect that there are no constraints in the periodicity AndOffset values for each of the multiple CSI-RS resources. No constraints on the periodicity AndOffset values for each of the multiple CSI-RS resources may be understood to mean that there are no constraints on the periodicity and slot offset values being the same or different in the case of periodic CSI-RS or semi-persistent CSI-RS. Additionally no constraints on the periodicity and slot offset values being the same or different may be understood to mean that when the UE measures the CSI-RS ports contained in each CSI-RS resource, information about some of the Ptot CSI-RS ports may be updated, and it is not necessary to update information about all CSI-RS ports at the same time or within a time that is not significantly different; and/or
qcl-InfoPeriodicCSI-RS: The UE may expect that multiple CSI-RS resources each have the same or different qcl-InfoPeriodicCSI-RS values. The UE may define this parameter (qcl-InfoPeriodicCSI-RS) only for the periodic CSI-RS. The parameter may have a value corresponding to a TCI-StateId, the TCI state ID may refer to a specific TCI-State or a specific dl-Or-Joint-TCI-State. The UE having the same qcl-InfoPeriodicCSI-RS value for multiple CSI-RS resources may be understood to mean that the UE receives Ptot CSI-RS ports transmitted in similar locations. For example, when the UE having the same qcl-InfoPeriodicCSI-RS value for multiple CSI-RS resources may be understood to mean that the Ptot CSI-RS ports are all transmitted from a TRP, radio unit (RU), or massive MIMO unit (MMU) existing in the same or similar locations. On the other hand, the UE having different qcl-InfoPeriodicCSI-RS values for multiple CSI-RS resources may be understood to mean that the CSI-RS ports contained in each CSI-RS resource are transmitted from a TRP, RU, or MMU existing in different locations.

In addition, the UE and the base station may define the CSI-RS-ResourceMapping, which is higher layer signaling in Table 6 described above, in a form including detailed parameters as shown in Table 30 below, and the UE may receive configuration information for each parameter based on the higher layer signaling from the base station. Of course, this is not limited to the example below.

```
TABLE 30
CSI-RS-ResourceMapping ::= SEQUENCE {
    frequencyDomain Allocation CHOICE {
          row1 BIT STRING (SIZE (4)),
          row2 BIT STRING (SIZE (12)),
          row4 BIT STRING (SIZE (3)),
          other BIT STRING (SIZE (6))
      },
      nrofPorts ENUMERATED {p1,p2,p4,p8,p12,p16,p24,p32},
      firstOFDMSymbolInTimeDomain INTEGER (0..13),
      firstOFDMSymbolInTimeDomain2 INTEGER (2..12) OPTIONAL, -- Need R
      cdm-Type ENUMERATED {noCDM, fd-CDM2, cdm4-FD2-TD2, cdm8-FD2-
      TD4},
      density CHOICE
        dot5 ENUMERATED {evenPRBs, oddPRBs},
        one NULL,
        three NULL,
        spare NULL
      },
    freqBand CSI-FrequencyOccupation,
    ...
}
CSI-FrequencyOccupation ::= SEQUENCE {
  startingRB INTEGER (0..maxNrofPhysicalResourceBlocks−1),
  nrofRBs INTEGER (24..maxNrofPhysicalResourceBlocksPlus1),
  ...
}
```

For each higher layer signaling in Table 30, the UE may receive the same or different information configured between the multiple CSI-RS resources, and the criteria and definitions for the configuration may be determined according to a combination of at least one of the following. Of course, this is not limited to the following examples.

The UE may expect at least one of nrofPorts, cdm-Type, density, or nrofRBs in CSI-FrequencyOccupation of the higher layer signaling in Table 30 between multiple CSI-RS resources to be the same.

The UE may expect at least one of frequencyDomainAllocation, firstOFDMSymbolInTimeDomain, firstOFDMSymbolInTimeDomain2, or startingRB of the higher layer signaling in Table 30 between multiple CSI-RS resources to be the same or different.

With respect to the method in which the UE supports a total of Ptot CSI-RS ports based on the above multiple CSI-RS resources, a specific CSI-RS resource may include all parameters in Table 6 and Table 30. On the other hand, the remaining CSI-RS resources in the multiple CSI-RS resources may exclude, from the configuration, parameters in Table 6 and Table 30 that have the same value as the specific CSI-RS resource described above. Exclusion from the configuration may be understood to mean that the specific CSI-RS resource described above has the same value as the parameters in Table 6 and Table 30.

According to an embodiment, with respect to a method in which the UE supports a total of Ptot CSI-RS ports based on the multiple CSI-RS resources above, a specific CSI-RS resource may include all parameters in Table 6 and Table 30. On the other hand, there is no parameter configured for the remaining CSI-RS resources among the multiple CSI-RS resources. Further, from the specific CSI-RS resource described above, time and frequency RE offsets are configured, so that REs to which, among the Ptot CSI-RS ports, the remaining CSI-RS ports except for the CSI-RS ports represented by the specific CSI-RS resource described above are mapped may be expressed. The RE offset may be a symbol or slot offset and may be an RE or RB offset in view of the frequency resource.

The UE may report, to the base station, a UE capability that indicates support for [Method 1-1] and [Method 1-2] described above. The base station may configure, in the UE, the higher layer signaling corresponding to the UE capability, or may support more than 32 CSI-RS ports based on a single or multiple CSI-RS resources as described above without specific higher layer signaling configuration.

### Third Embodiment: Method for Supporting an Associated CSI-RS Configured by More than 32 CSI-RS Ports

An embodiment of the disclosure describes a method when a UE supports an associated CSI-RS configured by more than 32 CSI-RS ports. This embodiment may operate in combination with other embodiments.

When the UE supports an associated CSI-RS configured by more than 32 CSI-RS ports based on [Method 1-1], the UE may receive the higher layer signaling for one associated CSI-RS configured within the SRS-resourceSet as shown in Table 31.

When the UE receives from the base station the resourceType within the SRS-resourceSet configured as aperiodic, the UE may receive a configuration of an associated CSI-RS resource ID from the base station via the higher layer signaling csi-RS.

When the UE receives a configuration of the resourceType within the SRS-resourceSet from the base station as semi-permanent or periodic, the UE may receive a configuration of the associated CSI-RS resource ID from the base station via the higher layer signaling associatedCSI-RS.

The UE may assume that the higher layer signaling csi-RS or associatedCSI-RS may optionally exist for the case of non-codebook-based transmission, otherwise the corresponding field (e.g., csi-RS or associatedCSI-RS) may be assumed not to exist. In this case, the non-codebook-based transmission may be understood to mean that the usage within the SRS-resourceSet, which is higher layer signaling, is configured for the UE as nonCodebook.

The UE may expect the CSI-RS resource configured via csi-RS, which is higher layer signaling, to be one of aperiodic, periodic, or semi-permanent CSI-RS resources. The base station may configure, for the UE, one of aperiodic, periodic, or semi-permanent CSI-RS resources via the higher layer signaling csi-RS.

The UE may expect the CSI-RS resource configured via associatedCSI-RS, which is higher layer signaling, to be one of periodic or semi-permanent CSI-RS resource and may not expect the same to be an aperiodic CSI-RS resource. The base station may configure, for the UE, one of periodic or semi-permanent CSI-RS resources via the higher layer signaling associatedCSI-RS and may not configure an aperiodic CSI-RS resource.

```
TABLE 31
SRS-ResourceSet ::= SEQUENCE {
  srs-ResourceSetId SRS-ResourceSetId,
  srs-ResourceIdList SEQUENCE (SIZE(1..maxNrofSRS-ResourcesPerSet)) OF SRS-
ResourceId OPTIONAL, -- Cond Setup
  resourceType CHOICE {
    aperiodic SEQUENCE {
      aperiodicSRS-ResourceTrigger INTEGER (1..maxNrofSRS-TriggerStates−1),
      csi-RS NZP-CSI-RS-ResourceId OPTIONAL, -- Cond NonCodebook
      slotOffset INTEGER (1..32) OPTIONAL, -- Need S
      ...,
      [[
      aperiodicSRS-ResourceTriggerList SEQUENCE (SIZE(1..maxNrofSRS-
TriggerStates−2))
        OF INTEGER (1..maxNrofSRS-
TriggerStates−1) OPTIONAL -- Need M
      ]]
    },
    semi-persistent SEQUENCE {
      associatedCSI-RS NZP-CSI-RS-ResourceId OPTIONAL, -- Cond NonCodebook
      ...
    },
    periodic SEQUENCE {
      associatedCSI-RS NZP-CSI-RS-ResourceId OPTIONAL, -- Cond NonCodebook
      ...
    }
},
```

When the UE supports an associated CSI-RS configured by more than 32 CSI-RS ports based on [Methods 1-2], the UE may receive the higher layer signaling for the associated CSI-RS configured within the SRS-resourceSet by using a combination of at least one of the following methods. This is not limited to the following examples.

### [Method 2-1]

When the UE receives, from the base station, the resourceType in SRS-ResourceSet configured as aperiodic, the UE may receive multiple associated CSI-RS resource IDs configured via the higher layer signaling csi-RS-List from the base station. When the UE receives a configuration of csi-RS-List, the UE may expect not to receive a configuration of higher layer signaling csi-RS, or even when csi-RS is configured, the UE may expect to ignore a value thereof and instead use a value configured in the csi-RS-List.

When the UE receives the resourceType in SRS-ResourceSet configured as semi-persistent or periodic from the base station, the UE may receive multiple associated CSI-RS resource IDs configured via the higher layer signaling associatedCSI-RS-List from the base station. When the UE receives a configuration of associatedCSI-RS-List, the UE may expect not to receive a configuration of higher layer signaling associatedCSI-RS, or even when associatedCSI-RS is configured, the UE may expect to ignore a value thereof and instead use a value configured in the associatedCSI-RS-List.

The UE may assume that the csi-RS-List or associatedCSI-RS-List, which is higher layer signaling, may optionally exist in the case of non-codebook-based transmission and in case that the number of ports of the associated CSI-RS exceeds 32, otherwise the corresponding field (e.g., csi-RS-List or associatedCSI-RS-List) may be assumed not to exist. In this case, the non-codebook-based transmission may be understood to mean that the usage within the SRS-resourceSet, which is higher layer signaling, is configured for the UE as nonCodebook. The names of the conditions described above (e.g., non-codebook-based transmission and the number of ports of the associated CSI-RS exceeding 32) may be defined as nonCodebook2 as in Table 32 below. However, nonCodebook2 is only an example and is used to distinguish the same from nonCodebook, which is a condition that may be used at the time of configuring the csi-RS or associatedCSI-RS. In addition, the actual name of the above condition may be different from nonCodebook2, such as nonCodebookWithMoreThan32PortCSI-RS. Alternatively, the UE may expect that nonCodebook, which is a condition used for csi-RS or associatedCSI-RS, is also used at the time of configuring the csi-RS-List or associatedCSI-RS-List.

The UE may expect that the configuration condition nonCodebook of the csi-RS and associatedCSI-RS may optionally exist for the case in which the usage within the SRS-ResourceSet is configured as nonCodebook, and the number of ports of the associated CSI-RS is 32 or less.

The UE may consider, as 2, 3, or 4, the value of maxNumAssCSI-RSRes, which is the maximum number of CSI-RS resources that the csi-RS-List and associatedCSI-RS-List may contain. The same value of maxNumAssCSI-RSRes may be applied to the csi-RS-List and associatedCSI-RS-List, or a separate value may be applied thereto. The UE may receive the value of maxNumAssCSI-RSRes from the base station via a combination of at least one of higher layer signaling, MAC-CE signaling, or L1 signaling, or may use a fixed value defined in the specification. The UE may report the maxNumAssCSI-RSRes value to the base station through UE capability.

The higher layer signaling structure corresponding to [Method 2-1], the configuration of which the UE may receive from the base station, may be considered as shown in Table 32 below. Of course, this is not limited to the example below.

```
TABLE 32
SRS-ResourceSet ::= SEQUENCE {
  srs-ResourceSetId SRS-ResourceSetId,
  srs-ResourceIdList SEQUENCE (SIZE(1..maxNrofSRS-ResourcesPerSet)) OF SRS-
ResourceId OPTIONAL, -- Cond Setup
  resourceType CHOICE {
    aperiodic SEQUENCE {
      aperiodicSRS-ResourceTrigger INTEGER (1..maxNrofSRS-TriggerStates−1),
      csi-RS NZP-CSI-RS-ResourceId OPTIONAL, -- Cond NonCodebook
      csi-RS-List SEQUENCE (SIZE(1..maxNumAssCSI-RSRes) NZP-CSI-RS-
ResourceId OPTIONAL, -- Cond NonCodebook2
      slotOffset INTEGER (1..32) OPTIONAL, -- Need S
      ...,
      [[
      aperiodicSRS-ResourceTriggerList SEQUENCE
TriggerStates−2))
        OF INTEGER (1..maxNrofSRS-
TriggerStates−1) OPTIONAL -- Need M
      ]]
    },
    semi-persistent SEQUENCE {
      associatedCSI-RS NZP-CSI-RS-ResourceId OPTIONAL, -- Cond NonCodebook
      associatedCSI-RS SEQUENCE (SIZE(1..maxNumAssCSI-RSRes)) NZP-CSI-RS-
ResourceId OPTIONAL, -- Cond NonCodebook2
      ...
    },
    periodic SEQUENCE {
      associatedCSI-RS NZP-CSI-RS-ResourceId OPTIONAL, -- Cond NonCodebook
      associatedCSI-RS SEQUENCE (SIZE(1..maxNumAssCSI-RSRes)) NZP-CSI-RS-
ResourceId OPTIONAL, -- Cond NonCodebook2
      ...
    }
},
```

### [Method 2-2]

When the UE receives from the base station the resourceType within the SRS-resourceSet configured as aperiodic, the UE may receive a configuration of one CSI-RS resource set from the base station via the higher layer signaling csi-RS-Set. In addition, the UE may consider, as an associated CSI-RS resource, one or more CSI-RS resources within the CSI-RS resource set. When the UE receives a configuration of csi-RS-Set, the UE may expect not to receive higher layer signaling csi-RS, or even when csi-RS is configured, the UE may expect to ignore a value thereof and instead use a value configured in the csi-RS-Set.

When the UE receives the resourceType in SRS-ResourceSet configured as semi-persistent or periodic from the base station, the UE may receive one CSI-RS resource set configured via the higher layer signaling associatedCSI-RS-Set from the base station and may consider all of one or more CSI-RS resources within the corresponding CSI-RS resource set as associated CSI-RS resources. When the UE receives a configuration of associatedCSI-RS-Set, the UE may expect not to receive a configuration of higher layer signaling associatedCSI-RS, or even when associatedCSI-RS is configured, the UE may expect to ignore a value thereof and instead use a value configured in the associatedCSI-RS-Set.

The UE may assume that the csi-RS-Set or associatedCSI-RS-Set, which is higher layer signaling, may optionally exist in the case of non-codebook-based transmission and in case that the number of ports of the associated CSI-RS exceeds 32, otherwise the corresponding field (e.g., csi-RS-Set or associatedCSI-RS-Set) may be assumed not to exist. In this case, the non-codebook-based transmission may be understood to mean that the usage within the SRS-resourceSet, which is higher layer signaling, is configured for the UE as nonCodebook. The names of the conditions described above (e.g., non-codebook-based transmission and the number of ports of the associated CSI-RS exceeding 32) may be defined as nonCodebook2 as in Table 33 below. However, nonCodebook2 is only an example and is used to distinguish the same from nonCodebook, which is a condition that may be used at the time of configuring the csi-RS or associatedCSI-RS. In addition, the actual name of the above condition may be different from nonCodebook2, such as nonCodebook WithMoreThan32PortCSI-RS. Alternatively, the UE may expect that nonCodebook, which is a condition used for csi-RS or associatedCSI-RS, is also used at the time of configuring csi-RS-Set or associatedCSI-RS-Set.

The UE may expect that the configuration condition nonCodebook of the csi-RS and associatedCSI-RS may optionally exist for the case in which the usage of the SRS-ResourceSet is configured as nonCodebook, and the number of ports of the associated CSI-RS is 32 or less.

The higher layer signaling structure corresponding to [Method 2-2], the configuration of which the UE may receive from the base station, may be considered as shown in Table 33 below. Of course, this is not limited to the example below.

```
TABLE 33
SRS-ResourceSet ::= SEQUENCE {
  srs-ResourceSetId SRS-ResourceSetId,
  srs-ResourceIdList SEQUENCE (SIZE(1..maxNrofSRS-ResourcesPerSet)) OF SRS-
ResourceId OPTIONAL, -- Cond Setup
  resourceType CHOICE {
    aperiodic SEQUENCE {
      aperiodicSRS-ResourceTrigger INTEGER (1..maxNrofSRS-TriggerStates−1),
      csi-RS NZP-CSI-RS-ResourceId OPTIONAL, -- Cond NonCodebook
      csi-RS-Set NZP-CSI-RS-ResourceSetId OPTIONAL, -- Cond NonCodebook2
      slotOffset INTEGER (1..32) OPTIONAL, -- Need S
      ...,
      [[
      aperiodicSRS-ResourceTriggerList SEQUENCE (SIZE(1..maxNrofSRS-
TriggerStates−2))
        OF INTEGER (1..maxNrofSRS-
TriggerStates−1) OPTIONAL -- Need M
      ]]
    },
    semi-persistent SEQUENCE {
      associatedCSI-RS NZP-CSI-RS-ResourceId OPTIONAL, -- Cond NonCodebook
      associatedCSI-RS-Set NZP-CSI-RS-ResourceSetId OPTIONAL, -- Cond
NonCodebook2
      ...
    },
    periodic SEQUENCE {
      associatedCSI-RS NZP-CSI-RS-ResourceId OPTIONAL, -- Cond NonCodebook
      associatedCSI-RS-Set NZP-CSI-RS-ResourceSetId OPTIONAL, -- Cond
NonCodebook2
      ...
    }
},
```

### [Method 2-3]

When the UE receives from the base station the resourceType within the SRS-resourceSet configured as aperiodic, the UE may receive a configuration of one CSI-RS resource from the base station via the higher layer signaling csi-RS. In addition, when the number of ports of the associated CSI-RS exceeds 32, the UE may additionally receive a configuration of one or more associated CSI-RS resource IDs from the base station via the higher layer signaling csi-RS-List. When the UE receives both the higher layer signaling csi-RS and csi-RS-List from the base station, the UE may consider one or more CSI-RS resources configured via the csi-RS and csi-RS-List as the associated CSI-RS.

When the UE receives from the base station the resourceType in SRS-ResourceSet configured as semi-persistent or periodic, the UE may receive a configuration of one CSI-RS resource from the base station via the higher layer signaling associatedCSI-RS. In addition, when the number of ports of the associated CSI-RS exceeds 32, the UE may additionally receive a configuration of one or more additional associated CSI-RS resource IDs from the base station via the higher layer signaling associatedCSI-RS-List. When the UE receives a configuration of both the higher layer signaling associatedCSI-RS and associatedCSI-RS-List from the base station, the UE may consider one or more CSI-RS resources configured via associatedCSI-RS and associatedCSI-RS-List as the associated CSI-RS.

The UE may assume that the csi-RS-List or associatedCSI-RS-List, which is the higher layer signaling, may optionally exist in the case of non-codebook-based transmission and in case that the number of ports of the associated CSI-RS exceeds 32, otherwise the corresponding field (e.g., csi-RS-List or associatedCSI-RS-List) may be assumed not to exist. In this case, the non-codebook-based transmission may be understood to mean that the UE has usage configured as “nonCodebook” within the SRS-resourceSet, wherein the usage is higher layer signaling. The names of the conditions described above (e.g., non-codebook-based transmission and the number of ports of the associated CSI-RS exceeding 32) may be defined as nonCodebook2 as in Table 32 below. However, nonCodebook2 is only an example and is used to distinguish the same from nonCodebook, which is a condition that may be used when configuring csi-RS or associatedCSI-RS. In addition, the actual name of the above condition be as may different from nonCodebook2, such nonCodebookWithMoreThan32PortCSI-RS. Alternatively, the UE may expect that nonCodebook, which is a condition used for csi-RS or associatedCSI-RS, is also used when configuring csi-RS-List or associatedCSI-RS-List.

The UE may expect that the configuration condition nonCodebook of the csi-RS and associatedCSI-RS may optionally exist for the case in which the usage of the SRS-ResourceSet is configured as nonCodebook, and the number of ports of the associated CSI-RS is 32 or less.

The UE may consider, as 2 or 3, the value of maxNumAssCSI-RSRes, which is the maximum number of CSI-RS resources that the csi-RS-List and associatedCSI-RS-List may contain. The same value of maxNumAssCSI-RSRes may be applied to the csi-RS-List and associatedCSI-RS-List, or a separate value may be applied thereto. The UE may receive the value of maxNumAssCSI-RSRes from the base station via a combination of at least one of higher layer signaling, MAC-CE signaling, or L1 signaling, or may use a fixed value defined in the specification. The UE may report the maxNumAssCSI-RSRes value to the base station through UE capability.

The higher layer signaling structure corresponding to [Method 2-3], the configuration of which the UE may receive from the base station, may be considered as shown in Table 34 below. Of course, this is not limited to the example below.

```
TABLE 34
SRS-ResourceSet ::= SEQUENCE {
  srs-ResourceSetId SRS-ResourceSetId,
  srs-ResourceIdList SEQUENCE (SIZE(1..maxNrofSRS-ResourcesPerSet)) OF SRS-
ResourceId OPTIONAL, -- Cond Setup
  resourceType CHOICE {
    aperiodic SEQUENCE {
      aperiodicSRS-ResourceTrigger INTEGER (1..maxNrofSRS-TriggerStates−1),
      csi-RS NZP-CSI-RS-ResourceId OPTIONAL, -- Cond NonCodebook
      csi-RS-List SEQUENCE (SIZE(1..maxNumAssCSI-RSRes)) NZP-CSI-RS-
ResourceId OPTIONAL, -- Cond NonCodebook2
      slotOffset INTEGER (1..32) OPTIONAL, -- Need S
      ...,
      [[
      aperiodicSRS-ResourceTriggerList SEQUENCE (SIZE(1..maxNrofSRS-
TriggerStates−2))
        OF INTEGER (1..maxNrofSRS-
TriggerStates−1) OPTIONAL -- Need M
      ]]
    },
    semi-persistent SEQUENCE {
      associatedCSI-RS NZP-CSI-RS-ResourceId OPTIONAL, -- Cond NonCodebook
      associatedCSI-RS SEQUENCE (SIZE(1..maxNumAssCSI-RSRes)) NZP-CSI-RS-
ResourceId OPTIONAL, -- Cond NonCodebook2
      ...
    },
    periodic SEQUENCE
      associatedCSI-RS NZP-CSI-RS-ResourceId OPTIONAL, -- Cond NonCodebook
      associatedCSI-RS SEQUENCE (SIZE(1..maxNumAssCSI-RSRes)) NZP-CSI-RS-
ResourceId OPTIONAL, -- Cond NonCodebook2
      ...
    }
},
```

### [Method 2-4]

When the UE receives, from the base station, a resourceType within the SRS-resourceSet configured as aperiodic, the UE may receive one CSI-RS resource from the base station via the higher layer signaling csi-RS. When the UE receives from the base station a configuration of associated CSI-RS having 32 or less ports, the UE may expect that the CSI-RS resource that can be configured via the csi-RS includes 32 or less ports and may consider the configured CSI-RS resource to be an associated CSI-RS. When the UE receives from the base station a configuration of associated CSI-RS having more than 32 ports, the UE may expect that all CSI-RS resources within the CSI-RS resource set including the CSI-RS resource that can be configured via csi-RS are configured as associated CSI-RS.

When the UE receives from the base station a resourceType within the SRS-resourceSet configured as semi-persistent or periodic, the UE may receive a configuration of one CSI-RS resource from the base station via the higher layer signaling associatedCSI-RS. When the UE receives a configuration of associated CSI-RS having 32 or less ports from the base station, the UE may expect that a CSI-RS resource that can be configured via associatedCSI-RS includes 32 or less ports and may consider the configured CSI-RS resource to be an associated CSI-RS. When the UE receives a configuration of associated CSI-RS from the base station having more than 32 ports, the UE may expect that all CSI-RS resources within the CSI-RS resource set including the CSI-RS resource that can be configured via the associatedCSI-RS are configured as the associated CSI-RS.

In this case, the UE may receive, from the base station, information indicating whether the associated CSI-RS, the configuration of which has been received by the UE, includes 32 or less ports or more than 32 ports via a combination of at least one of higher layer signaling, MAC-CE signaling, or L1 signaling, or may be implicitly indicated based on the configuration state of the CSI-RS resource set including the configured CSI-RS resource. For example, the UE may receive a specific higher layer signaling configured within the CSI-RS resource set such that one or more CSI-RS resources within the CSI-RS resource set are considered to be used to represent more than 32 ports. In addition, each CSI-RS resource may be considered to be incapable of representing an individual CSI-RS. When the UE is implicitly indicated whether the number of ports in the associated CSI-RS is less than or equal to 32 or greater than 32 based on the configuration state of the CSI-RS resource set including the CSI-RS resource configured through the csi-RS or the associatedCSI-RS, the UE may make a determination based on at least one of the number of CSI-RS resources included in the CSI-RS resource set, the total number of CSI-RS ports that can be calculated across all CSI-RS resources, whether a higher layer signaling CMR group has been configured, or whether the CSI-RS resource set is associated with a CSI-ReportConfig in which the codebookType is configured as Type-II coherent joint transmission.

For example, with respect to the case in which the total number of CSI-RS ports that can be calculated across all CSI-RS resources included in the CSI-RS resource set exceeds 32, the higher layer signaling CMR group is not configured, and the CSI-RS resource set is not associated with a CSI-ReportConfig in which codebookType is configured as Type-II coherent joint transmission, the UE may consider that all CSI-RS resources included in the CSI-RS resource set are used to represent more than 32 ports, and each CSI-RS resource are incapable of representing an individual CSI-RS. The above conditions may be included in the higher layer signaling csi-RS or within the nonCodebook that is a condition of the configuration for the associatedCSI-RS.

### [Method 2-5]

The UE may receive, from the base station, information indicating a combination of at least one of [Method 2-1] to [Method 2-4] via a combination of at least one of higher layer signaling, MAC-CE signaling, or L1 signaling, or may follow a method fixedly defined in the specification. For example, the UE may receive a configuration of associated CSI-RS including more than 32 ports according to [Method 2-1] as fixedly defined in the specification. In another example, the UE may be configured with one of [Method 2-1], [Method 2-3], or [Method 2-4] via higher layer signaling, and may receive a configuration of associated CSI-RS that includes more than 32 ports according to the configured method.

The UE may report to the base station via a UE capability whether it is capable of supporting a combination of at least one of [Methods 2-1] to [Methods 2-5]. In this case, when the UE reports that it is capable of supporting a particular method, it may be understood to mean that only the particular method among the multiple methods is supportable, and the other methods are not supportable except for the particular method that is supportable among the multiple methods. For example, the UE may report one of [Method 2-1] and [Method 2-3] to the base station. When the UE reports that [Method 2-1] is supportable, reporting that [Method 2-1] is supportable may automatically imply that the UE is unable to support [Method 2-3].

The UE may apply a combination of at least one of [Method 2-1] to [Method 2-5] depending on the time domain behavior of the SRS resource set. For example, the UE may apply [Method 2-1] for an SRS resource set with resourceType configured as aperiodic. Alternatively, in the case of periodic or semi-persistent, the UE may not apply any of [Method 2-1] to [Method 2-5] and may follow a conventional method. Following the conventional method may be understood to mean that, when considering associated CSI-RS, only one CSI-RS resource is configured and only the one CSI-RS resource is considered as the associated CSI-RS. For example, when following the above-described method, the UE may not be configured with an associated CSI-RS including more than 32 ports in the case of an SRS resource set in which the resourceType is configured as periodic or semi-persistent.

### Fourth Embodiment: Receiving Location Upon Triggering of Aperiodic Associated CSI-RS Configured by More than 32 CSI-RS Ports

An embodiment of the disclosure describes a receiving location of an aperiodic associated CSI-RS when a UE receives, from a base station, a triggering signal for the aperiodic associated CSI-RS including more than 32 CSI-RS ports that may be configured by multiple CSI-RS resources. In this case, the UE may follow a combination of at least one of [Method 2-1] to [Method 2-5] with respect to a method for supporting an aperiodic associated CSI-RS including more than 32 CSI-RS ports. This embodiment may operate in combination with other embodiments.

In case that an aperiodic associated CSI-RS including more than 32 CSI-RS ports, which may be configured by multiple CSI-RS resources, is triggered via DCI format 0_1, 0_2, 1_1, or 1_2, the UE may define the location of an aperiodic associated CSI-RS as follows. Of course, this is not limited to the example below.

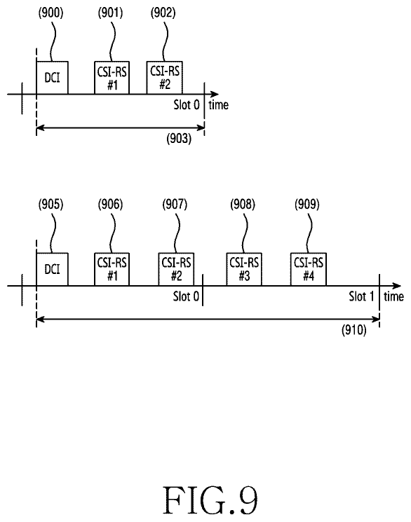

FIG. 9 illustrates possible locations where an aperiodic associated CSI-RS may exist according to an embodiment of the present disclosure.

### [Method 3-1]

When a UE receives DCI format 0_1, 0_2, 1_1, or 1_2 (indicated by reference numeral 900), the UE may expect to receive all of aperiodic associated CSI-RSs including more than 32 CSI-RS ports, which may consist of multiple CSI-RS resources, within a slot in which DCI has been received. For example, when the UE has received the DCI 900 within slot 0, the UE may consider, as an area in which aperiodic associated CSI-RSs including more than 32 CSI-RS ports that can be configured by multiple CSI-RS resources can be received, an interval (indicated by reference numeral 903) ranging from a first symbol in which the DCI is received to a last symbol of a slot in which the corresponding DCI is located. When the aperiodic associated CSI-RS is configured by two CSI-RS resources 901 and 902, each containing 32 ports for a total of 64 ports, the UE may expect that two CSI-RS resources are received within the interval 903. In this case, there may be no downlink and uplink switching between the two CSI-RS resource transmissions.

### [Method 3-2]

When the UE receives DCI format 0_1, 0_2, 1_1, or 1_2 (indicated by reference numeral 905), the UE may expect to receive all of the aperiodic associated CSI-RSs including more than 32 CSI-RS ports that can be configured by multiple CSI-RS resources, within a slot in which DCI is received and a slot following the slot in which DCI has been received (e.g., in two consecutive slots including the slot in which the DCI has been received). For example, when the UE has received the DCI 905 within slot 0, the UE may consider, as an area in which aperiodic associated CSI-RSs including more than 32 CSI-RS ports that can be configured by multiple CSI-RS resources can be received, an interval (indicated by reference numeral 910) ranging from a first symbol in which the DCI is received to a last symbol of the slot following the slot in which the corresponding DCI is located. When the aperiodic associated CSI-RS is configured by four CSI-RS resources 906, 907, 908, and 909, each containing 32 ports for a total of 128 ports, the UE may expect that two CSI-RS resources are received within slots 910. In this case, there may be no downlink and uplink switching between each CSI-RS resource transmission. In this case, the UE may expect that the CSI-RS resource that the UE receives first among the multiple CSI-RS resources configuring the associated CSI-RS exists in the same slot as the slot in which the DCI is received. Alternatively, the UE may report, via a UE capability, the number of CSI-RS resources that may exist in the same slot as the slot in which the DCI is received among the multiple CSI-RS resources including the associated CSI-RS.

The UE may receive information for a combination of at least one of [Method 3-1] and [Method 3-2] by using a combination of at least one of higher layer signaling, MAC-CE signaling, or L1 signaling from the base station, or may follow a method defined fixedly in the specification.

The UE may define a combination of at least one of [Method 3-1] and [Method 3-2] depending on the total number of ports included in the associated CSI-RS, and the number of CSI-RS resources. For example, the UE may follow [Method 3-1] when the number of associated CSI-RS resources is two and may follow [Method 3-2] when the number of associated CSI-RS resources is three and four. For example, the UE may follow [Method 3-1] when the total number of ports included in the associated CSI-RS is 64 or less and may follow [Method 3-2] when the total number of ports included in the associated CSI-RS is more than 64.

The UE may report to the base station whether the UE supports a combination of at least one of [Method 3-1] and [Method 3-2]. In this case, when the UE reports that the UE is capable of supporting a particular method, it may be understood to mean that only the particular method among the multiple methods is supportable, and the other methods are not supportable except for the particular method among the multiple methods. For example, the UE may report one of [Method 3-1] and [Method 3-3] to the base station. When the UE reports that [Method 3-1] is supportable, reporting that [Method 2-1] is supportable may automatically imply that the UE is unable to support [Method 2-3].

When the UE has been configured with an aperiodic associated CSI-RS including more than 32 CSI-RS ports that can be configured by multiple CSI-RS resources, and the SRS resources within the SRS resource set having usage configured as non-codebook are aperiodic SRS, the UE may not expect a time interval to be less than 42·2^{max (0,μ-3)}+d symbols, the time interval ranging from a last symbol of the last received CSI-RS resource among the one or more CSI-RS resources configuring the associated CSI-RS to a time point of transmission of one or more SRS resources to which precoding is applied.

Here, μ may be a value representing a subcarrier spacing, and “d” may be defined by considering a combination of at least one of the following:
d may denote a specific number of symbols independent of a subcarrier spacing (e.g., 3 symbols);
d may denote a specific number of symbols associated with a subcarrier spacing.

This may also have a different value for each subcarrier spacing (e.g., d=0 in case that μ=0, d=2 in case that μ=1, d=4 in case that μ=2, d=8 in case that μ=3, d=16 in case that μ=5, and d=32 in case that μ=6), and this value may change with respect to a specific subcarrier (e.g., d has a value of 2·2^{max (0,μ-3)}, d=2 up to 120 kHz, and d=8 and d=16 at 480 kHz and 960 kHz, respectively);
d may denote a specific absolute time (e.g., a value in msec units) (e.g., 1 ms) that is independent of a subcarrier spacing; and/or
d may have a different value depending on the number of CSI-RS resources and/or the total number of ports contained in the associated CSI-RS. For example, d may have a value of 10 when the associated CSI-RS has a total number of ports of 64, and d may have a value of 30 when the total number of ports is 128.

For example, when the associated CSI-RS is an aperiodic CSI-RS, and the SRS resource within the SRS resource set having usage configured as non-codebook is an aperiodic SRS, the UE may estimate a channel based on the associated CSI-RS and calculate a precoder to apply precoding to the SRS resource and use a time corresponding to at least 42 symbols before transmission.

The UE may receive a definition regarding “d” from the base station by using a combination of at least one of higher layer signaling, MAC-CE signaling, or L1 signaling, or may use a value defined fixedly in the specification.

The UE may report a definition regarding “d” to the base station through a UE capability. The UE capability may be reported as a different value for each subcarrier spacing depending on the definition of “d,” or may be defined so that its value changes with respect to a particular subcarrier or may be considered independent of the subcarrier.

When some of the symbols, configured for the UE, via the higher layer signaling tdd-UL-DL-ConfigurationCommon or tdd-UL-DL-ConfigurationDedicated are UL symbols, the UE may not receive CSI-RSs that overlap with UL symbols configured within the slot. When an associated CSI-RS is configured by multiple CSI-RS resources and includes more than 32 ports, and/or when at least one CSI-RS resource including the associated CSI-RS overlaps with the configured UL symbol, the UE may expect not to receive the remaining CSI-RS resources configuring the corresponding associated CSI-RS. For example, the UE may not expect to receive only some CSI-RS resources among the multiple CSI-RS resources that configure the associated CSI-RS. With respect to an operation of not receiving all CSI-RS resources due to overlap with UL symbols, the UE may apply the operation in case that the associated CSI-RS is at least periodic or semi-permanent, but may not apply the operation in case that the associated CSI-RS is aperiodic. In addition, with respect to an operation of not receiving all CSI-RS resources due to overlap with UL symbols, the UE may apply the operation regardless of whether the associated CSI-RS is periodic, semi-persistent, or aperiodic.

When the aperiodic associated CSI-RS described above includes multiple CSI-RS resources, and the total number of ports of the CSI-RS is greater than 32 (e.g., 48, 64, or 128), the UE may consider a combination of at least one of [Method 3-1] or [Method 3-2] above in determining the reception location of the multiple CSI-RS resources. When the UE follows [Method 2-1] or [Method 2-3] with respect to an aperiodic associated CSI-RS support scheme including more than 32 CSI-RS ports (e.g., the UE receives one or more CSI-RS resources configured via higher layer signaling within an SRS resource set having usage configured as noncodebook for aperiodic associated CSI-RS support), the UE may additionally consider the following details. The UE may consider at least one of the following. Of course, the examples are not limited to the following.
In case that the UE does not receive a configuration of a slot offset, which is higher layer signaling, for each of the one or more CSI-RS resources configured within the SRS resource set having usage configured as noncodebook, if the UE receives triggering on the reception of aperiodic associated CSI-RS having a total number of CSI-RS ports greater than 32 (e.g., 48, 64, or 128) via DCI, the reception location of the aperiodic associated CSI-RS may be limited to within the same slot as the DCI. In this case, the reception of aperiodic associated CSI-RS may be understood to mean that all of one or more CSI-RS resources are received. In this case, the UE may expect that all of one or more CSI-RS resources are received in the same slot. For example, when each of the N CSI-RS resources configured as aperiodic associated CSI-RS has M CSI-RS ports, the UE may receive higher layer signaling density values configured as evenPRBs for some of the four CSI-RS resources and oddPRBs for the remaining some CSI-RS resources. In this case, “N” may have a value of 2, 3, or 4, and “M” may have a value of 16, 24, or 32. For example, with respect to the case in which N is 4 and M is 32, the UE may be configured with even PRBs for some CSI-RS resources and oddPRBs for the remaining some CSI-RS resources as described above.
In case that the UE receives a configuration of a slot offset set, which is higher layer signaling, for one or more CSI-RS resources configured within the SRS resource set having usage configured as noncodebook, if the UE receives triggering on the reception of aperiodic associated CSI-RS having a total number of CSI-RS ports greater than 32 (e.g., 48, 64, or 128) via DCI, the UE may ignore the slot offset configured in each CSI-RS resource and expect to receive the aperiodic associated CSI-RS by considering a new slot offset for each CSI-RS resource. In this case, the reception of aperiodic associated CSI-RS may be understood to mean that all of one or more CSI-RS resources are received. If some CSI-RS resources among the respective CSI-RS resources receive slot offsets configured as N, the UE may expect that the remaining some CSI-RS resources receive slot offsets configured as (N+1). For example, the UE may expect to receive higher layer signaling configured such that all of CSI-RS resources are received within the CSI-RS resource set in two consecutive slots. The UE may expect that some CSI-RS resources having a slot offset configured as N described above are received in a slot in which DCI for triggering the aperiodic associated CSI-RS is received (e.g., the UE may ignore the slot offset N and consider the same to have a value of 0). In addition, the UE may expect that the remaining some CSI-RS resources having a slot offset configured as (N+1) are received in the slot following the slot in which DCI for triggering the aperiodic associated CSI-RS is received (e.g., the UE may ignore the slot offset (N+1) and consider the same to have a value of 1). For example, when there are N CSI-RS resources each having M CSI-RS ports, the UE may expect that N has a value of 2, 3, or 4, and M has a value of 16, 24, or 32.
In case that the UE receives a configuration of a slot offset, which is higher layer signaling, for each of the one or more CSI-RS resources configured within the SRS resource set having usage configured as noncodebook, if the UE receives triggering on the reception of aperiodic associated CSI-RS via DCI where the total number of CSI-RS ports is greater than 32 (e.g., 48, 64, or 128), the UE may expect to receive the aperiodic associated CSI-RS by considering the slot offset configured for each CSI-RS resource. In this case, the reception of aperiodic associated CSI-RS may be understood to mean that all of one or more CSI-RS resources are received. In this case, if some CSI-RS resources among the respective CSI-RS resources receive slot offsets configured as N, the UE may expect that the remaining some CSI-RS resources receive slot offsets configured as (N+1). For example, the UE may expect to receive higher layer signaling configured such that all of CSI-RS resources are received in two consecutive slots. The UE may expect that some CSI-RS resources having a slot offset configured as N described above are received in a slot which is distant by N slots from the slot in which the DCI for triggering the aperiodic associated CSI-RS is received. Further, the UE may expect that the remaining some CSI-RS resources having a slot offset configured as (N+1) are received in a slot which is distant by (N+1) slots from the slot in which the DCI for triggering the aperiodic associated CSI-RS is received. For example, when there are N CSI-RS resources each having M CSI-RS ports, the UE may expect that N has a value of 2, 3, or 4, and M has a value of 16, 24, or 32.

When the aperiodic associated CSI-RS described above includes multiple CSI-RS resources and the total number of ports of the CSI-RS is greater than 32 (e.g., 48, 64, or 128), the UE may consider a combination of at least one of [Method 3-1] or [Method 3-2] above in determining the reception location of the multiple CSI-RS resources. When the UE follows [Method 2-2] for an aperiodic associated CSI-RS support scheme including more than 32 CSI-RS ports (e.g., when the UE receives, via higher layer signaling, a configuration of CSI-RS resource set including at least one CSI-RS resource within an SRS resource set having usage configured as noncodebook for aperiodic associated CSI-RS support), the UE may additionally consider the details below. The UE may consider at least one of the details. Of course, the examples are not limited to the examples below.
In case that the UE does not receive a higher layer signaling slot offset (e.g., aperiodicTriggeringOffset, aperiodicTriggeringOffset-r16, aperiodicTriggeringOffset-r17, or aperiodicTriggeringOffsetL2-r17) configured within the CSI-RS resource set that is configured within the SRS resource set having usage configured as noncodebook, and does not receive resource-specific slot offsets configured in all CSI-RS resources within the CSI-RS resource set, if the UE receives triggering on the reception of aperiodic associated CSI-RS having a total number of CSI-RS ports greater than 32 (e.g., 48, 64, or 128) via DCI, the reception location of the aperiodic associated CSI-RS may be limited to within the same slot as the DCI. In this case, the reception of aperiodic associated CSI-RS may be understood to mean that all of CSI-RS resources configured in the CSI-RS resource set are received. For example, the UE may expect that all of CSI-RS resources within CSI-RS resource set are received in the same slot. For example, when each of the N CSI-RS resources within the CSI-RS resource set has M CSI-RS ports, the UE may receive higher layer signaling density values configured as evenPRBs for some of the four CSI-RS resources and oddPRBs for the remaining some CSI-RS resources. In this case, “N” may have a value of 2, 3, or 4, and “M” may have a value of 16, 24, or 32. For example, with respect to the case in which N is 4 and M is 32, the UE may be configured with evenPRBs for some CSI-RS resources and oddPRBs for the remaining some CSI-RS resources as described above.
In case that the UE receives a higher layer signaling slot offset configured within the CSI-RS resource set that is configured within the SRS resource set having usage configured as noncodebook, and does not receive resource-specific slot offsets configured in all CSI-RS resources within the CSI-RS resource set, if the UE receives triggering on the reception of aperiodic associated CSI-RS having a total number of CSI-RS ports greater than 32 (e.g., 48, 64, or 128) via DCI, the UE may ignore the slot offset configured in the CSI-RS resource set and expect to receive all aperiodic associated CSI-RSs within the slot in which the DCI is received. In this case, the reception of aperiodic associated CSI-RS may be understood to mean that all of CSI-RS resources configured in the CSI-RS resource set are received. For example, the UE may expect that all of CSI-RS resources within CSI-RS resource set are received in the same slot. For example, when each of the N CSI-RS resources within the CSI-RS resource set has M CSI-RS ports, the UE may receive higher layer signaling density values configured as evenPRBs for some of the four CSI-RS resources and oddPRBs for the remaining some CSI-RS resources. In this case, “N” may have a value of 2, 3, or 4, and “M” may have a value of 16, 24, or 32. For example, with respect to the case in which N is 4 and M is 32, the UE may be configured with evenPRBs for some CSI-RS resources and oddPRBs for the remaining some CSI-RS resources as described above.
In case that the UE receives a higher layer signaling slot offset configured within the CSI-RS resource set that is configured within the SRS resource set having usage configured as noncodebook, and does not receive resource-specific slot offsets configured in all CSI-RS resources within the CSI-RS resource set, if the UE receives triggering on the reception of aperiodic associated CSI-RS having a total number of CSI-RS ports greater than 32 (e.g., 48, 64, or 128) via DCI, the UE may expect to receive all the aperiodic associated CSI-RSs in a slot which is distant by a slot offset configured in the CSI-RS resource set from the slot in which the DCI for triggering the aperiodic associated CSI-RS is received. In this case, the reception of aperiodic associated CSI-RS may be understood to mean that all of CSI-RS resources configured in the CSI-RS resource set are received. For example, the UE may expect to receive all of CSI-RS resources within the same slot. As an example, when each of the N CSI-RS resources within the CSI-RS resource set has M CSI-RS ports, the UE may receive higher layer signaling density values configured as evenPRBs for some of the four CSI-RS resources and oddPRBs for the remaining some CSI-RS resources. In this case, “N” may have a value of 2, 3, or 4, and “M” may have a value of 16, 24, or 32. For example, with respect to the case in which N is 4 and M is 32, the UE may be configured with evenPRBs for some CSI-RS resources and oddPRBs for the remaining some CSI-RS resources as described above.
In case that the UE does not receive a higher layer signaling slot offset configured within the CSI-RS resource set that is configured within the SRS resource set having usage configured as noncodebook, and receives resource-specific slot offsets configured in all CSI-RS resources within the CSI-RS resource set, if the UE receives triggering on the reception of aperiodic associated CSI-RS having a total number of CSI-RS ports greater than 32 (e.g., 48, 64, or 128) via DCI, the UE may ignore the slot offset configured in each CSI-RS resource within the CSI-RS resource set and expect to receive the aperiodic associated CSI-RS by considering a new slot offset for each CSI-RS resource. In this case, the reception of aperiodic associated CSI-RS may be understood to mean that all of CSI-RS resources configured in the CSI-RS resource set are received. In this case, if some CSI-RS resources among the respective CSI-RS resources within the CSI-RS resource set receive slot offsets configured as N, the UE may expect that the remaining some CSI-RS resources receive slot offsets configured as (N+1). For example, the UE may expect to receive higher layer signaling configured such that all of CSI-RS resources within the CSI-RS resource set are received in two consecutive slots. In this case, the UE may expect that some CSI-RS resources having a slot offset configured as N described above are received in a slot in which DCI for triggering the aperiodic associated CSI-RS is received (e.g., the UE may ignore the slot offset N and consider the same to have a value of 0). In addition, the UE may expect that the remaining some CSI-RS resources having a slot offset configured as (N+1) are received in the slot following the slot in which DCI for triggering the aperiodic associated CSI-RS is received (e.g., the UE may ignore the slot offset (N+1) and consider the same to have a value of 1). For example, when there are N CSI-RS resources each having M CSI-RS ports within the CSI-RS resource set, the UE may expect that N has a value of 2, 3, or 4, and M has a value of 16, 24, or 32.
In case that the UE does not receive a higher layer signaling slot offset configured within the CSI-RS resource set that is configured within the SRS resource set having usage configured as noncodebook, and receives resource-specific slot offsets configured in all CSI-RS resources within the CSI-RS resource set, if the UE receives triggering on the reception of aperiodic associated CSI-RS having a total number of CSI-RS ports greater than 32 (e.g., 48, 64, or 128) via DCI, the UE may expect to receive the aperiodic associated CSI-RS by considering the slot offset configured in each CSI-RS resource within the CSI-RS resource set. In this case, the reception of aperiodic associated CSI-RS may be understood to mean that all of CSI-RS resources configured in the CSI-RS resource set are received. In this case, if some CSI-RS resources among the respective CSI-RS resources receive slot offsets configured as N, the UE may expect that the remaining some CSI-RS resources receive slot offsets configured as (N+1). For example, the UE may expect to receive higher layer signaling configured such that all of CSI-RS resources within the CSI-RS resource set are received in two consecutive slots. In this case, the UE may expect that some CSI-RS resources having a slot offset configured as N described above are received in a slot which is distant by N slots from the slot in which the DCI for triggering the aperiodic associated CSI-RS is received. Further, the UE may expect that the remaining some CSI-RS resources having a slot offset configured as (N+1) are received in a slot which is distant by (N+1) slots from the slot in which the DCI for triggering the aperiodic associated CSI-RS is received. For example, when there are N CSI-RS resources each having M CSI-RS ports within the CSI-RS resource set, the UE may expect that N has a value of 2, 3, or 4, and M has a value of 16, 24, or 32.
In case that the UE has received both the higher layer signaling slot offset within the CSI-RS resource set configured within the SRS resource set having usage configured as noncodebook and the resource-specific slot offset configured for all CSI-RS resources within the CSI-RS resource set, if the UE receives triggering on the aperiodic associated CSI-RS having a total number of CSI-RS ports greater than 32 (e.g., 48, 64, or 128) via DCI, the UE may ignore the slot offset configured in the CSI-RS resource set and the slot offset configured in each CSI-RS resource within the CSI-RS resource set, and expect to receive the aperiodic associated CSI-RS by considering a new slot offset for each CSI-RS resource. In this case, the reception of aperiodic associated CSI-RS may be understood to mean that all of CSI-RS resources configured in the CSI-RS resource set are received. In this case, if some CSI-RS resources among the respective CSI-RS resources within the CSI-RS resource set receive slot offsets configured as N, the UE may expect that the remaining some CSI-RS resources receive slot offsets configured as (N+1). For example, the UE may expect to receive higher layer signaling configured such that all of CSI-RS resources within the CSI-RS resource set are received in two consecutive slots. In this case, the UE may expect that some CSI-RS resources having a slot offset configured as N described above are received in a slot in which DCI for triggering the aperiodic associated CSI-RS is received (e.g., the UE may ignore the slot offset N and consider the same to have a value of zero). In addition, the UE may expect that the remaining some CSI-RS resources having a slot offset configured as (N+1) are received in the slot following the slot in which DCI for triggering the aperiodic associated CSI-RS is received (e.g., the UE may ignore the slot offset (N+1) and consider the same to have a value of 1). For example, when there are N CSI-RS resources each having M CSI-RS ports within the CSI-RS resource set, the UE may expect that N has a value of 2, 3, or 4, and M has a value of 16, 24, or 32.
In case that the UE has received both the higher layer signaling slot offset within the CSI-RS resource set configured within the above SRS resource set having usage configured as noncodebook and a resource-specific slot offset configured for all CSI-RS resources within the CSI-RS resource set, if the UE receives triggering on the reception of aperiodic associated CSI-RS having a total number of CSI-RS ports greater than 32 (e.g., 48, 64, or 128) via DCI, the UE may expect to receive the aperiodic associated CSI-RS by considering the slot offset configured in each CSI-RS resource within the CSI-RS resource set. In this case, the reception of aperiodic associated CSI-RS may be understood to mean that all of CSI-RS resources configured in the CSI-RS resource set are received. In this case, if some CSI-RS resources among the respective CSI-RS resources within the CSI-RS resource set receive slot offsets configured as N, the UE may expect that the remaining some CSI-RS resources receive slot offsets configured as (N+1). For example, the UE may expect to receive higher layer signaling configured such that all of CSI-RS resources within the CSI-RS resource set are received in two consecutive slots. In this case, the UE may expect that some CSI-RS resources having a slot offset configured as N described above are received in a slot which is distant by N slots from the slot in which DCI for triggering the aperiodic associated CSI-RS is received. Further, the UE may expect that the remaining some CSI-RS resources having a slot offset configured as (N+1) are received in a slot which is distant by (N+1) slots from the slot in which the DCI for triggering the aperiodic associated CSI-RS is received. For example, when there are N CSI-RS resources each having M CSI-RS ports within the CSI-RS resource set, the UE may expect that N has a value of 2, 3, or 4, and M has a value of 16, 24, or 32.

As described in [Method 2-1] or [Method 2-3], when the UE receives one or more CSI-RS resources configured as a periodic, semi-periodic, or aperiodic associated CSI-RS via higher layer signaling, the UE may expect the following to be configured for all of one or more CSI-RS resources via higher layer signaling.

As described in [Method 2-2], when the UE receives a CSI-RS resource set including one or more CSI-RS resources configured as an aperiodic associated CSI-RS via higher layer signaling, the UE may expect the following to be configured for all of one or more CSI-RS resources within the CSI-RS resource set via higher layer signaling. This is not limited to the following examples:
Each CSI-RS resource may have the same number of CSI-RS ports;
In the case of a periodic CSI-RS, qcl-InfoPeriodicCSI-RS may be the same;
In the case of an aperiodic CSI-RS, when a value of applyIndicatedTCI-State-r18
in the CSI-AssociatedReportConfigInfo is perSet-r18 (perSet-r18 may be configured as first or second, and the first or second indicated TCI state is equally applicable to all CSI-RS resources in a CSI-RS resource set), or when a value of applyIndicatedTCI-State-r18 is perResource-r18, all CSI-RS resources may be configured identically as first or second;
In the case of an aperiodic CSI-RS, when a value of resourcesForChannel in CSI-AssociatedReportConfigInfo is nzp-CSI-RS, qcl-info in nzp-CSI-RS may have the same value for all CSI-RS resources; And/or
The values of powerControlOffset, powerControlOffsetSS, startRB, and nrofRBs for each CSI-RS resource may be all the same.

An embodiment of the disclosure describes the reception location of an aperiodic associated CSI-RS when the UE receives a triggering signal for an aperiodic associated CSI-RS including more than 32 CSI-RS ports that may be configured by multiple CSI-RS resources from the base station. In this case, the UE may follow any combination of at least one of [Method 2-1] to [Method 2-5] to support an aperiodic associated CSI-RS including more than 32 CSI-RS ports. This embodiment may operate in combination with other embodiments.

The UE may define the location of an aperiodic associated CSI-RS as follows when an aperiodic associated CSI-RS including more than 32 CSI-RS ports that can be configured by multiple CSI-RS resources is triggered via DCI format 0_1, 0_2, 1_1, or 1_2. This is not limited to the example below.

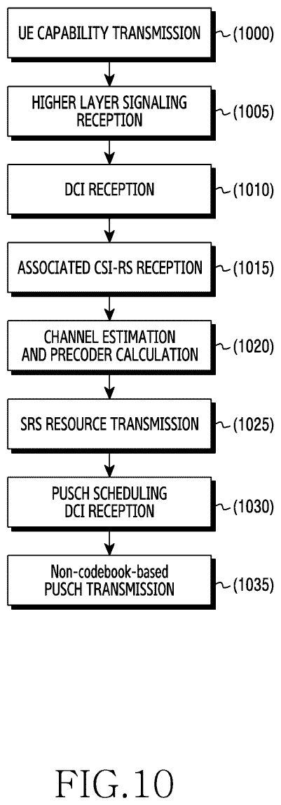

FIG. 10 illustrates the operation of a UE according to an embodiment of the present disclosure.

Referring to FIG. 10, in operation 1000, the UE may transmit a UE capability to a base station. In this case, UE capability signaling that can be reported may include a combination of at least one of a UE capability related to non-codebook-based PUSCH transmission support, a UE capability related to SRS resource configuration and SRS resource set configuration in which usage can be configured as non-codebook, a UE capability related to associated CSI-RS support, and a UE capability according to [Method 2-1] to [Method 2-5], [Method 3-1] to [Method 3-2], or the definition of “d” described above. However, operation 1000 may be omitted.

In operation 1005, the UE may receive higher layer signaling from the base station according to the reported UE capability. Here, the UE may define, from the base station, higher layer signaling related to support for non-codebook-based PUSCH transmission, SRS resource configuration and SRS resource set configuration having usage that may be configured as non-codebook, higher layer signaling related to support for associated CSI-RS, and higher layer parameters for a combination of at least one of [Method 2-1] to [Method 2-5] above, [Methods 3-1] to [Method 3-2] above, or “d”-related configuration described above, and may use one of them.

In operation 1010, the UE may receive DCI from the base station. The DCI may be DCI formats 1_1, 1_2, 0_1, or 0_2. The UE may perform triggering for a set of SRSs indicated via the SRS request field in the DCI.

In operation 1015, the UE may receive an associated CSI-RS from the base station. Here, the UE may know how the aperiodic associated CSI-RS is triggered via MC-DCI and/or where the aperiodic associated CSI-RS exists according to [Method 2-1] to [Method 2-5] and [Method 3-1] to [Method 3-2].

In operation 1020, the UE may estimate a channel between the base station and the UE based on the associated CSI-RS received from the base station and calculate the precoder.

In operation 1025, the UE may apply the calculated precoder to one or more SRS resources and transmit the same to the base station.

In operation 1030, the UE may receive, from the base station, DCI for scheduling non-codebook-based PUSCH transmission.

In operation 1035, the UE may perform non-codebook-based PUSCH transmission by referring to precoding-related scheduling information in the DCI received from the base station.

The flowcharts described above illustrate exemplary methods that may be implemented in accordance with the principles of the disclosure, and various modifications may be made to the methods illustrated in the flowcharts herein. For example, although shown as a series of operations, the various operations in each of the drawings may overlap, occur in parallel, occur in different order, or occur multiple times. In other examples, at least one operation may be omitted or replaced by another operation.

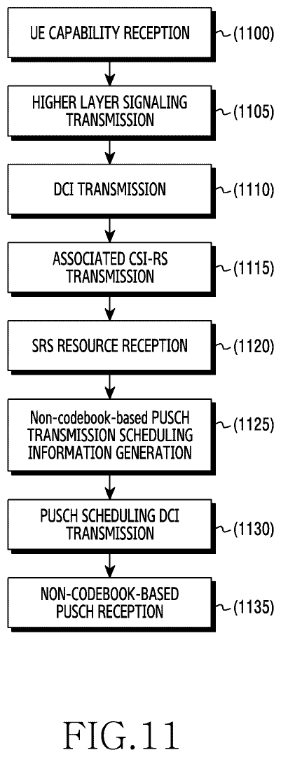

FIG. 11 illustrates the operation of a base station according to an embodiment of the present disclosure.

Referring to FIG. 11, in operation 1100, the base station may receive a UE capability from a UE. In this case, UE capability signaling that can be received by the base station may include a combination of at least one of a UE capability related to non-codebook-based PUSCH transmission support, a UE capability related to SRS resource configuration and SRS resource set configuration in which usage can be configured as non-codebook, a UE capability related to associated CSI-RS support, and a UE capability according to [Method 2-1] to [Method 2-5], [Method 3-1] to [Method 3-2], or the definition of “d” described above. However, operation 1100 may be omitted.

In operation 1105, the base station may receive higher layer signaling from the base station according to the UE capability reported by the UE. Here, the UE may define, from the base station, higher layer signaling related to support for non-codebook-based PUSCH transmission, SRS resource configuration and SRS resource set configuration having usage that may be configured as non-codebook, higher layer signaling related to support for associated CSI-RS, and higher layer parameters for a combination of at least one of [Method 2-1] to [Method 2-5] above, [Methods 3-1] to [Method 3-2] above, or “d”-related configuration described above, and may use one of them.

In operation 1110, the base station may transmit DCI to the UE. The DCI may be DCI formats 1_1, 1_2, 0_1, or 0_2.

In operation 1115, the base station may receive an SRS resource transmitted by the UE

In operation 1120, the base station may receive the SRS resource transmitted by the UE and generate precoding information for scheduling non-codebook-based PUSCH transmission to the UE.

In operation 1130, the base station may transmit PUSCH scheduling DCI to the UE.

In operation 1135, the base station may receive a non-codebook-based PUSCH from the UE.

The flowcharts described above illustrate exemplary methods that may be implemented in accordance with the principles of the disclosure, and various modifications may be made to the methods illustrated in the flowcharts herein. For example, although shown as a series of operations, the various operations in each of the drawings may overlap, occur in parallel, occur in different order, or occur multiple times. In other examples, at least one operation may be omitted or replaced by another operation.

### [UE/Base Station Drawings]

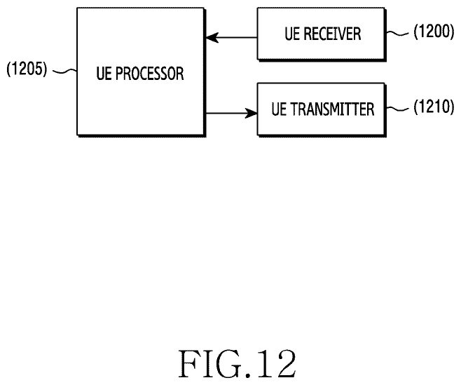

FIG. 12 illustrates a structure of a UE in a wireless communication system according to an embodiment of the present disclosure.

Referring to FIG. 12, the UE may include a transceiver, which refers to a UE receiver 1200 and a UE transmitter 1210 as a whole, a memory (not illustrated), and a UE processor 1205 (or UE controller or processor). The UE transceiver 1200 and 1210, the memory, and the UE processor 1205 may operate according to the above-described communication methods of the UE. Components of the UE are not limited to the above-described example. For example, the UE may include a larger or smaller number of components than the above-described components. Furthermore, the transceiver 1200 and 1210, the memory, and the UE processor 1205 may be implemented in the form of a single chip.

The transceiver 1200 and 1210 may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver 1200 and 1210, and the components of the transceiver 1200 and 1210 are not limited to the RF transmitter and the RF receiver.

In addition, the transceiver 1200 and 1210 may receive signals through a radio channel, output the same to the processor 1205, and transmit signals output from the processor 1205 through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories, and the memory may store instructions for performing the above-described communication methods.

Furthermore, the UE processor 1205 may control a series of processes such that the UE can operate according to the above-described embodiments. For example, the UE processor 1205 may control components of the UE to receive DCI configured in two layers so as to simultaneously receive multiple PDSCHs. The processor may include multiple processors, and the UE processor 1205 may perform operations of controlling the components of the UE by executing programs stored in the memory.

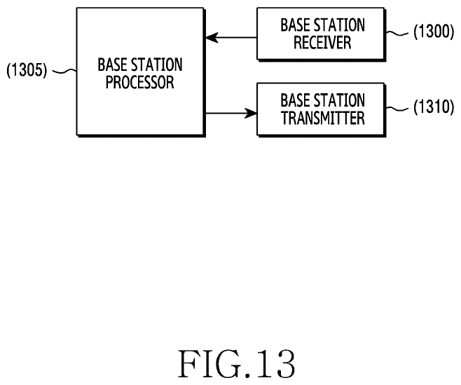

FIG. 13 illustrates a structure of a base station in a wireless communication system according to an embodiment of the present disclosure.

Referring to FIG. 13, the base station may include a transceiver, which refers to a base station receiver 1300 and a base station transmitter 1310 as a whole, a memory (not illustrated), and a base station processor 1305 (or base station controller or processor). The base station transceiver 1300 and 1310, the memory, and the base station processor 1305 may operate according to the above-described communication methods of the base station. However, components of the base station are not limited to the above-described example. For example, the base station may include a larger or smaller number of components than the above-described components. Furthermore, the transceiver 1300 and 1310, the memory, and the base station processor may be implemented in the form of a single chip.

The transceiver 1300 and 1310 may transmit/receive signals with the UE. The signals may include control information and data. To this end, the transceiver 1300 and 1310 may include an RF transmitter configured to up-convert and amplify the frequency of transmitted signals, an RF receiver configured to low-noise-amplify received signals and down-convert the frequency thereof, and the like. However, this is only an embodiment of the transceiver 1300 and 1310, and the components of the transceiver 1300 and 1310 are not limited to the RF transmitter and the RF receiver.

In addition, the transceiver 1300 and 1310 may receive signals through a radio channel, output the same to the base station processor 1305, and transmit signals output from the base station processor 1305 through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories, and the memory may store instructions for performing the above-described communication methods.

The base station processor 1305 may control a series of processes such that the base station can operate according to the above-described embodiments. For example, the base station processor 1305 may control components of the base station to configure DCI configured in two layers including allocation information regarding multiple PDSCHs and to transmit the same. The base station processor 1305 may include multiple processors, and the base station processor 1305 may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, configuration information on a channel state information (CSI)-reference signal (RS) resource set with more than 32 antenna ports, wherein the CSI-RS resource set includes an aggregation of a plurality of CSI-RS resources as an associated CSI-RS;
receiving, from the base station, downlink control information (DCI) requesting a sounding reference signal (SRS);
receiving, from the base station, the associated CSI-RS;
transmitting, to the base station, the SRS based on the DCI; and
transmitting, to the base station, a non-codebook based physical uplink shared channel (PUSCH) according to the SRS,
wherein a number of the plurality of CSI-RS resources is one of 2, 3, or 4.

2. The method of claim 1, wherein an SRS resource set of the SRS is configured with a usage set to a nonCodebook.

3. The method of claim 1, wherein the DCI and the associated CSI-RS are received in a same slot.

4. The method of claim 1, wherein the associated CSI-RS is an aperiodic CSI-RS, and wherein the SRS is an aperiodic SRS.

5. A method performed by a base station in a wireless communication system, the method comprising:
transmitting, to a terminal, configuration information on a channel state information (CSI)-reference signal (RS) resource set with more than 32 antenna ports, wherein the CSI-RS resource set includes an aggregation of a plurality of CSI-RS resources as an associated CSI-RS;
transmitting, to the terminal, downlink control information (DCI) requesting a sounding reference signal (SRS);
transmitting, to the terminal, the associated CSI-RS;
receiving, from the terminal, the SRS based on the DCI; and
receiving, from the terminal, a non-codebook based physical uplink shared channel (PUSCH) according to the SRS,
wherein a number of the plurality of CSI-RS resources is one of 2, 3, or 4.

6. The method of claim 5, wherein an SRS resource set of the SRS is configured with a usage set to a nonCodebook.

7. The method of claim 5, wherein the DCI and the associated CSI-RS are transmitted in a same slot.

8. The method of claim 5, wherein the associated CSI-RS is an aperiodic CSI-RS, and wherein the SRS is an aperiodic SRS.

9. A terminal in a wireless communication system, the terminal comprising:
a transceiver; and
at least one processor coupled with the transceiver and configured to:
receive, from a base station, configuration information on a channel state information (CSI)-reference signal (RS) resource set with more than 32 antenna ports, wherein the CSI-RS resource set includes an aggregation of a plurality of CSI-RS resources as an associated CSI-RS,
receive, from the base station, downlink control information (DCI) requesting a sounding reference signal (SRS),
receive, from the base station, the associated CSI-RS,
transmit, to the base station, the SRS based on the DCI, and
transmit, to the base station, a non-codebook based physical uplink shared channel (PUSCH) according to the SRS,
wherein a number of the plurality of CSI-RS resources is one of 2, 3, or 4.

10. The terminal of claim 9, wherein an SRS resource set of the SRS is configured with a usage set to a nonCodebook.

11. The terminal of claim 9, wherein the DCI and the associated CSI-RS are received in a same slot.

12. The terminal of claim 9, wherein the associated CSI-RS is an aperiodic CSI-RS, and wherein the SRS is an aperiodic SRS.

13. A base station in a wireless communication system, the base station comprising:
a transceiver; and
at least one processor coupled with the transceiver and configured to:
transmit, to a terminal, configuration information on a channel state information (CSI)-reference signal (RS) resource set with more than 32 antenna ports, wherein the CSI-RS resource set includes an aggregation of a plurality of CSI-RS resources as an associated CSI-RS,
transmit, to the terminal, downlink control information (DCI) requesting a sounding reference signal (SRS),
transmit, to the terminal, the associated CSI-RS,
receive, from the terminal, the SRS based on the DCI, and
receive, from the terminal, a non-codebook based physical uplink shared channel (PUSCH) according to the SRS,
wherein a number of the plurality of CSI-RS resources is one of 2, 3, or 4.

14. The base station of claim 13, wherein an SRS resource set of the SRS is configured with a usage set to a nonCodebook.

15. The base station of claim 13, wherein the DCI and the associated CSI-RS are transmitted in a same slot.

16. The base station of claim 13, wherein the associated CSI-RS is an aperiodic CSI-RS, and
wherein the SRS is an aperiodic SRS.
